(19) United States
(12) Patent Application Publication
(10) Pub. No.: US 2026/0280782 A1
(43) Pub. Date: Sep. 17, 2026

(54) UNIFIED TRANSMISSION CONFIGURATION INDICATOR (TCI) STATE INDICATION FOR MULTIPLE DOWNLINK CONTROL INFORMATION (DCI) BASED MULTIPLE TRANSMISSION RECEPTION POINT (TRP) OPERATION

(71) Applicant: QUALCOMM Incorporated, San Diego, CA (US)

(72) Inventors: Fang YUAN, Beijing (CN); Yan ZHOU, San Diego, CA (US)

(21) Appl. No.: 19/473,436

(22) PCT Filed: May 1, 2024
(86) PCT No.: PCT/CN2024/091068

§ 371 Date: Oct. 7, 2025

(30) Foreign Application Priority Data
May 12, 2023 (WO) PCT/CN2023/093769
May 12, 2023 (WO) PCT/CN2023/093838

(51) Int. Cl. H04L 5/00; H04W 72/232; H04W 72/51

(52) U.S. Cl. CPC H04L 5/0035; H04L 5/0094; H04L 5/0098; H04W 72/232; H04W 72/51

(57) ABSTRACT

Methods, systems, and devices for wireless communications are described. In multiple downlink control information (multi-DCI) based multiple transmission reception point (multi-TRP) operations, a user equipment (UE) may receive respective DCIs from each of the multiple TRPs that schedule a shared channel communication to be performed with the corresponding TRP of the multiple TRPs. A UE may be configured with or activated with unified transmission configuration indicator (TCI) states for one or more channels or signals. A UE may transmit capability information to the network that indicates capabilities of the UE associated with application of the unified TCI state framework to multi-DCI based multi-TRP operation. The network may transmit control signaling indicating parameters for the multi-DCI based multi-TRP operation based on the capability information. The UE may receive multiple DCIs from the multiple TRPs that schedule a multi-TRP operation (e.g., a shared channel communication between the UE and the multiple TRPs).

### CROSS REFERENCE

The present Application for Patent is a 371 national stage filing of International PCT Patent Application No. PCT/CN2024/091068 by YUAN et al., entitled “UNIFIED TRANSMISSION CONFIGURATION INDICATOR (TCI) STATE INDICATION FOR SINGLE OR MULTIPLE DOWNLINK CONTROL INFORMATION (DCI) BASED MULTIPLE TRANSMISSION RECEPTION POINT (TRP) OPERATION,” filed May 1, 2024, which claims priority to International Patent Application No. PCT/CN2023/093769 by YUAN et al. entitled “UNIFIED TRANSMISSION CONFIGURATION INDICATOR FRAMEWORK FOR SINGLE DOWNLINK CONTROL INFORMATION-BASED MULTI-TRANSMISSION RECEPTION POINT OPERATION,” filed May 12, 2023; and International Patent Application No. PCT/CN2023/093838 by YUAN et al., entitled “UNIFIED TRANSMISSION CONFIGURATION INDICATOR (TCI) STATE INDICATION FOR MULTIPLE DOWNLINK CONTROL INFORMATION (DCI) BASED MULTIPLE TRANSMISSION RECEPTION POINT (TRP) OPERATION,” filed May 12, 2023, each of which is assigned to the assignee hereof, and each of which is expressly incorporated by reference herein in its entirety.

### FIELD OF TECHNOLOGY

The following relates to wireless communications, including unified transmission configuration indicator (TCI) state indication for single or multiple downlink control information (DCI) based multiple transmission reception point (TRP) operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may support communicating with a network via one or more TRPs. A UE may also communicate a unified TCI state to indicate a common beam for multiple channels. However, multi-TRP operation in conjunction with a unified TCI state framework may be unsupported.

### SUMMARY

The described techniques relate to improved methods, systems, devices, and apparatuses that support unified transmission configuration indicator (TCI) state indication for single or multiple downlink control information (multi-DCI) based multiple transmission reception point (multi-TRP) operation. For example, the described techniques provide for an indication from a UE to a network entity of UE capabilities that may support implementation of the unified TCI state framework to single or multi-DCI based multi-TRP operation. In single DCI-based multi-TRP operations, the UE may receive DCI that schedules the communication of one or more messages to be performed with multiple TRPs. In multi-DCI multi-TRP operations, the UE may receive respective DCIs from each of the multiple TRPs, each of the DCIs scheduling a shared channel communication to be performed with the corresponding TRP of the multiple TRPs. A UE may be configured with or activated with unified TCI states for one or more channels or signals. A UE may transmit capability information to the network (e.g., to a serving network entity that includes multiple TRPs) that indicates capabilities of the UE associated with the application of the unified TCI state framework to single and/or multi-DCI based multi-TRP operation. Once the UE capabilities have been reported, the network entity may transmit control signaling indicating parameters for the single or multi-DCI based multi-TRP operation. In some examples, the UE may receive a DCI from a network entity (e.g., a TRP or via a TRP) that schedules a multi-TRP operation (e.g., communication of one or more messages between the UE and the multiple TRPs), and the UE and TRPs may perform the multi-TRP operation. In some examples, the UE may receive multiple DCIs from the multiple TRPs that schedule a multi-TRP operation (e.g., a shared channel transmission between the UE and the multiple TRPs).

A method for wireless communications at a UE is described. The method may include transmitting capability information indicating one or more capabilities of the UE associated with a unified TCI framework for a multi-DCI based multi-TRP operation, receiving, based on the capability information, a control message indicating one or more parameters for the multi-DCI based multi-TRP operation, receiving a set of multiple DCIs from a respective set of multiple TRPs, where the set of multiple DCIs schedule a multi-TRP operation with the respective set of multiple TRPs in accordance with the one or more parameters, and performing the multi-TRP operation.

An apparatus for wireless communications at a UE is described. The apparatus may include at least one processor, memory coupled with the at least one processor, and instructions stored in the memory. The instructions may be executable by the at least one processor to cause the apparatus to transmit capability information indicating one or more capabilities of the UE associated with a unified TCI framework for a multi-DCI based multi-TRP operation, receive, based on the capability information, a control message indicating one or more parameters for the multi-DCI based multi-TRP operation, receive a set of multiple DCIs from a respective set of multiple TRPs, where the set of multiple DCIs schedule a multi-TRP operation with the respective set of multiple TRPs in accordance with the one or more parameters, and perform the multi-TRP operation.

Another apparatus for wireless communications at a UE is described. The apparatus may include means for transmitting capability information indicating one or more capabilities of the UE associated with a unified TCI framework for a multi-DCI based multi-TRP operation, means for receiving, based on the capability information, a control message indicating one or more parameters for the multi-DCI based multi-TRP operation, means for receiving a set of multiple DCIs from a respective set of multiple TRPs, where the set of multiple DCIs schedule a multi-TRP operation with the respective set of multiple TRPs in accordance with the one or more parameters, and means for performing the multi-TRP operation.

A non-transitory computer-readable medium storing code for wireless communications at a UE is described. The code may include instructions executable by at least one processor to transmit capability information indicating one or more capabilities of the UE associated with a unified TCI framework for a multi-DCI based multi-TRP operation, receive, based on the capability information, a control message indicating one or more parameters for the multi-DCI based multi-TRP operation, receive a set of multiple DCIs from a respective set of multiple TRPs, where the set of multiple DCIs schedule a multi-TRP operation with the respective set of multiple TRPs in accordance with the one or more parameters, and perform the multi-TRP operation.

In some examples of the method, apparatuses, and non-transitory computer-readable medium described herein, the one or more capabilities include a capability of the UE to receive control signaling activating one joint unified TCI state per component carrier (CC) in a band and at least one TCI codepoint may be mapped to a joint unified TCI state per control resource set (CORESET) pool index.

In some examples of the method, apparatuses, and non-transitory computer-readable medium described herein, the one or more capabilities include a capability of the UE to receive control signaling activating one downlink unified TCI state and one uplink unified transmission configuration state per CC in a band and at least one TCI codepoint may be mapped to a downlink unified TCI state and an uplink unified TCI state per CORESET pool index.

In some examples of the method, apparatuses, and non-transitory computer-readable medium described herein, the one or more capabilities include a capability of the UE to receive control signaling indicating an activated joint unified TCI state may be mapped to a CORESET pool index.

In some examples of the method, apparatuses, and non-transitory computer-readable medium described herein, the one or more capabilities include a capability of the UE to receive control signaling indicating an activated downlink unified TCI and an activated downlink unified TCI state may be mapped to a CORESET pool index.

In some examples of the method, apparatuses, and non-transitory computer-readable medium described herein, common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

In some examples of the method, apparatuses, and non-transitory computer-readable medium described herein, the one or more capabilities include a capability of the UE to perform a shared channel communication using a joint unified TCI state associated with a CORESET pool index associated with a DCI that scheduled the shared channel communication.

In some examples of the method, apparatuses, and non-transitory computer-readable medium described herein, the one or more capabilities include a capability of the UE to receive a downlink shared channel communication using a downlink unified TCI state associated with a CORESET pool index associated with a DCI that scheduled the downlink shared channel communication.

In some examples of the method, apparatuses, and non-transitory computer-readable medium described herein, the one or more capabilities include a capability of the UE to transmit an uplink shared channel communication using an uplink unified TCI state associated with a CORESET pool index associated with a DCI that scheduled the uplink shared channel communication.

In some examples of the method, apparatuses, and non-transitory computer-readable medium described herein, the one or more capabilities include a capability of the UE to receive control signaling associating an uplink control channel resource with a joint unified TCI state and the joint unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating an uplink control channel resource with an uplink unified TCI state and the uplink unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating a configured grant resource with a joint unified TCI state and the joint unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating a configured grant resource with an uplink unified TCI state and the uplink unified TCI state may be associated with a CORESET pool index associated with one of the respective set of multiple TRPs.

In some examples of the method, apparatuses, and non-transitory computer-readable medium described herein, the one or more capabilities include a capability of the UE to update at least one of a quasi co-location (QCL) assumption, a spatial transmission filter, or a pathloss reference signal for a joint unified TCI state in response to a beam failure recovery procedure for a beam corresponding to the joint unified TCI state.

In some examples of the method, apparatuses, and non-transitory computer-readable medium described herein, the one or more capabilities include a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

In some examples of the method, apparatuses, and non-transitory computer-readable medium described herein, the one or more capabilities include a capability of the UE to receive control signaling associating a joint unified TCI state or an uplink unified TCI state with an uplink power control configuration.

In some examples of the method, apparatuses, and non-transitory computer-readable medium described herein, the one or more capabilities include a capability of the UE to receive control signaling associating an uplink power control configuration per TRP.

In some examples of the method, apparatuses, and non-transitory computer-readable medium described herein, the one or more capabilities include a capability of the UE to receive control signaling activating a set of joint unified TCI states per physical cell identifier of a set of multiple physical cell identifiers and at least one of the set of multiple physical cell identifiers may be a serving cell.

In some examples of the method, apparatuses, and non-transitory computer-readable medium described herein, the one or more capabilities include a capability of the UE to receive control signaling activating a set of downlink unified TCI states and a set of uplink unified TCI states per physical cell identifier of a set of multiple physical cell identifiers and at least one of the set of multiple physical cell identifiers may be a serving cell.

Some examples of the method, apparatuses, and non-transitory computer-readable medium described herein may further include operations, features, means, or instructions for transmitting second capability information indicating one or more second capabilities of the UE associated with the unified TCI framework for a single DCI based single-TRP operation, where the capability information indicates that one or more of the one or more capabilities of the UE may be the same as corresponding capabilities of the one or more second capabilities indicated by the second capability information.

In some examples of the method, apparatuses, and non-transitory computer-readable medium described herein, the capability information includes a report that indicates the one or more capabilities of the UE in addition to one or more second capabilities of the UE associated with the unified TCI framework for a single DCI-based single TRP operation.

Some examples of the method, apparatuses, and non-transitory computer-readable medium described herein may further include operations, features, means, or instructions for transmitting second capability information indicating one or more second capabilities of the UE associated with the unified TCI framework for a single DCI based single-TRP operation, where the capability information includes an indication that one or more third capabilities of the UE associated with the unified TCI framework for the multi-DCI based multi-TRP operation that may be excluded from the capability information may be the same as corresponding capabilities of the one or more second capabilities included in the second capability information.

In some examples of the method, apparatuses, and non-transitory computer-readable medium described herein, the one or more capabilities may be specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

A method for wireless communications at a network entity is described. The method may include receiving, from a UE, capability information indicating one or more capabilities of the UE associated with a unified TCI framework for a multi-DCI based multi-TRP operation, transmitting, to the UE and based on the capability information, a control message indicating one or more parameters for the multi-DCI based multi-TRP operation, and transmitting, to the UE, a set of multiple DCIs via a respective set of multiple TRPs, where the set of multiple DCIs schedule a multi-TRP operation with the respective set of multiple TRPs in accordance with the one or more parameters.

An apparatus for wireless communications at a network entity is described. The apparatus may include at least one processor, memory coupled with the at least one processor, and instructions stored in the memory. The instructions may be executable by the at least one processor to cause the apparatus to receive, from a UE, capability information indicating one or more capabilities of the UE associated with a unified TCI framework for a multi-DCI based multi-TRP operation, transmit, to the UE and based on the capability information, a control message indicating one or more parameters for the multi-DCI based multi-TRP operation, and transmit, to the UE, a set of multiple DCIs via a respective set of multiple TRPs, where the set of multiple DCIs schedule a multi-TRP operation with the respective set of multiple TRPs in accordance with the one or more parameters.

Another apparatus for wireless communications at a network entity is described. The apparatus may include means for receiving, from a UE, capability information indicating one or more capabilities of the UE associated with a unified TCI framework for a multi-DCI based multi-TRP operation, means for transmitting, to the UE and based on the capability information, a control message indicating one or more parameters for the multi-DCI based multi-TRP operation, and means for transmitting, to the UE, a set of multiple DCIs via a respective set of multiple TRPs, where the set of multiple DCIs schedule a multi-TRP operation with the respective set of multiple TRPs in accordance with the one or more parameters.

A non-transitory computer-readable medium storing code for wireless communications at a network entity is described. The code may include instructions executable by at least one processor to receive, from a UE, capability information indicating one or more capabilities of the UE associated with a unified TCI framework for a multi-DCI based multi-TRP operation, transmit, to the UE and based on the capability information, a control message indicating one or more parameters for the multi-DCI based multi-TRP operation, and transmit, to the UE, a set of multiple DCIs via a respective set of multiple TRPs, where the set of multiple DCIs schedule a multi-TRP operation with the respective set of multiple TRPs in accordance with the one or more parameters.

In some examples of the method, apparatuses, and non-transitory computer-readable medium described herein, the one or more capabilities include a capability of the UE to receive control signaling activating one joint unified TCI state per CC in a band and at least one TCI codepoint may be mapped to a joint unified TCI state per CORESET pool index.

In some examples of the method, apparatuses, and non-transitory computer-readable medium described herein, the one or more capabilities include a capability of the UE to receive control signaling activating one downlink unified TCI state and one uplink unified transmission configuration state per CC in a band and at least one TCI codepoint may be mapped to a downlink unified TCI state and an uplink unified TCI state per CORESET pool index.

In some examples of the method, apparatuses, and non-transitory computer-readable medium described herein, the one or more capabilities include a capability of the UE to receive control signaling indicating an activated joint unified TCI state may be mapped to a CORESET pool index.

In some examples of the method, apparatuses, and non-transitory computer-readable medium described herein, the one or more capabilities include a capability of the UE to receive control signaling indicating an activated downlink unified TCI and an activated downlink unified TCI state may be mapped to a CORESET pool index.

In some examples of the method, apparatuses, and non-transitory computer-readable medium described herein, common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

In some examples of the method, apparatuses, and non-transitory computer-readable medium described herein, the one or more capabilities include a capability of the UE to perform a shared channel communication using a joint unified TCI state associated with a CORESET pool index associated with a DCI that scheduled the shared channel communication.

In some examples of the method, apparatuses, and non-transitory computer-readable medium described herein, the one or more capabilities include a capability of the UE to receive a downlink shared channel communication using a downlink unified TCI state associated with a CORESET pool index associated with a DCI that scheduled the downlink shared channel communication.

In some examples of the method, apparatuses, and non-transitory computer-readable medium described herein, the one or more capabilities include a capability of the UE to transmit an uplink shared channel communication using an uplink unified TCI state associated with a CORESET pool index associated with a DCI that scheduled the uplink shared channel communication.

In some examples of the method, apparatuses, and non-transitory computer-readable medium described herein, the one or more capabilities include a capability of the UE to receive control signaling associating an uplink control channel resource with a joint unified TCI state and the joint unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating an uplink control channel resource with an uplink unified TCI state and the uplink unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating a configured grant resource with a joint unified TCI state and the joint unified TCI state may be associated with a CORESET pool index associated with one of the respective set of multiple TRPs.

In some examples of the method, apparatuses, and non-transitory computer-readable medium described herein, the one or more capabilities include a capability of the UE to receive control signaling associating a configured grant resource with an uplink unified TCI state and the uplink unified TCI state may be associated with a CORESET pool index associated with one of the respective set of multiple TRPs.

In some examples of the method, apparatuses, and non-transitory computer-readable medium described herein, the one or more capabilities include a capability of the UE to update at least one of a QCL assumption, a spatial transmission filter, or a pathloss reference signal for a joint unified TCI state in response to a beam failure recovery procedure for a beam corresponding to the joint unified TCI state.

In some examples of the method, apparatuses, and non-transitory computer-readable medium described herein, the one or more capabilities include a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

In some examples of the method, apparatuses, and non-transitory computer-readable medium described herein, the one or more capabilities include a capability of the UE to receive control signaling associating a joint unified TCI state or an uplink unified TCI state with an uplink power control configuration.

In some examples of the method, apparatuses, and non-transitory computer-readable medium described herein, the one or more capabilities include a capability of the UE to receive control signaling associating an uplink power control configuration per TRP.

In some examples of the method, apparatuses, and non-transitory computer-readable medium described herein, the one or more capabilities include a capability of the UE to receive control signaling activating a set of joint unified TCI states per physical cell identifier of a set of multiple physical cell identifiers and at least one of the set of multiple physical cell identifiers may be a serving cell.

In some examples of the method, apparatuses, and non-transitory computer-readable medium described herein, the one or more capabilities include a capability of the UE to receive control signaling activating a set of downlink unified TCI states and a set of uplink unified TCI states per physical cell identifier of a set of multiple physical cell identifiers and at least one of the set of multiple physical cell identifiers may be a serving cell.

Some examples of the method, apparatuses, and non-transitory computer-readable medium described herein may further include operations, features, means, or instructions for receiving second capability information indicating one or more second capabilities of the UE associated with the unified TCI framework for a single DCI based single-TRP operation, where the capability information indicates that one or more of the one or more capabilities of the UE may be the same as corresponding capabilities of the one or more second capabilities indicated by the second capability information.

In some examples of the method, apparatuses, and non-transitory computer-readable medium described herein, the capability information includes a report that indicates the one or more capabilities of the UE in addition to one or more second capabilities of the UE associated with the unified TCI framework for a single DCI-based single TRP operation.

Some examples of the method, apparatuses, and non-transitory computer-readable medium described herein may further include operations, features, means, or instructions for receiving second capability information indicating one or more second capabilities of the UE associated with the unified TCI framework for a single DCI based single-TRP operation, where the capability information includes an indication that one or more third capabilities of the UE associated with the unified TCI framework for the multi-DCI based multi-TRP operation that may be excluded from the capability information may be the same as corresponding capabilities of the one or more second capabilities included in the second capability information.

In some examples of the method, apparatuses, and non-transitory computer-readable medium described herein, the one or more capabilities may be specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

A method for wireless communications at a UE is described. The method may include transmitting capability information indicating one or more capabilities of the UE associated with a unified TCI framework for a single DCI-based multi-TRP operation, receiving, based on the capability information, a control message indicating one or more parameters for the single DCI-based multi-TRP operation, receiving DCI that schedules a multi-TRP operation in accordance with the one or more parameters, and performing the multi-TRP operation.

An apparatus for wireless communications at a UE is described. The apparatus may include a processor, memory coupled with the processor, and instructions stored in the memory. The instructions may be executable by the processor to cause the apparatus to transmit capability information indicating one or more capabilities of the UE associated with a unified TCI framework for a single DCI-based multi-TRP operation, receive, based on the capability information, a control message indicating one or more parameters for the single DCI-based multi-TRP operation, receive DCI that schedules a multi-TRP operation in accordance with the one or more parameters, and perform the multi-TRP operation.

Another apparatus for wireless communications at a UE is described. The apparatus may include means for transmitting capability information indicating one or more capabilities of the UE associated with a unified TCI framework for a single DCI-based multi-TRP operation, means for receiving, based on the capability information, a control message indicating one or more parameters for the single DCI-based multi-TRP operation, means for receiving DCI that schedules a multi-TRP operation in accordance with the one or more parameters, and means for performing the multi-TRP operation.

A non-transitory computer-readable medium storing code for wireless communications at a UE is described. The code may include instructions executable by a processor to transmit capability information indicating one or more capabilities of the UE associated with a unified TCI framework for a single DCI-based multi-TRP operation, receive, based on the capability information, a control message indicating one or more parameters for the single DCI-based multi-TRP operation, receive DCI that schedules a multi-TRP operation in accordance with the one or more parameters, and perform the multi-TRP operation.

In some examples of the method, apparatuses, and non-transitory computer-readable medium described herein, the one or more capabilities include a capability of the UE to receive control signaling that activates a TCI codepoint mapped to one or more unified joint TCI states, one or more unified downlink TCI states, or one or more unified uplink TCI states per CC in a band.

In some examples of the method, apparatuses, and non-transitory computer-readable medium described herein, the one or more capabilities include a second capability of the UE to update a first subset of unified TCI states of a set of activated unified TCI states based on the TCI codepoint being mapped to the first subset and maintain a second subset of unified TCI states of the set of activated unified TCI states based on the TCI codepoint lacking a mapping to the second subset.

In some examples of the method, apparatuses, and non-transitory computer-readable medium described herein, at least one TCI codepoints of a set of TCI codepoints including the TCI codepoint may be mapped to two unified joint TCI states, two unified downlink TCI states, or two unified uplink TCI states.

In some examples of the method, apparatuses, and non-transitory computer-readable medium described herein, the one or more capabilities include a capability of the UE to receive control signaling that activates a TCI codepoint mapped to up to two unified joint TCI states, two unified downlink TCI states, or two unified uplink TCI states.

In some examples of the method, apparatuses, and non-transitory computer-readable medium described herein, the one or more capabilities include a capability of the UE to support common TCI state identifier update and activation for a set of CCs associated with the single DCI-based multi-TRP operation.

In some examples of the method, apparatuses, and non-transitory computer-readable medium described herein, the one or more capabilities include a capability of the UE to receive control signaling that indicates whether the UE is to apply, to an aperiodic channel state information-reference signal (CSI-RS) resource or an aperiodic CSI-RS resource set: a first unified joint TCI state or a second unified joint TCI state indicated by a second control message; or a first unified downlink TCI state or a second unified downlink TCI state indicated by the second control message.

In some examples of the method, apparatuses, and non-transitory computer-readable medium described herein, the one or more capabilities include a capability of the UE to receive control signaling that indicates whether the UE is to apply, to a physical uplink control channel (PUCCH) resource or group: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the one or more capabilities include a capability of the UE to receive control signaling that indicates whether the UE is to apply, to a CORESET or group of CORESETs: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the CORESET or group of CORESETs may be associated with communications via a physical downlink control channel (PDCCH) with repetition, communications via a PDCCH without repetition, PDCCH-single frequency network (SFN) communications, PDCCH-non SFN communications, or a combination thereof.

In some examples of the method, apparatuses, and non-transitory computer-readable medium described herein, the one or more capabilities include a capability of the UE to receive DCI associated with physical downlink shared channel (PDSCH) reception scheduling that includes a field to select, for reception of a PDSCH, one or more unified joint TCI states or one or more unified downlink TCI states indicated by a TCI codepoint.

In some examples of the method, apparatuses, and non-transitory computer-readable medium described herein, the one or more capabilities include a capability of the UE to receive DCI associated with physical uplink shared channel (PUSCH) reception scheduling that includes a field to select, for transmission of a PUSCH, one or more unified joint TCI states or one or more unified uplink TCI states indicated by a TCI codepoint.

In some examples of the method, apparatuses, and non-transitory computer-readable medium described herein, the one or more capabilities include a capability of the UE to receive control signaling that indicates whether the UE is to apply, to a configured grant (CG)-PUSCH transmission: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the one or more capabilities include a capability of the UE to switch between performing the multi-TRP operation and performing a single-TRP operation.

In some examples of the method, apparatuses, and non-transitory computer-readable medium described herein, the one or more capabilities include a capability of the UE to determine a beam failure detection (BFD) reference signal set based on one or more unified joint TCI states or one or more unified downlink TCI states indicated for the single DCI-based multi-TRP operation.

In some examples of the method, apparatuses, and non-transitory computer-readable medium described herein, the one or more capabilities include a capability of the UE to perform per-TRP beam reset in association with beam failure recovery (BFR).

In some examples of the method, apparatuses, and non-transitory computer-readable medium described herein, the one or more capabilities include a capability of the UE to support per-TRP default power control parameters.

In some examples of the method, apparatuses, and non-transitory computer-readable medium described herein, the one or more capabilities include a capability of the UE to support an offset threshold that may be specific to the single DCI-based multi-TRP operation, the offset threshold being a duration of time between a second control message that schedules a PDSCH or an aperiodic CSI-RS and a reception of the PDSCH or the aperiodic CSI-RS.

In some examples of the method, apparatuses, and non-transitory computer-readable medium described herein, the one or more capabilities include a capability of the UE to use a first indicated unified joint TCI state or a first indicated unified uplink TCI state as a default in association with a PUSCH transmission scheduled by DCI that lacks a field to select or indicate a unified TCI state.

In some examples of the method, apparatuses, and non-transitory computer-readable medium described herein, the one or more capabilities include a capability of the UE to receive control signaling that configures a PDSCH-coherent joint transmission (CJT) scheme associated with the single DCI-based multi-TRP operation.

In some examples of the method, apparatuses, and non-transitory computer-readable medium described herein, the one or more capabilities include a second capability of the UE that indicates a first quantity of unified joint TCI states or a second quantity of unified downlink TCI states supported by the UE for the PDSCH-CJT scheme.

In some examples of the method, apparatuses, and non-transitory computer-readable medium described herein, the one or more capabilities include a third capability of the UE to support QCL operation for the PDSCH-CJT scheme when two unified TCI states are indicated, where for the QCL operation: PDSCH demodulation reference signal (DMRS) ports may be QCLed with downlink reference signals of the two unified TCI states with respect to a first QCL type; or the PDSCH DMRS ports may be QCLed with the downlink reference signals with respect to the first QCL type except for a subset of QCL parameters associated with a second unified TCI state of the two unified TCI states; or the PDSCH DMRS ports may be QCLed with downlink reference signals a first unified TCI state of the two unified TCI states with respect to the first QCL type and QCLed with downlink reference signals of the second unified TCI state with respect to a second QCL type.

Some examples of the method, apparatuses, and non-transitory computer-readable medium described herein may further include operations, features, means, or instructions for transmitting second capability information indicating one or more second capabilities of the UE associated with a unified TCI framework for a single DCI-based single-TRP operation, where the capability information indicates that one or more of the one or more capabilities of the UE may be the same as corresponding capabilities of the one or more second capabilities indicated by the second capability information.

In some examples of the method, apparatuses, and non-transitory computer-readable medium described herein, the capability information includes a report that indicates the one or more capabilities of the UE in addition to one or more second capabilities of the UE associated with the unified TCI framework for a single DCI-based single TRP operation.

Some examples of the method, apparatuses, and non-transitory computer-readable medium described herein may further include operations, features, means, or instructions for transmitting second capability information indicating one or more second capabilities of the UE associated with a unified TCI framework for a single DCI-based single-TRP operation, where the capability information includes an indication that one or more third capabilities of the UE associated with the unified TCI framework for the single DCI-based multi-TRP operation that may be excluded from the capability information may be the same as corresponding capabilities of the one or more second capabilities included in the second capability information.

In some examples of the method, apparatuses, and non-transitory computer-readable medium described herein, the one or more capabilities may be specific to the UE, a frequency band, a frequency band combination, a feature set associated with the UE, a feature set per CC, a frequency division duplexing (FDD) configuration, a time division duplexing (TDD) configuration, a sub-millimeter wave (mmW) range of frequencies, a mmW range of frequencies, or a combination thereof.

A method for wireless communications at a network entity is described. The method may include receiving capability information indicating one or more capabilities of a UE associated with a unified TCI framework for a single DCI-based multi-TRP operation, transmitting, based on the capability information, a control message indicating one or more parameters for the single DCI-based multi-TRP operation, and transmitting DCI that schedules a multi-TRP operation in accordance with the one or more parameters.

An apparatus for wireless communications at a network entity is described. The apparatus may include a processor, memory coupled with the processor, and instructions stored in the memory. The instructions may be executable by the processor to cause the apparatus to receive capability information indicating one or more capabilities of a UE associated with a unified TCI framework for a single DCI-based multi-TRP operation, transmit, based on the capability information, a control message indicating one or more parameters for the single DCI-based multi-TRP operation, and transmit DCI that schedules a multi-TRP operation in accordance with the one or more parameters.

Another apparatus for wireless communications at a network entity is described. The apparatus may include means for receiving capability information indicating one or more capabilities of a UE associated with a unified TCI framework for a single DCI-based multi-TRP operation, means for transmitting, based on the capability information, a control message indicating one or more parameters for the single DCI-based multi-TRP operation, and means for transmitting DCI that schedules a multi-TRP operation in accordance with the one or more parameters.

A non-transitory computer-readable medium storing code for wireless communications at a network entity is described. The code may include instructions executable by a processor to receive capability information indicating one or more capabilities of a UE associated with a unified TCI framework for a single DCI-based multi-TRP operation, transmit, based on the capability information, a control message indicating one or more parameters for the single DCI-based multi-TRP operation, and transmit DCI that schedules a multi-TRP operation in accordance with the one or more parameters.

In some examples of the method, apparatuses, and non-transitory computer-readable medium described herein, the one or more capabilities include a capability of the UE to receive control signaling that activates a TCI codepoint mapped to one or more unified joint TCI states, one or more unified downlink TCI states, or one or more unified uplink TCI states per CC in a band.

In some examples of the method, apparatuses, and non-transitory computer-readable medium described herein, the one or more capabilities include a second capability of the UE to: update a first subset of unified TCI states of a set of activated unified TCI states based on the TCI codepoint being mapped to the first subset and maintain a second subset of unified TCI states of the set of activated unified TCI states based on the TCI codepoint lacking a mapping to the second subset.

In some examples of the method, apparatuses, and non-transitory computer-readable medium described herein, at least one TCI codepoints of a set of TCI codepoints including the TCI codepoint may be mapped to two unified joint TCI states, two unified downlink TCI states, or two unified uplink TCI states.

In some examples of the method, apparatuses, and non-transitory computer-readable medium described herein, the one or more capabilities include a capability of the UE to receive control signaling that activates a TCI codepoint mapped to up to two unified joint TCI states, two unified downlink TCI states, or two unified uplink TCI states.

In some examples of the method, apparatuses, and non-transitory computer-readable medium described herein, the one or more capabilities include a capability of the UE to support common TCI state identifier update and activation for a set of CCs associated with the single DCI-based multi-TRP operation.

In some examples of the method, apparatuses, and non-transitory computer-readable medium described herein, the one or more capabilities include a capability of the UE to receive control signaling that indicates whether the UE is to apply, to an aperiodic CSI-RS resource or an aperiodic CSI-RS resource set: a first unified joint TCI state or a second unified joint TCI state indicated by a second control message; or a first unified downlink TCI state or a second unified downlink TCI state indicated by the second control message.

In some examples of the method, apparatuses, and non-transitory computer-readable medium described herein, the one or more capabilities comprise a capability of the UE to receive control signaling that indicates whether the UE is to apply, to a PUCCH resource or group: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the one or more capabilities include a capability of the UE to receive control signaling that indicates whether the UE is to apply, to a CORESET or group of CORESETs: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the CORESET or group of CORESETs may be associated with communications via a PDCCH with repetition, communications via a PDCCH without repetition, PDCCH-single frequency network communications, PDCCH-non single frequency network communications, or a combination thereof.

In some examples of the method, apparatuses, and non-transitory computer-readable medium described herein, the one or more capabilities include a capability of the UE to receive DCI associated with PDSCH reception scheduling that includes a field to select, for reception of a PDSCH, one or more unified joint TCI states or one or more unified downlink TCI states indicated by a TCI codepoint.

In some examples of the method, apparatuses, and non-transitory computer-readable medium described herein, the one or more capabilities include a capability of the UE to receive DCI associated with PUSCH reception scheduling that includes a field to select, for transmission of a PUSCH, one or more unified joint TCI states or one or more unified uplink TCI states indicated by a TCI codepoint.

In some examples of the method, apparatuses, and non-transitory computer-readable medium described herein, the one or more capabilities include a capability of the UE to receive control signaling that indicates whether the UE is to apply, to a CG-PUSCH transmission: a first unified joint TCI state, a second unified joint TCI state, or both, indicated by a second control message; or a first unified uplink TCI state, a second unified uplink TCI state, or both, indicated by the second control message.

In some examples of the method, apparatuses, and non-transitory computer-readable medium described herein, the one or more capabilities include a capability of the UE to switch between performing the multi-TRP operation and performing a single-TRP operation.

In some examples of the method, apparatuses, and non-transitory computer-readable medium described herein, the one or more capabilities include a capability of the UE to determine a BFD reference signal set based on one or more unified joint TCI states or one or more unified downlink TCI states indicated for the single DCI-based multi-TRP operation.

In some examples of the method, apparatuses, and non-transitory computer-readable medium described herein, the one or more capabilities include a capability of the UE to perform per-TRP beam reset in association with BFR.

In some examples of the method, apparatuses, and non-transitory computer-readable medium described herein, the one or more capabilities include a capability of the UE to support per-TRP default power control parameters.

In some examples of the method, apparatuses, and non-transitory computer-readable medium described herein, the one or more capabilities include a capability of the UE to support an offset threshold that may be specific to the single DCI-based multi-TRP operation, the offset threshold being a duration of time between a second control message that schedules a PDSCH or an aperiodic CSI-RS and a reception of the PDSCH or the aperiodic CSI-RS.

In some examples of the method, apparatuses, and non-transitory computer-readable medium described herein, the one or more capabilities include a capability of the UE to use a first indicated unified joint TCI state or a first indicated unified uplink TCI state as a default in association with a PUSCH transmission scheduled by DCI that lacks a field to select or indicate a unified TCI state.

In some examples of the method, apparatuses, and non-transitory computer-readable medium described herein, the one or more capabilities include a capability of the UE to receive control signaling that configures a PDSCH-CJT scheme associated with the single DCI-based multi-TRP operation.

In some examples of the method, apparatuses, and non-transitory computer-readable medium described herein, the one or more capabilities include a second capability of the UE that indicates a first quantity of unified joint TCI states or a second quantity of unified downlink TCI states supported by the UE for the PDSCH-CJT scheme.

In some examples of the method, apparatuses, and non-transitory computer-readable medium described herein, the one or more capabilities include a third capability of the UE to support QCL operation for the PDSCH-CJT scheme when two unified TCI states are indicated, where for the QCL operation: PDSCH DMRS ports may be QCLed with downlink reference signals of the two unified TCI states with respect to a first QCL type; or the PDSCH DMRS ports may be QCLed with the downlink reference signals with respect to the first QCL type except for a subset of QCL parameters associated with a second unified TCI state of the two unified TCI states; or the PDSCH DMRS ports may be QCLed with downlink reference signals a first unified TCI state of the two unified TCI states with respect to the first QCL type and QCLed with downlink reference signals of the second unified TCI state with respect to a second QCL type.

Some examples of the method, apparatuses, and non-transitory computer-readable medium described herein may further include operations, features, means, or instructions for receiving second capability information indicating one or more second capabilities of the UE associated with a unified TCI framework for a single DCI-based single-TRP operation, where the capability information indicates that one or more of the one or more capabilities of the UE may be the same as corresponding capabilities of the one or more second capabilities indicated by the second capability information.

In some examples of the method, apparatuses, and non-transitory computer-readable medium described herein, the capability information includes a report that indicates the one or more capabilities of the UE in addition to one or more second capabilities of the UE associated with the unified TCI framework for a single DCI-based single TRP operation.

Some examples of the method, apparatuses, and non-transitory computer-readable medium described herein may further include operations, features, means, or instructions for receiving second capability information indicating one or more second capabilities of the UE associated with a unified TCI framework for a single DCI-based single-TRP operation, where the capability information includes an indication that one or more third capabilities of the UE associated with the unified TCI framework for the single DCI-based multi-TRP operation that may be excluded from the capability information may be the same as corresponding capabilities of the one or more second capabilities included in the second capability information.

In some examples of the method, apparatuses, and non-transitory computer-readable medium described herein, the one or more capabilities may be specific to the UE, a frequency band, a frequency band combination, a feature set associated with the UE, a feature set per CC, a FDD configuration, a TDD configuration, a sub-mmW range of frequencies, a mmWrange of frequencies, or a combination thereof.

A method for wireless communications at a UE is described. The method may include transmitting capability information indicating one or more capabilities of the UE associated with a unified TCI framework for a multi-TRP operation, receiving, based on the capability information, a control message indicating one or more parameters for the multi-TRP operation, receiving at least one DCI that schedules a multi-TRP operation in accordance with the one or more parameters, and performing the multi-TRP operation.

An apparatus for wireless communications at a UE is described. The apparatus may include a processor, memory coupled with the processor, and instructions stored in the memory. The instructions may be executable by the processor to cause the apparatus to transmit capability information indicating one or more capabilities of the UE associated with a unified TCI framework for a multi-TRP operation, receive, based on the capability information, a control message indicating one or more parameters for the multi-TRP operation, receive at least one DCI that schedules a multi-TRP operation in accordance with the one or more parameters, and perform the multi-TRP operation.

Another apparatus for wireless communications at a UE is described. The apparatus may include means for transmitting capability information indicating one or more capabilities of the UE associated with a unified TCI framework for a multi-TRP operation, means for receiving, based on the capability information, a control message indicating one or more parameters for the multi-TRP operation, means for receiving at least one DCI that schedules a multi-TRP operation in accordance with the one or more parameters, and means for performing the multi-TRP operation.

A non-transitory computer-readable medium storing code for wireless communications at a UE is described. The code may include instructions executable by a processor to transmit capability information indicating one or more capabilities of the UE associated with a unified TCI framework for a multi-TRP operation, receive, based on the capability information, a control message indicating one or more parameters for the multi-TRP operation, receive at least one DCI that schedules a multi-TRP operation in accordance with the one or more parameters, and perform the multi-TRP operation.

In some examples of the method, apparatuses, and non-transitory computer-readable medium described herein, the multi-TRP operation is a single DCI-based multi-TRP operation, where the one or more parameters are for the single DCI-based multi-TRP operation, and where the at least one DCI is a single DCI that schedules the multi-TRP operation.

In some examples of the method, apparatuses, and non-transitory computer-readable medium described herein, the multi-TRP operation is a multi DCI-based multi-TRP operation, where the one or more parameters are for the multi DCI-based multi-TRP operation, where the at least one DCI is a set of multiple DCIs received from a respective set of multiple TRPs, and where the set of multiple DCIs schedule the multi-TRP operation with the respective set of multiple TRPs.

A method for wireless communications at a network entity is described. The method may include receiving capability information indicating one or more capabilities of a UE associated with a unified TCI framework for a multi-TRP operation, transmitting, based on the capability information, a control message indicating one or more parameters for the multi-TRP operation, and transmitting at least one DCI that schedules a multi-TRP operation in accordance with the one or more parameters.

An apparatus for wireless communications at a network entity is described. The apparatus may include a processor, memory coupled with the processor, and instructions stored in the memory. The instructions may be executable by the processor to cause the apparatus to receive capability information indicating one or more capabilities of a UE associated with a unified TCI framework for a multi-TRP operation, transmit, based on the capability information, a control message indicating one or more parameters for the multi-TRP operation, and transmit at least one DCI that schedules a multi-TRP operation in accordance with the one or more parameters.

Another apparatus for wireless communications at a network entity is described. The apparatus may include means for receiving capability information indicating one or more capabilities of a UE associated with a unified TCI framework for a multi-TRP operation, means for transmitting, based on the capability information, a control message indicating one or more parameters for the multi-TRP operation, and means for transmitting at least one DCI that schedules a multi-TRP operation in accordance with the one or more parameters.

A non-transitory computer-readable medium storing code for wireless communications at a network entity is described. The code may include instructions executable by a processor to receive capability information indicating one or more capabilities of a UE associated with a unified TCI framework for a multi-TRP operation, transmit, based on the capability information, a control message indicating one or more parameters for the multi-TRP operation, and transmit at least one DCI that schedules a multi-TRP operation in accordance with the one or more parameters.

In some examples of the method, apparatuses, and non-transitory computer-readable medium described herein, the multi-TRP operation is a single DCI-based multi-TRP operation, where the one or more parameters are for the single DCI-based multi-TRP operation, and where the at least one DCI is a single DCI that schedules the multi-TRP operation.

In some examples of the method, apparatuses, and non-transitory computer-readable medium described herein, the multi-TRP operation is a multi DCI-based multi-TRP operation, where the one or more parameters are for the multi DCI-based multi-TRP operation, where the at least one DCI is a set of multiple DCIs transmitted via a respective set of multiple TRPs, and where the set of multiple DCIs schedule the multi-TRP operation with the respective set of multiple TRPs.

### BRIEF DESCRIPTION OF THE DRAWINGS

FIG. 1 shows an example of a wireless communications system that supports unified TCI state indication for single or multi-DCI based multi-TRP operation in accordance with one or more aspects of the present disclosure.

FIG. 2 shows an example of a wireless communications system that supports unified TCI state indication for single or multi-DCI based multi-TRP operation in accordance with one or more aspects of the present disclosure.

FIG. 3 shows an example of a wireless communications system that supports unified TCI state indication for single or multi-DCI based multi-TRP operation in accordance with one or more aspects of the present disclosure.

FIG. 4 shows an example of a process flow that supports unified TCI state indication for single or multi-DCI based multi-TRP operation in accordance with one or more aspects of the present disclosure.

FIGS. 5 and 6 show diagrams of devices that support unified TCI state indication for single or multi-DCI based multi-TRP operation in accordance with one or more aspects of the present disclosure.

FIG. 7 shows a diagram of a communications manager that supports unified TCI state indication for single or multi-DCI based multi-TRP operation in accordance with one or more aspects of the present disclosure.

FIG. 8 shows a diagram of a system including a device that supports unified TCI state indication for single or multi-DCI based multi-TRP operation in accordance with one or more aspects of the present disclosure.

FIGS. 9 and 10 show diagrams of devices that support unified TCI state indication for single or multi-DCI based multi-TRP operation in accordance with one or more aspects of the present disclosure.

FIG. 11 shows a diagram of a communications manager that supports unified TCI state indication for single or multi-DCI based multi-TRP operation in accordance with one or more aspects of the present disclosure.

FIG. 12 shows a diagram of a system including a device that supports unified TCI state indication for single or multi-DCI based multi-TRP operation in accordance with one or more aspects of the present disclosure.

FIGS. 13 through 18 show flowcharts illustrating methods that support unified TCI state indication for single or multi-DCI based multi-TRP operation in accordance with one or more aspects of the present disclosure.

### DETAILED DESCRIPTION

A UE may communicate with a network entity via multiple transmission reception points (TRP)s within a multi-TRP configuration. In single downlink control information (s-DCI) multi-TRP operations, a single DCI received from one TRP schedules a shared channel communication (e.g., a physical uplink shared channel (PUSCH) or a physical downlink shared channel (PDSCH)) to be performed with the multiple TRPs. In multi-DCI multi-TRP operations, the UE receives respective DCIs from each of the multiple TRPs, and each DCI schedules the shared channel communication to be performed with the corresponding TRP of the multiple TRPs.

A UE may be configured with or activated with unified transmission configuration indicator (TCI) states for one or more channels or signals. For example, a joint unified TCI state indicates a common beam for at least one downlink channel or reference signal and at least one uplink channel or reference signal, a downlink unified TCI state indicates a common beam for more than one downlink channel or reference signal, and an uplink unified TCI state indicates a common beam for more than one uplink channel or reference signal. Application of unified TCI states to multi-TRP operation enables TCI states to be reused for different channels communicated with the different TRPs. For example, a UE that receives a DCI scheduling a shared channel transmission via a control resource set (CORESET) that is included within a CORESET pool index may apply the unified TCI state that is associated with that CORESET pool index to the shared channel transmission. A unified TCI state framework cannot be configured for a UE, however, unless the UE indicates capabilities associated with the application of the unified TCI state framework to multi-DCI based multi-TRP operation.

Aspects of the present disclosure describe UE capabilities that may support implementation of the unified TCI state framework to single or multi-DCI based multi-TRP operation. A UE may transmit capability information (e.g., via radio resource control (RRC)) to the network (e.g., to a serving network entity that includes multiple TRPs) that indicates capabilities of the UE associated with the application of the unified TCI state framework to single and/or multi-DCI based multi-TRP operation. The capability information may identify new UE capabilities (and values) that pertain to single and/or multi-DCI based multi-TRP operation. The capability information may also include existing capabilities (e.g., capabilities associated with single TRP operation) that may still pertain to single and/or multi-DCI based multi-TRP operation, but may have situationally-specific values. Once the UE capabilities have been reported, the network entity may transmit control signaling (e.g., via RRC) indicating parameters for the single or multi-DCI based multi-TRP operation. In some examples, the UE may receive multiple DCIs from the multiple TRPs that schedule a multi-TRP operation (e.g., a shared channel transmission between the UE and the multiple TRPs). In some examples, the UE may receive a single DCI from the network entity that schedules a multi-TRP operation (e.g., communication of one or more messages between the UE and the multiple TRPs).

Various capabilities may be indicated to support the multi-TRP operation. For example, the capabilities may include a capability of the UE to receive a medium access control (MAC) control element (CE) that activates one or more unified TCI states (e.g., joint or separate uplink and downlink) per CORESET pool index. As another example, the capabilities may include a capability of the UE to apply the unified TCI state that is associated with a CORESET pool index to a shared channel transmission when the DCI that scheduled the shared channel transmission was received via a CORESET included in the CORESET pool index. As another example, the capabilities may include a capability of the UE to receive DCI that selects one or more activated unified TCI states to apply, such as for a scheduled transmission. As another example, the capabilities may include a capability of the UE to receive an indication of a unified TCI state (e.g., based on a reference to the CORESET pool index) to apply to given physical uplink control channel (PUCCH) resources or configured grant (CG) occasions. As another example the UE may indicate the capability of the UE to receive different uplink power control settings per TRP or per unified TCI state. As another example, the UE may indicate the capability of the UE to support the unified TCI state framework for inter-cell multi-TRP (e.g., one unified TCI state for a service cell and another unified TCI state for another physical cell identifier). As another example, when performing a beam failure recovery (BFR) procedure, the UE may update parameters such as the quasi co-location (QCL) assumption, spatial transmission filter, or pathloss reference signal that applied to a unified TCI state based on updating the beam associated with the unified TCI state during the beam failure recovery procedure. As another example, the capabilities may include a capability of the UE to support common TCI state update and activation for multiple component carriers (CCs), such as for a list of CCs configured for single DCI-based multi-TRP operation. As another example, the capabilities may include a capability of the UE to support per aperiodic channel state information reference signal (CSI-RS) resource or resource set TCI association, per PUCCH resource or group TCI association, and/or per CORESET TCI association. As another example, the capabilities may include a capability of the UE to support a unified TCI selection indication for PDSCH transmission and/or for PUSCH transmission, such as to support dynamic downlink TRP switching and dynamic uplink TRP switching, respectively. As another example, the capabilities may include a capability of the UE to support CG TCI association, BFR operations, per-TRP default power control parameters, single DCI-based multi-TRP specific scheduling offsets, unified TCI operation in association with fallback DCI transmission (e.g., DCI that lacks a TCI selection or TCI indication field), PDSCH-coherent joint transmission (CJT) configuration, or a combination thereof.

Aspects of the disclosure are initially described in the context of wireless communications systems. Aspects of the disclosure are further illustrated by and described with reference to process flows, apparatus diagrams, system diagrams, and flowcharts that relate to unified TCI state indication for single or multi-DCI based multi-TRP operation.

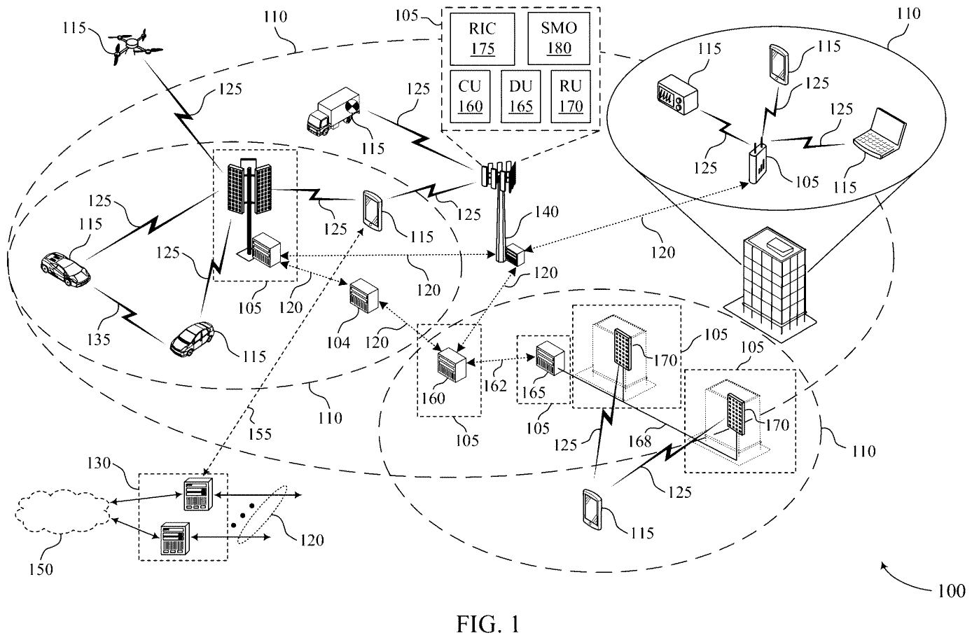

FIG. 1 shows an example of a wireless communications system 100 that supports unified TCI state indication for single or multi-DCI based multi-TRP operation in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115—and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115—are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support unified TCI state indication for single or multi-DCI based multi-TRP operation as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCI), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, a UE 115 may communicate with a network entity 105 via multiple TRPs within a multi-TRP configuration. In s-DCI multi-TRP operations, a single DCI received by the UE 115 from one TRP schedules a shared channel communication (e.g., a PUSCH or a PDSCH) to be performed with the multiple TRPs. In multi-DCI based multi-TRP operations, the UE 115 receives respective DCIs from each of the multiple TRPs, and each respective DCI schedules the shared channel communication to be performed with the corresponding TRP.

A UE 115 may be configured with or activated with unified TCI states for one or more channels or signals. For example, a joint unified TCI state indicates a common beam for at least one downlink channel or reference signal and at least one uplink channel or reference signal (e.g., including UE-specific physical downlink control channel (PDCCH), PDSCH, PUCCH, PUSCH, a CSI-RS, and/or a sounding reference signal (SRS)). A downlink unified TCI state indicates a common beam for more than one downlink channel or reference signal (e.g., including UE-specific PDCCH, PDSCH, and/or CSI-RS). An uplink unified TCI state indicates a common beam for more than one uplink channel or reference signal (e.g., including UE-specific PUCCH, PUSCH, and/or SRS). Application of unified TCI states to multi-TRP operation enables TCI states to be reused for different channels communicated with the different TRPs. For example, a UE 115 that receives a DCI scheduling a shared channel transmission via a CORESET that is included within a CORESET pool index may apply the unified TCI state that is associated with that CORESET pool index to the shared channel transmission. A unified TCI state framework cannot be configured for a UE 115, however, unless the UE 115 indicates capabilities associated with the application of the unified TCI state framework to multi-DCI based multi-TRP operation.

A UE 115 may transmit capability information (e.g., via RRC) to the network (e.g., to a serving network entity 105 that includes multiple TRPs) that indicates capabilities of the UE 115 associated with the application of the unified TCI state framework to single and/or multi-DCI based multi-TRP operation. The capability information may identify new capabilities of the UE 115 (and values) that pertain to single and/or multi-DCI based multi-TRP operation. The capability information may also include existing capabilities (e.g., capabilities associated with single TRP operation) that may still pertain to multi-DCI based multi-TRP operation, but may have situationally-specific values. Once the capabilities of the UE 115 have been reported, the network entity 105 may transmit control signaling (e.g., via RRC) indicating parameters for the single and/or multi-DCI based multi-TRP operation. In some examples, the UE 115 may receive multiple DCIs from the multiple TRPs that schedule a multi-TRP operation (e.g., a shared channel transmission between the UE 115 and the multiple TRPs). As described herein, various capabilities may be indicated to support the multi-TRP operation. In some examples, the UE 115 may receive a single DCI that schedules a multi-TRP operation (e.g., communication of one or more messages between the UE and the multiple TRPs).

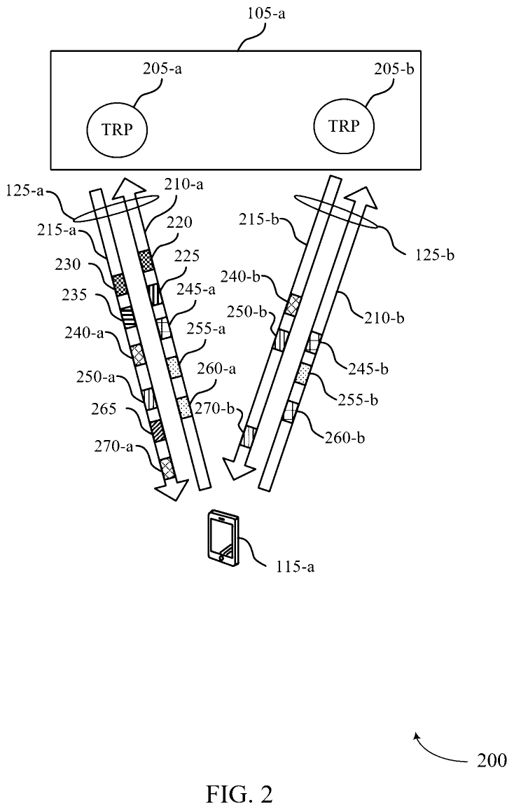

FIG. 2 shows an example of a wireless communications system 200 that supports unified TCI state indication for single or multi-DCI based multi-TRP operation in accordance with one or more aspects of the present disclosure. The wireless communications system 200 may implement aspects of wireless communications system 100. For example, the wireless communications system 200 may include a network entity 105-a, which may be an example of a network entity 105 as described herein, and the wireless communications system 200 may include a UE 115-a, which may be an example of a UE 115 as described herein.

The network entity 105-a may include multiple TRPs. For example, as shown in FIG. 2, the network entity 105-a includes a first TRP 205-a and a second TRP 205-b. The UE 115-a and the network entity 105-a may communicate in a multi-DCI based multi-TRP operation, as described herein. For example, the UE 115-a may communicate with the first TRP 205-a using a communication link 125-a and the UE 115-a may communicate with the second TRP 205-b using a communication link 125-b. The communication link 125-a and the communication link 125-b may be examples of a communication link 125 as described herein. For example, the communication link 125-a and the communication link 125-b may include bi-directionals link that enable both uplink and downlink communications. For example, the UE 115-a may transmit uplink signals 210-a (e.g., uplink transmissions), such as uplink control signals or uplink data signals, to the network entity 105-a via the first TRP 205-a using the communication link 125-a, and the network entity 105-a may transmit downlink signals 215-a (e.g., downlink transmissions), such as downlink control signals or downlink data signals, to the UE 115-a via the first TRP 205-a using the communication link 125-a. The UE 115-a may transmit uplink signals 210-b (e.g., uplink transmissions), such as uplink control signals or uplink data signals, to the network entity 105-a via the second TRP 205-b using the communication link 125-b, and the network entity 105-a may transmit downlink signals 215-b (e.g., downlink transmissions), such as downlink control signals or downlink data signals, to the UE 115-a via the second TRP 205-b using the communication link 125-b.

The UE 115-a may support a unified TCI state framework as described herein. The UE 115-a may transmit capability information 220 (e.g., via RRC) to the network entity 105-a that indicates capabilities of the UE 115-a associated with the application of the unified TCI state framework to multi-DCI based multi-TRP operation. In some aspects, the UE 115-a may indicate the capability information 220 at different granularities. For example, the capability information 220 may indicate the capabilities of the UE 115-a per UE, per band, per band combination, per feature set, or per feature set per CC. In some aspects the capability information 220 may indicate the capabilities of the UE 115-a in TDD and FDD, in frequency range (FR) 1 and FR2, or a combination of TDD, FDD, FR1, and FR2.

In some aspects, the UE 115-a may transmit second capability information 225 to the network entity 105-a that indicates capabilities of the UE 115-a associated with the application of the unified TCI state framework to single TRP operation. In some aspects, the capability information 220 and the second capability information 225 may be transmitted in a same control message. In some aspects, the capability information 220 and the second capability information 225 may be transmitted in separate control messages. In some aspects, some of the capabilities of the UE 115-a may be the same for multi-DCI based multi-TRP operation and single TRP operation. In such cases, in some examples, the UE 115-a may list the capabilities for multi-DCI based multi-TRP operation and single TRP operation in two separate reports, and may indicate that some of the capabilities for multi-DCI based multi-TRP operation are the same as the capabilities for single TRP operation. In some examples, the UE 115-a may indicate the capability information 220 and the second capability information 225 in a same capability report, and may indicate separate values in the capability report for multi-DCI based multi-TRP operation and single TRP operation. In such cases, a multi-DCI based multi-TRP operation may have the same or a different value from the corresponding value for the single TRP operation based on the capability of the UE 115-a. In some examples, the UE 115-a may not list or indicate the capabilities that are the same for the multi-DCI based multi-TRP operation and the single TRP operation in a capability report that indicates the UE capability for multi-DCI based multi-TRP operation. In such examples, the network entity 105-a may understand to use the corresponding capability indicated in the capability report for the single TRP operation.

In response to the capability information 220, the network entity 105-a may transmit control signaling 230 (e.g., via RRC) indicating parameters for the multi-DCI based multi-TRP operation. The UE 115-a may subsequently receive DCIs from the multiple TRPs that schedule a multi-TRP operation. For example, a DCI 240-a from the first TRP 205-a may schedule a PUSCH 245-a and a DCI 240-b from the second TRP 205-b may schedule a PUSCH 245-b, where transmission of the PUSCH 245-a and the PUSCH 245-b are a multi-TRP operation. As another example, the DCI 240-a from the first TRP 205-a may schedule a PDSCH 250-a and the DCI 240-b from the second TRP 205-b may schedule a PDSCH 250-b, where reception of the PDSCH 250-a and the PDSCH 250-b are a multi-TRP operation. As another example, the DCI 240 may schedule a PUCCH 255-a and a PUCCH 255-b for transmission by the UE 115-a, where communication of the PUCCH 255-a and the PUCCH 255-b are a multi-TRP operation. As another example, the DCI 240 may schedule a CG PUSCH 260-a and a CG PUSCH 260-b for transmission by the UE 115-a, where communication of the CG PUSCH 260-a and the CG PUSCH 260-b are a multi-TRP operation. As another example, the DCI 240 may schedule a CSI-RS 265 a and a CSI-RS 265 b for reception by the UE 115-a, where communication of the CSI-RS 265 a and the CSI-RS 265 b are a multi-TRP operation. As another example, the DCI 240 may schedule a PDCCH 270-a and a PDCCH 270-b for reception by the UE 115-a, where communication of the PDCCH 270-a and the PDCCH 270-b are a multi-TRP operation.

In some aspects, the capability information 220 may indicate that the UE 115-a supports joint unified TCI state operation for intra-cell multi-TRP, including a basic set (e.g., a single activated TCI codepoint). In such aspects, the capability information 220 may indicate that the UE 115-a supports a joint unified TCI state update with the corresponding components of the TCI state (e.g., configuration mechanism, QCL rules, and applicable source and target signals). In such aspects, the capability information 220 may also indicate the maximum quantity of configured joint unified TCI states per BWP per CC in a band. In some examples, the capability information 220 may indicate that the UE 115-a supports reception of one MAC-CE 235 activated joint unified TCI state per CC in a band, where at least one codepoint is mapped to one joint unified TCI state per a CORESET pool index. In such aspects, the capability information 220 may indicate that the UE 115-a supports MAC-CE based TCI state indication for 2 activated codepoints mapped to 2 joint TCIs with the same PCI. In some aspects, the capability information 220 may indicate that the UE 115-a supports TCI state indication for updating and/or activation of a TCI state (e.g., via a MAC-CE 235). For example, a CORESET pool index value field may be included in a TCI state activation command (e.g., in a MAC-CE 235) to indicate the mapping between the activated joint unified TCI state and the TCI codepoint is specific to the indicated CORESET pool index. As another example, the UE 115-a may support a MAC-CE based TCI state indication for a single activated TCI codepoint mapped to up to 1 joint unified TCI state per CORESET pool index. In some aspects, the capability information 220 may indicate the maximum quantity of MAC-CE activated joint unified TCI states across all CCs in a band the UE 115-a may support. In some aspects, the capability information 220 may indicate that the UE 115-a supports per BWP TCI state pool configuration for carrier aggregation (CA) mode (e.g., and/or that the UE 115-a supports TCI state pool configuration per BWP for CA mode).

In some aspects, the capability information 220 may indicate that the UE 115-a supports joint unified TCI state operation for inter-cell multi-TRP, including a basic set (e.g., a single activated TCI codepoint). For joint unified TCI state framework, the capability information 220 may indicate that the UE 115-a supports the joint unified TCI state framework for inter-cell multi-TRP. In such cases, TCI activation may be per PCI, and two indicated TCIs may be for different PCIs.

In some aspects, the capability information 220 may indicate that the UE 115-a supports separate downlink and uplink unified TCI operation for intra-cell multi-TRP, including a basic set (e.g., a single activated TCI codepoint). In such aspects, the capability information 220 may indicate that the UE 115-a supports separate TCI state updates for downlink and uplink unified TCI states with the corresponding components of the TCI state (e.g., configuration mechanism, QCL rules, and applicable source and target signals). In such aspects, the capability information 220 may also indicate the maximum quantity of configured downlink unified TCI states per BWP per CC in a band. In such aspects, the capability information 220 may also indicate the maximum quantity of configured uplink unified TCI states per BWP per CC in a band. In some examples, the capability information 220 may indicate that the UE 115-a supports reception of one MAC-CE 235 activated downlink or uplink unified TCI state per CC in a band, where at least one codepoint is mapped to up to one downlink or uplink unified TCI state per a CORESET pool index. In some aspects, the capability information 220 may indicate that the UE 115-a supports TCI state indication for update and/or activation of a TCI state (e.g., via a MAC-CE 235). For example, a CORESET pool index value field may be included in a TCI state activation command (e.g., in a MAC-CE 235) to indicate the mapping between the activated downlink or uplink unified TCI state(s) and the TCI codepoint(s) is specific to the indicated CORESET pool index. As another example, the UE 115-a may support a MAC-CE based TCI state indication for a single activated TCI codepoint mapped to up to 1 downlink unified TCI state and 1 uplink unified TCI state per CORESET pool index. In some aspects, the capability information 220 may indicate the maximum quantity of MAC-CE activated downlink and uplink unified TCI states the UE 115-a may support across all CCs in a band. In some aspects, the capability information 220 may indicate that the UE 115-a supports per BWP TCI state pool configuration for carrier aggregation (CA) mode (e.g., and/or that the UE 115-a supports TCI state pool configuration per BWP for CA mode). In some examples where the UE 115-a supports one MAC-CE 235 activated separate unified TCI state per CC in a band, at least one TCI codepoint is mapped to one downlink unified TCI state and/or one uplink unified TCI state. For example, the UE 115-a may be activated with 2 downlink unified TCI states and 1 uplink unified TCI state if the UE 115-a supports at least 2 active downlink unified TCI states across all CC(s) in a band, or may be activated with 1 downlink unified TCI state and 2 uplink unified TCI states if the UE 115-a supports at least 1 active uplink unified TCI states across all CC(s) in a band, or may be activated with 2 downlink unified TCI states and 2 uplink unified TCI states if the UE 115-a supports at least 2 active downlink unified TCI states and two active uplink unified TCI states across all CC(s) in a band, where the UE 115-a may support at least 1 of 3 combinations with 2 indicated downlink unified TCI states and/or 2 indicated uplink unified TCI states for the same PCI.

In some aspects, the capability information 220 may indicate that the UE 115-a supports separate downlink and uplink unified TCI operation for inter-cell multi-TRP, including a basic set (e.g., a single activated TCI codepoint). For separate unified TCI state framework, the capability information 220 may indicate that the UE 115-a supports the separate unified TCI state framework for inter-cell multi-TRP. In such cases, TCI state activation may be per PCI, and 2 indicated downlink unified TCI states or 2 indicated uplink unified TCI states are for different PCIs.

In some aspects, the capability information 220 may indicate that the UE 115-a supports joint unified TCI operation for intra-cell multi-TRP, including an enhanced set (e.g., more than 1 TCI codepoint). In such aspects, the capability information 220 may indicate the supported TCI state indication for updating and/or activation of joint unified TCI states. For example, the capability information 220 may indicate that the UE 115-a supports a MAC-CE 235 based TCI state activation and DCI 240 based TCI state indication (e.g., use of DCI formats 1_1 or 1_2 with the downlink assignment). As another example, the capability information 220 may indicate that the UE 115-a supports a MAC-CE 235 based TCI state activation and DCI based TCI state indication (e.g., use of DCI formats 1_1 or 1_2 without the downlink assignment). In some aspects, the capability information 220 may indicate the maximum supported number of MAC-CE activated joint unified TCI states per CC in a band for the enhanced set operation. The 2 activated joint unified TCI states are for the same PCI. In some aspects, the capability information 220 may indicate a minimum beam application time in a number of symbols per subcarrier spacing (SCS). In some aspects, the capability information 220 may indicate that the UE 115-a supports a TCI indication field in a DCI format 1_1 and/or 1_2 (e.g., with or without downlink assignment) associated with one CORESET pool index value, where the TCI indication field indicates the joint unified TCI state specific to the same CORESET pool index value. In some aspects, the capability information 220 may indicate that the UE 115-a supports a joint unified TCI activation and/or indication per CORESET pool index.

In some aspects, the capability information 220 may indicate that the UE 115-a supports separate downlink and uplink unified TCI operation for intra-cell multi-TRP, including an enhanced set (e.g., more than 1 TCI codepoint). In such aspects, the capability information 220 may indicate the supported TCI state indication for updating and/or activation of separate downlink and uplink unified TCI states. For example, the capability information 220 may indicate that the UE 115-a supports a MAC-CE 235 based TCI state activation and DCI 240 based TCI state indication (e.g., use of DCI formats 1_1 or 1_2 with the downlink assignment). As another example, the capability information 220 may indicate that the UE 115-a supports a MAC-CE 235 based TCI state activation and DCI based TCI state indication (e.g., use of DCI formats 1_1 or 1_2 without the downlink assignment). The 2 activated downlink unified TCIs or 2 activated uplink unified TCIs are for the same PCI. In some aspects, the capability information 220 may indicate a minimum beam application time in a quantity of symbols per SCS. In some aspects, the capability information 220 may indicate the maximum supported quantity of MAC-CE activated downlink unified TCI states per CC in a band for the enhanced set operation. In some aspects, the capability information 220 may indicate the maximum supported quantity of MAC-CE activated uplink unified TCI states per CC in a band for the enhanced set operation. In some aspects, the capability information 220 may indicate that the UE 115-a supports a TCI indication field in a DCI format 1_1 and/or 1_2 (e.g., with or without downlink assignment) associated with one CORESET pool index value, where the TCI indication field indicates the downlink and/or uplink unified TCI states specific to the same CORESET pool index value. In some aspects, the capability information 220 may indicate that the UE 115-a supports a separate downlink and uplink unified TCI activation and/or indication per CORESET pool index.

For joint unified TCI state operation, the capability information 220 may indicate that the UE 115-a supports per CORESET pool index joint unified TCI state association for PDSCH. For example, to determine which joint unified TCI state to apply to a PDSCH, the UE 115-a may apply the joint unified TCI state indicated for a CORESET pool index value that includes the CORESET used to receive a PDCCH that schedules or activates the PDSCH. For example, the first TRP 205-a may be associated with a first CORESET pool index and the second TRP 205-b may be associated with a second CORESET pool index. The UE 115-a may receive a DCI 240-a via a first PDCCH using a first CORESET, and the DCI 240-a schedules a PDSCH 250-a. The UE 115-a may also receive a DCI 240-b via a second PDCCH using a second CORESET, and the DCI 240-b schedules a PDSCH 250-b. The first CORESET includes the first CORESET pool index and the second CORESET includes the second CORESET pool index. Accordingly, the UE 115-a applies the joint unified TCI state indicated for the first CORESET pool index (associated with the first TRP 205-a) to reception of the PDSCH 250-a and the UE 115-a applies the joint unified TCI state indicated for the second CORESET pool index (associated with the second TRP 205-b) to reception of the PDSCH 250-b.

For joint unified TCI state operation, the capability information 220 may indicate that the UE 115-a supports per CORESET pool index joint unified TCI state association for PUSCH. For example, to determine which joint unified TCI state to apply to a PUSCH, the UE 115-a may apply the joint unified TCI state indicated for a CORESET pool index value that includes the CORESET used to receive a PDCCH that schedules or activates the PUSCH. For example, the first TRP 205-a may be associated with a first CORESET pool index and the second TRP 205-b may be associated with a second CORESET pool index. The UE 115-a may receive a DCI 240-a via a first PDCCH using a first CORESET, and the DCI 240-a schedules a PUSCH 245-a. The UE 115-a may also receive a DCI 240-b via a second PDCCH using a second CORESET, and the DCI 240-b schedules a PUSCH 245-b. The first CORESET includes the first CORESET pool index and the second CORESET includes the second CORESET pool index. Accordingly, the UE 115-a applies the joint unified TCI state indicated for the first CORESET pool index (associated with the first TRP 205-a) to transmission of the PUSCH 245-a and the UE 115-a applies the joint unified TCI state indicated for the second CORESET pool index (associated with the second TRP 205-b) to transmission of the PUSCH 245-b.

For separate downlink and uplink unified TCI state operation, the capability information 220 may indicate that the UE 115-a supports per CORESET pool index downlink unified TCI state association for PDSCH. For example, to determine which downlink unified TCI state to apply to a PDSCH, the UE 115-a may apply the downlink unified TCI state indicated for a CORESET pool index value that includes the CORESET used to receive a PDCCH that schedules or activates the PDSCH. For example, the first TRP 205-a may be associated with a first CORESET pool index and the second TRP 205-b may be associated with a second CORESET pool index. The UE 115-a may receive a DCI 240-a via a first PDCCH using a first CORESET, and the DCI 240-a schedules a PDSCH 250-a. The UE 115-a may also receive a DCI 240-b via a second PDCCH using a second CORESET, and the DCI 240-b schedules a PDSCH 250-b. The first CORESET includes the first CORESET pool index and the second CORESET includes the second CORESET pool index. Accordingly, the UE 115-a applies the downlink unified TCI state indicated for the first CORESET pool index (associated with the first TRP 205-a) to reception of the PDSCH 250-a and the UE 115-a applies the downlink unified TCI state indicated for the second CORESET pool index (associated with the second TRP 205-b) to reception of the PDSCH 250-b.

For separate downlink and uplink unified TCI state operation, the capability information 220 may indicate that the UE 115-a supports per CORESET pool index uplink unified TCI state association for PUSCH. For example, to determine which uplink unified TCI state to apply to a PUSCH, the UE 115-a may apply the uplink unified TCI state indicated for a CORESET pool index value that includes the CORESET used to receive a PDCCH that schedules or activates the PUSCH. For example, the first TRP 205-a may be associated with a first CORESET pool index and the second TRP 205-b may be associated with a second CORESET pool index. The UE 115-a may receive a DCI 240-a via a first PDCCH using a first CORESET, and the DCI 240-a schedules a PUSCH 245-a. The UE 115-a may also receive a DCI 240-b via a second PDCCH using a second CORESET, and the DCI 240-b schedules a PUSCH 245-b. The first CORESET includes the first CORESET pool index and the second CORESET includes the second CORESET pool index. Accordingly, the UE 115-a applies the uplink unified TCI state indicated for the first CORESET pool index (associated with the first TRP 205-a) to transmission of the PUSCH 245-a and the UE 115-a applies the uplink unified TCI state indicated for the second CORESET pool index (associated with the second TRP 205-b) to transmission of the PUSCH 245-b.

For joint unified TCI state operation, the capability information 220 may indicate that the UE 115-a supports per CORESET pool index TCI association for PUCCH. For example, the capability information 220 may indicate that the UE 115-a supports RRC configuration per PUCCH resource or PUCCH resource group that informs the UE to apply a first or second joint unified TCI state to the corresponding PUCCH resource or PUCCH resource group, where the first and the second indicated joint unified TCI states correspond to the indicated joint unified TCI states specific to specific to the first and second CORESET pool indices, respectively. For example, the first TRP 205-a may be associated with a first CORESET pool index and the second TRP 205-b may be associated with a second CORESET pool index. The RRC configuration may indicate that a first PUCCH resource or resource group is associated with the first CORESET pool index, and that a second PUCCH resource or resource group is associated with the second CORESET pool index. The UE 115-a may transmit a PUCCH 255-a in the first PUCCH resource or resource group using the joint unified TCI state indicated for the first CORESET pool index, and the UE 115-a may transmit a PUCCH 255-b in the second PUCCH resource or resource group using the joint unified TCI state indicated for the second CORESET pool index.

For separate downlink and uplink unified TCI state operation, the capability information 220 may indicate that the UE 115-a supports per CORESET pool index TCI association for PUCCH. For example, the capability information 220 may indicate that the UE 115-a supports RRC configuration per PUCCH resource or PUCCH resource group that informs the UE to apply a first or second uplink unified TCI state to the corresponding PUCCH resource or PUCCH resource group, where the first and the second indicated uplink unified TCI states correspond to the indicated uplink unified TCI states specific to specific to the first and second CORESET pool indices, respectively. For example, the first TRP 205-a may be associated with a first CORESET pool index and the second TRP 205-b may be associated with a second CORESET pool index. The RRC configuration may indicate that a first PUCCH resource or resource group is associated with the first CORESET pool index, and that a second PUCCH resource or resource group is associated with the second CORESET pool index. The UE 115-a may transmit a PUCCH 255-a in the first PUCCH resource or resource group using the uplink unified TCI state indicated for the first CORESET pool index, and the UE 115-a may transmit a PUCCH 255-b in the second PUCCH resource or resource group using the uplink unified TCI state indicated for the second CORESET pool index.

For joint unified TCI state operation, the capability information 220 may indicate that the UE 115-a supports per CORESET pool index TCI association for typel CG PUSCH. For example, the capability information 220 may indicate that the UE 115-a supports RRC configuration for a type 1 CG that informs the UE to apply a first or second joint unified TCI state to the corresponding CG PUSCH transmissions, where the first and the second indicated joint unified TCI states correspond to the indicated joint unified TCI states specific to the first and second CORESET pool indices, respectively. For example, the first TRP 205-a may be associated with a first CORESET pool index and the second TRP 205-b may be associated with a second CORESET pool index. The RRC configuration may indicate that a first CG PUSCH occasion is associated with the first CORESET pool index, and that a second CG PUSCH occasion is associated with the second CORESET pool index. The UE 115-a may transmit a CG PUSCH 260-a in the first CG PUSCH occasion using the joint unified TCI state indicated for the first CORESET pool index, and the UE 115-a may transmit a CG PUSCH 260-b in the second CG PUSCH occasion using the joint unified TCI state indicated for the second CORESET pool index.

For separate downlink and uplink unified TCI state operation, the capability information 220 may indicate that the UE 115-a supports per CORESET pool index TCI association for typel CG PUSCH. For example, the capability information 220 may indicate that the UE 115-a supports RRC configuration for a type 1 CG that informs the UE to apply a first or second uplink unified TCI state to the corresponding CG PUSCH transmissions, where the first and the second indicated uplink unified TCI states correspond to the indicated downlink unified TCI states specific to the first and second CORESET pool indices, respectively. For example, the first TRP 205-a may be associated with a first CORESET pool index and the second TRP 205-b may be associated with a second CORESET pool index. The RRC configuration may indicate that a first CG PUSCH occasion is associated with the first CORESET pool index, and that a second CG PUSCH occasion is associated with the second CORESET pool index. The UE 115-a may transmit a CG PUSCH 260-a in the first CG PUSCH occasion using the uplink unified TCI state indicated for the first CORESET pool index, and the UE 115-a may transmit a CG PUSCH-b in the second CG PUSCH occasion using the uplink unified TCI state indicated for the second CORESET pool index.

In some aspects, the capability information 220 may indicate that the UE 115-a supports per-CORESET or per-CORESET pool index TCI state association, such as for joint unified TCI state operation. For example, for joint unified TCI state operation, the capability information 220 may indicate that the UE 115-a supports reception of control signaling (e.g., RRC signaling) that indicates whether the UE 115-a is to apply, to a CORESET or CORESETs of a CORESET pool index, a first joint unified TCI state, or a second joint unified TCI state, indicated by a control message (e.g., a MAC-CE 235, DCI 240).

In some aspects, the capability information 220 may indicate that the UE 115-a supports per-CORESET or per-CORESET pool index TCI state association, such as for separate downlink and uplink unified TCI state operation. For example, for separate downlink and uplink unified TCI state operation, the capability information 220 may indicate that the UE 115-a supports reception of control signaling (e.g., RRC signaling) that indicates whether the UE 115-a is to apply, to a CORESET or CORESETs of a CORESET pool index, a first downlink unified TCI state, or a second downlink unified TCI state, indicated by a control message (e.g., a MAC-CE 235, DCI 240).

In some aspects, the capability information 220 may indicate that the UE 115-a supports common multi-CC TCI state update and activation (e.g., for joint unified TCI states or separate downlink and uplink unified TCI states). For example, the TCI state indication may be applied for a set (or a list) of CCs or BWPs in CA. In some examples, the capability information 220 may indicate a maximum quantity of CCs. In some examples, the capability information 220 may indicate a maximum quantity of configured CC lists. In some examples, the capability information 220 may indicate that the UE 115-a supports common unified TCI state identifier activation and/or update for a set of CCs operating in multi-DCI based multi-TRP operation. In some examples, the capability information 220 may indicate that the UE 115-a supports common unified TCI state identifier activation and/or update for a set of CCs that include a subset of CCs operating in multi-DCI based multi-TRP operation and a subset of CCs operating in single TRP operation. In some examples, the capability information 220 may indicate that the UE 115-a supports common unified TCI state identifier activation and/or update for a set of CCs including a subset of CCs operating in multi-DCI based multi-TRP operation and a subset of CCs operating in s-DCI based multi-TRP operation. In some examples, the capability information 220 may indicate that the UE 115-a supports common unified TCI state identifier activation and/or update for a set of CCs including a subset of CCs operating in multi-DCI based multi-TRP operation, a subset of CCs operating in s-DCI based multi-TRP operation, and a subset of CCs operating in single TRP operation. In some examples, the capability information 220 may indicate whether the UE 115-a supports TCI pool sharing for multiple CCs in CA. For example, the capability information 220 may indicate that the UE 115-a supports a reference BWP/CC configured with a reference TCI state pool shared by a set of BWPs/CCs. The capability information 220 may also indicate a maximum quantity of configured joint unified TCI state pools, downlink unified TCI state pools, and/or uplink unified TCI state pools across all BWPs or CCs in a band.

In some aspects, the capability information 220 may indicate that the UE 115-a supports per aperiodic CSI-RS resource or per aperiodic CSI-RS resource set TCI association, such as for joint unified TCI state operation. For example, for joint unified TCI state operation, the capability information 220 may indicate that the UE 115-a supports reception of control signaling (e.g., RRC signaling) that indicates whether the UE 115-a is to apply, to an aperiodic CSI-RS resource or resource set, a first joint unified TCI state or a second joint unified TCI state indicated by a control message (e.g., a MAC-CE 235, DCI 240). For example, for joint unified TCI state operation, the capability information 220 may indicate that the UE 115-a supports reception of control signaling (e.g., RRC signaling) that indicates whether the UE 115-a is to apply, to an aperiodic CSI-RS resource or resource set, a first joint unified TCI state associated with a first CORESET pool index or a second joint unified TCI state associated with a second CORESET pool index indicated by a control message (e.g., a MAC-CE 235, DCI 240).

In some aspects, the capability information 220 may indicate that the UE 115-a supports per aperiodic CSI-RS resource or per aperiodic CSI-RS resource set TCI association, such as for separate downlink and uplink unified TCI state operation. For example, for separate downlink and uplink unified TCI state operation, the capability information 220 may indicate that the UE 115-a supports reception of control signaling (e.g., RRC signaling) that indicates whether the UE 115-a is to apply, to an aperiodic CSI-RS resource or resource set, a first downlink unified TCI state or a second downlink unified TCI state indicated by a control message (e.g., a MAC-CE 235, DCI 240). For example, for separate downlink and uplink unified TCI state operation, the capability information 220 may indicate that the UE 115-a supports reception of control signaling (e.g., RRC signaling) that indicates whether the UE 115-a is to apply, to an aperiodic CSI-RS resource or resource set, a first downlink unified TCI state associated with a first CORESET pool index or a second downlink unified TCI state associated with a second CORESET pool index indicated by a control message (e.g., a MAC-CE 235, DCI 240).

For joint unified TCI state operation, the capability information 220 may indicate that the UE 115-a supports per-TRP beam resetting. For example, after the network response to a TRP-specific BFR request for a beam failure detection reference signal (BFD-RS) set associated with a given CORESET pool index value, the QCL assumption, spatial transmission filter, or pathloss reference signal (PL-RS) that apply to the indicated joint unified TCI state to the CORESET pool index may be updated according to the new beam corresponding to the BFD-RS set.

For separate downlink and uplink unified TCI state operation, the capability information 220 may indicate that the UE 115-a supports per-TRP beam resetting. For example, after the network response for a TRP-specific BFR request to a BFD-RS set associated with a given CORESET pool index value, the QCL assumption, spatial transmission filter, or PL-RS that apply to the indicated downlink or uplink unified TCI state to the CORESET pool index may be updated according to the new beam corresponding to the BFD-RS set.

In some aspects, the capability information 220 may indicate that the UE 115-a supports an association between a joint unified TCI state or an uplink unified TCI state and uplink power control settings (e.g., for PUCCH, PUSCH, and/or SRS). In some aspects, the capability information 220 may indicate that the UE 115-a supports per-TRP default power control parameters, where the UE 115-a may apply the default power control parameters per joint unified TCI state or per uplink unified TCI state.

In some aspects, the capability information 220 may indicate that the UE 115-a supports default PDSCH and/or aperiodic CSI-RS beam parameters for joint unified TCI state operation and/or separate downlink and uplink unified TCI state operation. For example, the capability information 220 may indicate that the UE 115-a supports a new value for an offset threshold (e.g., a scheduling offset threshold), the offset threshold being a duration of time between a control message (e.g., DCI 240-a or DCI 240-b) that schedules a PDSCH 250 or an aperiodic CSI-RS 265 and a reception of the PDSCH 250 or the aperiodic CSI-RS 265. That is, the UE 115-a may support an offset threshold that is specific to multiple DCI-based multi-TRP operation with the unified TCI states. In some examples, the capability information 220 may indicate that the UE 115-a supports one or two default beams for multiple DCI-based multi-TRP operation, where the UE 115-a may use default joint unified TCI states or default downlink unified TCI states to buffer the PDSCH 250 or the aperiodic CSI-RS 265 if received before the offset threshold (e.g., the PDSCH 250 or the aperiodic CSI-RS 265 is scheduled to be received within the duration of the offset threshold from the transmission of the control message).

In some aspects, the capability information 220 may indicate that the UE 115-a supports an indication or configuration of joint or downlink unified TCI states for aperiodic CSI-RS, PDCCH, or PDSCH for individual channels or reference signals. In some aspects, the capability information 220 may indicate that the UE 115-a supports an indication or configuration of joint or uplink unified TCI states for SRS for individual reference signals. For example, for joint unified TCI state operation and/or separate downlink unified downlink and uplink unified TCI state operation, the capability information 220 may indicate whether the UE 115-a can support indication and/or configuration of release 18 (R18) unified TCI states for individual aperiodic CSI-RS, PDCCH, PDSCH as legacy release 15 (R15) or release 16 (R16) TCI states for individual channels or reference signals. For example, for joint unified TCI state operation and/or separate downlink unified and uplink unified TCI state operation, the capability information 220 may indicate whether the UE 115-a can support indication and/or configuration of R18 unified TCI states for SRS, as legacy R15 or R16 TCI states for SRS.

In some aspects, for joint unified TCI state operation and/or separate downlink unified and uplink unified TCI state operation, the capability information 220 may indicate whether the UE 115-a can support any combination of configuring release 17 (R17) single TRP operation in one or more CCs, R18 single TRP operation in one or more CCs, R18 single DCI based multi-TRP operation one or more CCs, and R18 multi-DCI based multi-TRP operation in one or more CCs in the same CC list for common beam/TCI activation and/or indication.

For joint unified TCI state framework, the capability information 220 may indicate that the UE 115-a supports the joint unified TCI state framework for inter-cell multi-TRP. In such cases, TCI activation may be per PCI, and two indicated TCIs are for different PCIs. In such aspects, the capability information 220 may indicate that the UE 115-a supports MAC-CE based TCI state indication for 2 activated codepoints mapped to 2 joint TCIs with different PCIs. For example, if the UE 115-a is configured with a synchronization signal block (SSB) measurement timing configuration (MTC) and an additional PCI, and the UE 115-a receives a TCI state activation command (e.g., MAC-CE 235) that activates a set of joint unified TCI state(s) specific to each CORESET pool index value for multi-DCI based multi-TRP operation, the activated joint TCI state(s) specific to one CORESET pool index value is associated with the serving cell PCI and the activated joint TCI state(s) specific to another CORESET pool index value may be associated with a PCI other than the serving cell PCI. In some aspects, the capability information 220 may indicate that the UE 115-a supports a quantity K additional MAC-CE activated joint unified TCI states in a band. In some aspects, the capability information 220 may indicate that the UE 115-a supports a quantity K additional MAC-CE activated joint unified TCI states across all CCs in a band.

For separate the downlink and uplink unified TCI state framework, the capability information 220 may indicate that the UE 115-a supports downlink and uplink unified TCI state framework for inter-cell multi-TRP. In such cases, TCI activation may be per PCI, and two indicated TCIs are for different PCIs. For example, if the UE 115-a is configured with an SSB MTC and an additional PCI, and the UE 115-a receives a TCI state activation command (e.g., MAC-CE 235) that activates a set of downlink and uplink unified TCI state(s) specific to each CORESET pool index value for multi-DCI based multi-TRP operation, the activated downlink and uplink TCI state(s) specific to one CORESET pool index value is associated with the serving cell PCI and the activated downlink and uplink TCI state(s) specific to another CORESET pool index value may be associated with a PCI other than the serving cell PCI. In some aspects, the capability information 220 may indicate that the UE 115-a supports a quantity K additional MAC-CE activated downlink unified TCI states in a band. In some aspects, the capability information 220 may indicate that the UE 115-a supports a quantity K additional MAC-CE activated uplink unified TCI states in a band. In some aspects, the capability information 220 may indicate that the UE 115-a supports a quantity K additional MAC-CE activated downlink unified TCI states across all CCs in a band. In some aspects, the capability information 220 may indicate that the UE 115-a supports a quantity K additional MAC-CE activated uplink unified TCI states across all CCs in a band.

In some aspects, the capability information 220 may indicate that the UE 115-a supports indication or configuration of unified TCI states for CORESET #0 for inter-cell multi-TRP operation. For example, the UE 115-a may support indication of unified TCI states and respective PDSCH reception reusing the non-unified TCI state framework for single TRP operation.

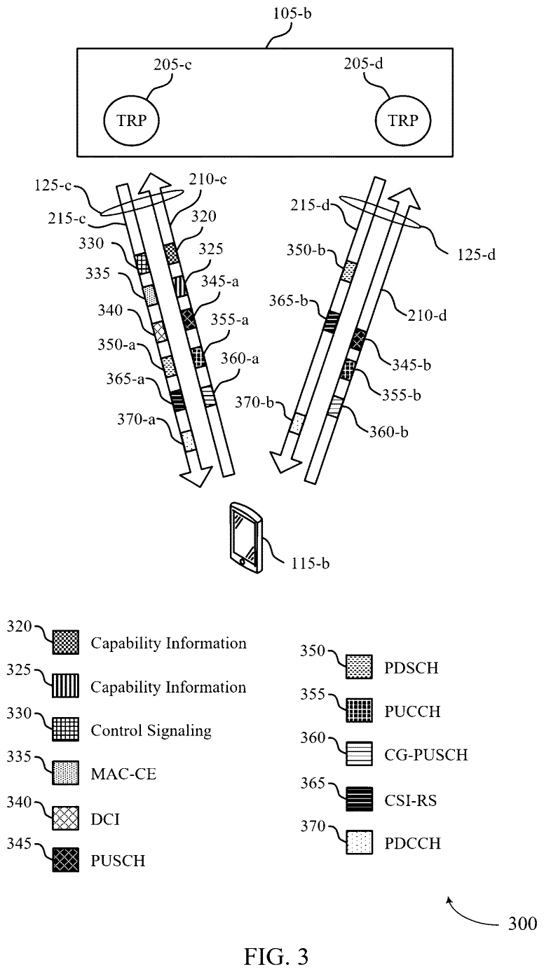

FIG. 3 shows an example of a wireless communications system 300 that supports unified TCI state indication for single or multi-DCI based multi-TRP operation in accordance with one or more aspects of the present disclosure. The wireless communications system 300 may implement aspects of wireless communications system 100. For example, the wireless communications system 200 may include a network entity 105-b, which may be an example of a network entity 105 as described herein, and the wireless communications system 200 may include a UE 115-b, which may be an example of a UE 115 as described herein.

The network entity 105-b may include multiple TRPs 205. For example, as shown in FIG. 3, the network entity 105-b includes a first TRP 205-c and a second TRP 205-d, although the network entity 105-b may include any quantity of TRPs 205. The UE 115-b and the network entity 105-b may communicate in a single DCI-based multi-TRP operation, as described herein. For example, the UE 115-b may communicate with the first TRP 205-c using a communication link 125-c and the UE 115-b may communicate with the second TRP 205-d using a communication link 125-d. The communication link 125-c and the communication link 125-d may be examples of a communication link 125 as described herein. For example, the communication link 125-c and the communication link 125-d may include bi-directional links that enable both uplink and downlink communications. For instance, the UE 115-b may transmit uplink signals 210-c (e.g., uplink transmissions), such as uplink control signals or uplink data signals, to the network entity 105-b via the first TRP 205-c using the communication link 125-c, and the network entity 105-b may transmit downlink signals 215-c (e.g., downlink transmissions), such as downlink control signals or downlink data signals, to the UE 115-b via the first TRP 205-c using the communication link 125-c. The UE 115-b may transmit uplink signals 210-d (e.g., uplink transmissions), such as uplink control signals or uplink data signals, to the network entity 105-b via the second TRP 205-d using the communication link 125-d, and the network entity 105-b may transmit downlink signals 215-d (e.g., downlink transmissions), such as downlink control signals or downlink data signals, to the UE 115-b via the second TRP 205-d using the communication link 125-d.

The UE 115-b may support a unified TCI state framework as described herein. The UE 115-b may transmit capability information 320 (e.g., via RRC) to the network entity 105-b that indicates capabilities of the UE 115-b associated with the application of the unified TCI state framework to single DCI-based multi-TRP operation. In the example of FIG. 3, the capability information 320 may be transmitted to the first TRP 205-c, however, in some other examples, the capability information 320 may be transmitted to the second TRP 205-d. In some aspects, the UE 115-b may indicate the capability information 320 at different granularities. For example, the capability information 320 may indicate the capabilities of the UE 115-b per UE, per band, per band combination, per feature set, or per feature set per CC. In some aspects the capability information 320 may indicate the capabilities of the UE 115-b with TDD or FDD differentiation, with frequency range (FR)1 (e.g., 410 MHz-7.125 GHz, which may be referred to as a “Sub-6 GHz band” or a sub-mmW range) or FR2 (e.g., 24.25 GHz-52.6 GHz, which may be referred to as a millimeter band or a mmW range) differentiation, or with capability interpretation for mixture of TDD, FDD, FR1, and FR2. That is, the capabilities indicated by the capability information 320 may be specific to the UE 115-b, a frequency band, a frequency band combination, a feature set, a feature set per CC, an FDD configuration, a TDD configuration, a FR1, FR2 or a combination thereof.

In some aspects, the UE 115-b may transmit second capability information 325 to the network entity 105-b that indicates capabilities of the UE 115-b associated with the application of the unified TCI state framework to single TRP operation. In some aspects, the capability information 320 and the second capability information 325 may be transmitted in a same control message. In some aspects, the capability information 320 and the second capability information 325 may be transmitted in separate control messages. In some aspects, some of the capabilities of the UE 115-b may be the same for single DCI-based multi-TRP operation and single TRP operation. In such cases, in some examples, the UE 115-b may list the capabilities for single DCI-based multi-TRP operation and single TRP operation in two separate reports and may indicate that one or more of the capabilities for single DCI-based multi-TRP operation are the same as the capabilities for single TRP operation. That is, that UE 115-b (e.g., the report for the single DCI-based multi-TRP operation) may indicate that the one or more capabilities will reuse the capabilities (e.g., the values of the capabilities) for single TRP operation (e.g., in the UE capabilities for NR release 17 (R17) or earlier operation).

In some examples, the UE 115-b may indicate the capability information 320 and the second capability information 325 in a same capability report and may indicate separate values in the capability report for single DCI-based multi-TRP operation and single TRP operation. In such cases, a single DCI-based multi-TRP operation may have the same or a different value (e.g., in the UE capabilities for NR release 18 (R18) operation) from the corresponding value for the single TRP operation based on the capability of the UE 115-b (e.g., in the UE capabilities for R17 or earlier operation).

In some examples, the UE 115-b may not list or indicate the capabilities that are the same for the single DCI-based multi-TRP operation and the single TRP operation in a capability report that indicates the UE capability for single DCI-based multi-TRP operation. In such examples, the network entity 105-b may understand to use the corresponding capability indicated in the capability report for the single TRP operation. For example, a rule may indicate that if a capability is missing from the capability report for single DCI-based multi-TRP operation (e.g., the UE capabilities for R18 operation), the corresponding capability indicated in the capability report for the single TRP operation (e.g., the UE capabilities for R17 or earlier) is to be reused.

In response to the capability information 320, the network entity 105-b may transmit control signaling 330 (e.g., via RRC) indicating parameters for the single DCI-based multi-TRP operation. For example, the parameters may indicate a configuration of the single DCI-based multi-TRP operation that is in accordance with the capabilities of the UE 115-b indicated by the capability information 320 (e.g., and the second capability information 325). The UE 115-b may subsequently receive DCI 340 from a TRP 205 that schedules a multi-TRP operation. For example, a DCI 340 from the first TRP 205-c (although the DCI 340 may alternatively be from the second TRP 205-d) may schedule a PUSCH 345-a and a PUSCH 345-b for transmission by the UE 115-b, where communication of the PUSCH 345-a and the PUSCH 345-b are a multi-TRP operation. As another example, the DCI 340 may schedule a PDSCH 350-a and a PDSCH 350-b for reception by the UE 115-b, where communication of the PDSCH 350-a and the PDSCH 350-b are a multi-TRP operation. As another example, the DCI 340 may schedule a PUCCH 355-a and a PUCCH 355-b for transmission by the UE 115-b, where communication of the PUCCH 355-a and the PUCCH 355-b are a multi-TRP operation. As another example, the DCI 340 may schedule a CG-PUSCH 360-a and a CG-PUSCH 360-b for transmission by the UE 115-b, where communication of the CG-PUSCH 360-a and the CG-PUSCH 360-b are a multi-TRP operation. As another example, the DCI 340 may schedule a CSI-RS 365-a and a CSI-RS 365-b for reception by the UE 115-b, where communication of the CSI-RS 365-a and the CSI-RS 365-b are a multi-TRP operation. As another example, the DCI 340 may schedule a PDCCH 370-a and a PDCCH 370-b for reception by the UE 115-b, where communication of the PDCCH 370-a and the PDCCH 370-b are a multi-TRP operation.

In some aspects, the capability information 320 may indicate that the UE 115-b supports unified joint TCI state operation, including a basic set (e.g., a single activated TCI codepoint, where the single TCI codepoint may be mapped to one or more TCI states and used to indicate the mapped TCI states). In such aspects, the capability information 320 may indicate that the UE 115-b supports a unified joint TCI state update with the corresponding components of the TCI state (e.g., TCI configuration mechanism, QCL rules, and/or applicable source and target signals). In such aspects, the capability information 320 may indicate a maximum number of configured unified joint TCI states per BWP per CC in a band (e.g., a frequency band).

In such aspects of the unified joint TCI state operation including the basic set, the capability information 320 may indicate that the UE 115-b supports reception of control signaling (e.g., a MAC-CE 335) that activates a TCI codepoint mapped to one or more unified joint TCI states. For example, the capability information 320 may indicate that the UE 115-b supports two MAC-CE 335 activated unified joint TCI states per CC in a band. In some examples, a TCI codepoint activated by the MAC-CE 335 may map to a subset of unified joint TCI states of a set of unified joint TCI states (e.g., indicated, such as activated, for multi-TRP operation). The capability information 320 may indicate that if the UE 115-b receives a TCI codepoint in the MAC-CE 335 that is mapped to a first subset of the indicated TCI states, such as a subset of {first unified joint TCI state, second unified joint TCI state}, the UE 115-b may update the first or second unified joint TCI state with the unified joint TCI state indicated by TCI codepoint and maintain (e.g., keep the same) a second subset of the indicated TCI states (e.g., the other unified joint TCI state) that is not updated (e.g., indicated) by the TCI codepoint. In some examples of supporting two MAC-CE 335 activated unified joint TCI states per CC in a band, at least one TCI codepoint is mapped to two unified joint TCI states.

In such aspects of the unified joint TCI state operation including the basic set, the capability information 320 may indicate that the UE 115-b supports TCI state indication for updating and/or activation of a TCI state (e.g., via a MAC-CE 335). For example, the capability information 320 may indicate that the UE 115-b supports a MAC-CE based TCI state indication for a single activated TCI codepoint mapped to up to 2 unified joint TCI states.

In such aspects of the unified joint TCI state operation including the basic set, the capability information 320 may indicate a maximum number of MAC-CE activated unified joint TCI states the UE 115-b may support across all CCs in a band. In such aspects of the unified joint TCI state operation including the basic set, the capability information 320 may indicate that the UE 115-b supports per BWP TCI state pool configuration for CA mode (e.g., and/or that the UE 115-b supports TCI state pool configuration per BWP for CA mode).

In some aspects, the capability information 320 may indicate that the UE 115-b supports separate unified downlink and uplink TCI state operation, including a basic set (e.g., a single activated TCI codepoint). In such aspects, the capability information 320 may indicate that the UE 115-b supports separate TCI state updates for unified downlink and unified uplink TCI states with the corresponding components of the TCI state (e.g., configuration mechanism, QCL rules, and/or applicable source and target signals). In such aspects, the capability information 320 may also indicate a maximum number of configured unified downlink per BWP and/or per CC in a band, a maximum number of configured unified uplink TCI states per BWP and/or per CC in a band, or a combination thereof.

In such aspects of the separate unified downlink and unified uplink TCI state operation including the basic set, the capability information 320 may indicate that the UE 115-b supports reception of control signaling (e.g., a MAC-CE 335) that activates a TCI codepoint mapped to one or more unified downlink TCI states and/or one or more unified uplink TCI states. For example, the capability information 320 may indicate that the UE 115-b supports one or more MAC-CE 335 activated separate unified TCI states per CC in a band. In some examples, a TCI codepoint activated by the MAC-CE 335 may map to a subset of separate unified TCI states of a set of separate unified TCI states (e.g., indicated, such as activated, for multi-TRP operation). The capability information 320 may indicate that if the UE 115-b receives a TCI codepoint in the MAC-CE 335 that is mapped to a first subset of the indicated TCI states, such as a subset of {first unified downlink TCI state, first unified uplink TCI state, second unified downlink TCI state, second unified uplink TCI state}, the UE 115-b may update the first subset of TCI states with the unified TCI states indicated by TCI codepoint and maintain (e.g., keep the same) the second subset of TCI states that are not updated (e.g., indicated) by the TCI codepoint. In some examples of supporting one or more MAC-CE 335 activated separate unified TCI states per CC in a band, at least one TCI codepoint is mapped to two unified downlink TCI states and/or two unified uplink TCI states. For example, one MAC-CE 335 may activate 2 separate unified downlink TCI states and 1 separate unified uplink TCI state if the UE 115-b supports at least two active downlink TCI states across all CC(s) in a band, or may activate 1 separate unified downlink TCI state and 2 separate unified uplink TCI states if the UE 115-b supports at least two active uplink TCI states across all CC(s) in a band, or may activate 2 separate unified downlink TCI states and 2 separate unified uplink TCI states if the UE 115-b supports at least two active downlink TCI states and two active uplink TCI states across all CC(s) in a band, where the capability information 320 may indicate that the UE 115 supports at least one of these combinations of activation of separate unified downlink and uplink TCI states.

In such aspects of the separate unified TCI state operation including the basic set, the capability information 320 may indicate that the UE 115-b supports TCI state indication for updating and/or activation of a TCI state (e.g., via a MAC-CE 335). For example, the capability information 320 may indicate that the UE 115-b supports a MAC-CE based TCI state indication for a single activated TCI codepoint mapped to up to two unified downlink TCI states and/or two unified uplink TCI states.

In such aspects of the separate unified TCI state operation including the basic set, the capability information 320 may indicate a maximum number of MAC-CE activated unified downlink and/or uplink TCI states the UE 115-b may support across all CCs in a band. In such aspects, the capability information 320 may indicate a maximum number of MAC-CE activated unified downlink across all CCs in a band and a maximum number of MAC-CE activated unified uplink across all CCs in a band. In such aspects of the separate unified TCI state operation including the basic set, the capability information 320 may indicate that the UE 115-b supports per BWP TCI state pool configuration for CA mode (e.g., and/or that the UE 115-b supports TCI state pool configuration per BWP for CA mode).

In some aspects, the capability information 320 may indicate that the UE 115-b supports unified joint TCI operation, including an enhanced set (e.g., more than 1 TCI codepoint). In such aspects, the capability information 320 may indicate the supported TCI state indication for updating and/or activation of unified joint TCI states. For example, the capability information 320 may indicate that the UE 115-b supports a MAC-CE 335 based TCI state activation and DCI 340 based TCI state indication (e.g., use of DCI formats 1_1 or 1_2 with downlink assignment, such as to select a TCI codepoint). As another example, the capability information 320 may indicate that the UE 115-b supports a MAC-CE 335 based TCI state activation and DCI 340 based TCI state indication (e.g., use of DCI formats 1_1 or 1_2 without downlink assignment, such as to select a TCI codepoint). In some aspects, the capability information 320 may indicate a minimum beam application time in a number of symbols per subcarrier spacing (SCS). In some aspects, the capability information 320 may indicate a maximum supported number of MAC-CE activated unified joint TCI states per CC in a band for the enhanced set operation. In some aspects, the capability information 320 may indicate that the UE 115-b supports a TCI indication field in a DCI 340, such as in a DCI format 1_1 and/or 1_2 (e.g., with or without downlink assignment). In some aspects, the TCI indication field may indicate one TCI codepoint of up to a quantity of (e.g., two) unified joint TCI states in a CC and/or BWP.

In some aspects, the capability information 320 may indicate that the UE 115-b supports separate unified downlink and unified uplink TCI operation, including an enhanced set (e.g., more than 1 TCI codepoint). In such aspects, the capability information 320 may indicate the supported TCI state indication for updating and/or activation of separate unified downlink and unified uplink TCI states. For example, the capability information 320 may indicate that the UE 115-b supports a MAC-CE 335 based TCI state activation and DCI 340 based TCI state indication (e.g., use of DCI formats 1_1 or 1_2 with downlink assignment, such as to select a TCI codepoint). As another example, the capability information 320 may indicate that the UE 115-b supports a MAC-CE 335 based TCI state activation and DCI 340 based TCI state indication (e.g., use of DCI formats 1_1 or 1_2 without downlink assignment, such as to select a TCI codepoint). In some aspects, the capability information 320 may indicate a maximum supported number of MAC-CE activated unified downlink TCI states per CC and indicate a maximum supported number of MAC-CE activated unified uplink TCI states per CC in a band for the enhanced set operation. In some aspects, the capability information 320 may indicate a minimum beam application time in a number of symbols per SCS. In some aspects, the capability information 320 may indicate that the UE 115-b supports a TCI indication field in a DCI 340, such as in a DCI format 1_1 and/or 1_2 (e.g., with or without downlink assignment). In some aspects, the TCI indication field may indicate one TCI codepoint of up to a quantity of (e.g., two) unified downlink and/or unified uplink TCI states in a CC and/or BWP.

In some aspects, the capability information 320 may indicate that the UE 115-b supports common multi-CC TCI state identifier update and activation, such as for unified joint TCI state operation and/or separate unified downlink and unified uplink TCI state operation. For example, a TCI state indication may be applied to a set (e.g., a list) of CCs and/or BWPs in CA. In some examples, the capability information 320 may indicate a maximum quantity of CCs and/or BWPs and/or a maximum quantity of sets of CCs. In some examples, the capability information 320 may indicate a maximum number of configured CC lists. In some examples, the capability information 320 may indicate that the UE 115-b supports common unified TCI state ID activation and/or update for a set of CCs associated with single DCI-based multi-TRP operation. That is, the capability information 320 may indicate that a list of CCs operating in single DCI-based multi-TRP operation may be configured for common TCI state identifier activation and/or update.

In some examples, the capability information 320 may indicate whether the UE 115-b supports TCI pool sharing for multiple CCs in CA. For example, the capability information 320 may indicate that the UE 115-b supports a reference BWP and/or a reference CC configured with a reference TCI state pool shared by a set of BWPs and/or CCs. In some examples, the capability information 320 may indicate a maximum quantity of configured unified joint TCI state pools, unified downlink TCI state pools, and/or unified uplink TCI state pools across all BWPs and/or CCs in a band.

In some aspects, the capability information 320 may indicate that the UE 115-b supports per aperiodic CSI-RS resource or per aperiodic CSI-RS resource set TCI association, such as for unified joint TCI state operation. For example, for unified joint TCI state operation, the capability information 320 may indicate that the UE 115-b supports reception of control signaling (e.g., RRC signaling) that indicates whether the UE 115-b is to apply, to an aperiodic CSI-RS resource or resource set, a first unified joint TCI state or a second unified joint TCI state indicated by a control message (e.g., a MAC-CE 335, DCI 340). For instance, if per resource TCI association is supported, the capability information 320 may indicate that an RRC configuration may be configured, such as in CSI-AssociatedReportConfigInfo of a CSI-AperiodicTrigger State for each CSI-RS resource in each aperiodic CSI-RS resource set, to inform (e.g., indicate) that the UE 115-b is to apply the first or the second indicated unified joint TCI state to the CSI-RS resource, such as if the aperiodic CSI-RS resource set for CSI and/or beam management is configured to follow (e.g., adhere to, configured in accordance with) the unified TCI state framework. If per resource set TCI association is supported, the capability information 320 may indicate that an RRC configuration may be configured, such as in CSI-AssociatedReportConfigInfo of a CSI-AperiodicTrigger State for each aperiodic CSI-RS resource set, to inform (e.g., indicate) that the UE 115-b is to apply the first or the second indicated unified joint TCI state to the CSI-RS resource set, such as if the aperiodic CSI-RS resource set for CSI and/or beam management is configured to follow (e.g., adhere to, configured in accordance with) the unified TCI state framework.

In some aspects, the capability information 320 may indicate that the UE 115-b supports per aperiodic CSI-RS resource or per aperiodic CSI-RS resource set TCI association, such as for separate unified downlink and unified uplink TCI state operation. For separate unified TCI state operation, the capability information 320 may indicate that the UE 115-b supports reception of control signaling (e.g., RRC signaling) that indicates whether the UE 115-b is to apply, to an aperiodic CSI-RS resource or resource set, a first unified downlink TCI state or a second unified downlink TCI state indicated by a control message (e.g., a MAC-CE 335, DCI 340). For instance, if per resource TCI association is supported, the capability information 320 may indicate that an RRC configuration may be configured (e.g., in a CSI-AssociatedReportConfigInfo of a CSI-AperiodicTrigger State) for each CSI-RS resource in each aperiodic CSI-RS resource set to inform (e.g., indicate) that the UE 115-b is to apply the first or the second indicated unified downlink TCI state to the CSI-RS resource, such as if the aperiodic CSI-RS resource set for CSI and/or beam management is configured to follow the unified TCI state framework. If per resource set TCI association is supported, the capability information 320 may indicate that an RRC configuration may be configured (e.g., in a CSI-AssociatedReportConfigInfo of a CSI-AperiodicTrigger State) for each aperiodic CSI-RS resource set to inform (e.g., indicate) that the UE 115-b is to apply the first or the second indicated unified downlink TCI state to the CSI-RS resource set, such as if the aperiodic CSI-RS resource set for CSI and/or beam management is configured to follow the unified TCI state framework.

In some aspects, the capability information 320 may indicate that the UE 115-b supports per-PUCCH resource or per-PUCCH group TCI association, such as for unified joint TCI state operation. For example, for unified joint TCI state operation, the capability information 320 may indicate that the UE 115-b supports reception of control signaling (e.g., RRC signaling) that indicates whether the UE 115-b is to apply, to a PUCCH resource or group, a first unified joint TCI state, a second unified joint TCI state, or both, indicated by a control message (e.g., a MAC-CE 335, DCI 340). For instance, the capability information 320 may indicate that an RRC configuration may indicate that the UE 115-b is to apply the first unified joint TCI state, the second unified joint TCI state, or both of the unified joint TCI states indicated by the control message to a PUCCH resource or group.

In some aspects, the capability information 320 may indicate that the UE 115-b supports per-PUCCH resource or per-PUCCH group TCI association, such as for separate unified downlink and unified uplink TCI state operation. For separate unified TCI state operation, the capability information 320 may indicate that the UE 115-b supports reception of control signaling (e.g., RRC signaling) that indicates whether the UE 115-b is to apply, to a PUCCH resource or group, a first unified uplink TCI state, a second unified uplink TCI state, or both, indicated by a control message. For instance, the capability information 320 may indicate that an RRC configuration may indicate that the UE 115-b is to apply the first unified uplink TCI state, the second unified uplink TCI state, or both of the unified uplink TCI states indicated by the control message to a PUCCH resource or group.

In some aspects, the capability information 320 may indicate that the UE 115-b supports per-CORESET or per-CORESET group TCI association, such as for unified joint TCI state operation. For example, for unified joint TCI state operation, the capability information 320 may indicate that the UE 115-b supports reception of control signaling (e.g., RRC signaling) that indicates whether the UE 115-b is to apply, to a CORESET or group of CORESETs, a first unified joint TCI state, a second unified joint TCI state, both of the unified joint TCI states, or none (e.g., neither) of the unified joint TCI states indicated by a control message (e.g., a MAC-CE 335, DCI 340). For instance, the capability information 320 may indicate that an RRC configuration may indicate that the UE 115-b is to apply the first unified joint TCI state, the second unified joint TCI state, both of the unified joint TCI states, or none of the unified joint TCI states indicated by the control message to a CORESET or group of CORESETs (e.g., if CORESET group configuration is supported). In some examples, the CORESET or CORESET group may be configured for PDCCH with repetition, PDCCH without repletion, PDCCH-SFN communications, PDCCH-non SFN communications, or a combination thereof.

In some aspects, the capability information 320 may indicate that the UE 115-b supports per-CORESET or per-CORESET group TCI association, such as for separate unified downlink and unified uplink TCI state operation. For example, for separate unified TCI state operation, the capability information 320 may indicate that the UE 115-b supports reception of control signaling (e.g., RRC signaling) that indicates whether the UE 115-b is to apply, to a CORESET or group of CORESETs, a first unified downlink TCI state, a second unified downlink TCI state, both unified downlink TCI states, or none of the unified downlink TCI states indicated by a control message (e.g., a MAC-CE 335, DCI 340). For instance, the capability information 320 may indicate that an RRC configuration may indicate that the UE 115-b is to apply the first unified downlink TCI state, the second unified downlink TCI state, both of the unified downlink TCI states, or none of the unified downlink TCI states indicated by the control message to a CORESET or group of CORESETs (e.g., if CORESET group configuration is supported). In some examples, the CORESET or CORESET group may be configured for PDCCH with repetition, PDCCH without repletion, PDCCH-SFN communications, PDCCH-non SFN communications, or a combination thereof.

In some aspects, the capability information 320 may indicate that the UE 115-b supports a unified TCI selection indication for PDSCH, such as to support dynamic or one-shot downlink TRP switching between single TRP and multi-TRP operation, for unified joint TCI state operation. For example, for unified joint TCI state operation, the capability information 320 may indicate that the UE 115-b supports reception of DCI 340 associated with PDSCH 350 reception scheduling that includes a field to select, for reception of a PDSCH 350, one or more unified joint TCI states indicated by a TCI codepoint. For instance, the capability information 320 may indicate that a TCI selection field (e.g., a 2-bit field) may be configured via RRC signaling to be present in DCI 340 (e.g., a DCI format 1_1/1_2) that schedules and/or activates PDSCH reception (including dynamic PDSCH and semi-persistent scheduling (SPS) PDSCH). The TCI selection field may select one or more of the unified joint TCI states mapped to by a TCI codepoint (e.g., that is activated by a MAC-CE 335 and/or selected by a previous DCI). In some examples, the one or more unified joint TCI states from which the TCI selection field selects may be indicated by a single TCI codepoint for a basic set or by a TCI indication field for an enhanced set. In some examples, the capability information 320 may indicate that the TCI selection field can be RRC-configured per DCI format (DCI format 1_1 or DCI format 1_2), per downlink BWP, or a combination thereof.

In some aspects, the capability information 320 may indicate that the UE 115-b supports a unified TCI selection indication for PDSCH, such as to support dynamic or one-shot downlink TRP switching between single TRP and multi-TRP operation, for separate unified downlink and unified uplink TCI state operation. For separate unified TCI state operation, the capability information 320 may indicate that the UE 115-b supports reception of DCI 340 associated with PDSCH 350 reception scheduling that includes a field to select, for reception of a PDSCH 350, one or more unified downlink TCI states indicated by a TCI codepoint. For instance, the capability information 320 may indicate that a TCI selection field (e.g., a 2-bit field) may be configured via RRC signaling to be present in DCI 340 (e.g., a DCI format 1_1/1_2) that schedules and/or activates PDSCH reception (including dynamic PDSCH and semi-persistent scheduling (SPS) PDSCH). The TCI selection field may select one or more of the unified downlink TCI states mapped to by a TCI codepoint (e.g., that is activated by a MAC-CE 335). In some examples, the one or more unified downlink TCI states from which the TCI selection field selects may be indicated by a single TCI codepoint for a basic set or by a TCI indication field for an enhanced set. In some examples, the capability information 320 may indicate that the TCI selection field can be RRC-configured per DCI format (DCI format 1_1 or DCI format 1_2), per downlink BWP, or a combination thereof.

In some aspects, the capability information 320 may indicate that the UE 115-b supports a unified TCI selection indication for PUSCH, such as to support dynamic or one-shot uplink TRP switching, for unified joint TCI state operation. For example, for unified joint TCI state operation, the capability information 320 may indicate that the UE 115-b supports reception of DCI 340 associated with PUSCH 345 transmission scheduling that includes a field to select, for transmission of a PUSCH 345, one or more unified uplink TCI states indicated by a TCI codepoint. For instance, the capability information 320 may indicate that an SRS resource set indicator field may be configured via RRC signaling to be present in DCI 340 (e.g., a DCI format 0_1/0_2) that schedules and/or activates PUSCH transmission (e.g., including dynamic grant PUSCH and type 2 CG PUSCH). The SRS resource set indicator field may select one or more of the unified joint TCI states mapped to by a TCI codepoint (e.g., that is activated by a MAC-CE 335). In some examples, the one or more unified joint TCI states from which the SRS resource set indicator field selects may be indicated by a single TCI codepoint for a basic set or by a TCI indication field for an enhanced set.

In some aspects, the capability information 320 may indicate that the UE 115-b supports a unified TCI selection indication for PUSCH, such as to support dynamic or one-shot uplink TRP switching, for separate unified downlink and unified uplink TCI state operation. For separate unified TCI state operation, the capability information 320 may indicate that the UE 115-b supports reception of DCI 340 associated with PUSCH 345 transmission scheduling that includes a field to select, for transmission of a PUSCH 345, one or more unified uplink TCI states indicated by a TCI codepoint. For instance, the capability information 320 may indicate that an SRS resource set indicator field may be configured via RRC signaling to be present in DCI 340 (e.g., a DCI format 0_1/0_2) that schedules and/or activates PUSCH transmission (e.g., including dynamic grant PUSCH and type 2 CG PUSCH). The SRS resource set indicator field may select one or more of the unified uplink TCI states mapped to by a TCI codepoint (e.g., that is activated by a MAC-CE 335). In some examples, the one or more unified uplink TCI states from which the SRS resource set indicator field selects may be indicated by a single TCI codepoint for a basic set or by a TCI indication field for an enhanced set.

In some aspects, the capability information 320 may indicate that the UE 115-b supports CG (e.g., type 1 CG-PUSCH) TCI association, such as for unified joint TCI state operation. For example, for unified joint TCI state operation, the capability information 320 may indicate that the UE 115-b supports reception of control signaling (e.g., RRC signaling) that indicates whether the UE 115-b is to apply, to a CG-PUSCH 360 transmission, a first unified joint TCI state, a second unified joint TCI state, or both, indicated by a control message (e.g., a MAC-CE 335, DCI 340). For instance, the capability information 320 may indicate that an RRC configuration for CG-PUSCH transmission (e.g., type 1 CG-PUSCH transmission) may indicate that the UE 115-b is to apply the first unified joint TCI state, the second unified joint TCI state, or both of the unified joint TCI states indicated by the control message to a CG-PUSCH 360 transmission.

In some aspects, the capability information 320 may indicate that the UE 115-b supports CG (e.g., type 1 CG-PUSCH) TCI association, such as for separate unified downlink and unified uplink TCI state operation. For separate unified TCI state operation, the capability information 320 may indicate that the UE 115-b supports reception of control signaling (e.g., RRC signaling) that indicates whether the UE 115-b is to apply, to a CG-PUSCH 360 transmission, a first unified uplink TCI state, a second unified uplink TCI state, or both, indicated by a control message (e.g., a MAC-CE 335, DCI 340). For instance, the capability information 320 may indicate that an RRC configuration for CG-PUSCH transmission (e.g., type 1 CG-PUSCH transmission) may indicate that the UE 115-b is to apply the first unified uplink TCI state, the second unified uplink TCI state, or both of the unified uplink TCI states indicated by the control message to a CG-PUSCH 360 transmission.

In some aspects, the capability information 320 may indicate that the UE 115-b supports TCI association for spatial division multiplexing (SDM) based multi-TRP PDSCH operation, such as for unified joint TCI state operation. In some aspects, the capability information 320 may indicate that the UE 115-b supports TCI association for FDM based multi-TRP PDSCH operation, such as for unified joint TCI state operation. In some aspects, the capability information 320 may indicate that the UE 115-b supports TCI association for TDM based multi-TRP PDSCH operation, such as for unified joint TCI state operation. In some aspects, the capability information 320 may indicate that the UE 115-b supports TCI association for SFN based multi-TRP PDSCH operation, such as for unified joint TCI state operation.

In some aspects, the capability information 320 may indicate that the UE 115-b supports TCI association for SDM based multi-TRP PDSCH operation, such as for separate unified downlink and unified uplink TCI state operation. In some aspects, the capability information 320 may indicate that the UE 115-b supports TCI association for FDM based multi-TRP PDSCH operation, such as for separate unified downlink and unified uplink TCI state operation. In some aspects, the capability information 320 may indicate that the UE 115-b supports TCI association for TDM based multi-TRP PDSCH operation, such as for separate unified downlink and unified uplink TCI state operation. In some aspects, the capability information 320 may indicate that the UE 115-b supports TCI association for SFN based multi-TRP PDSCH operation, such as for separate unified downlink and unified uplink TCI state operation.

In some aspects, the capability information 320 may indicate that the UE 115-b supports TCI association for SDM based multi-TRP PUSCH operation, such as for unified joint TCI state operation. In some aspects, the capability information 320 may indicate that the UE 115-b supports TCI association for FDM based multi-TRP PUSCH operation, such as for unified joint TCI state operation. In some aspects, the capability information 320 may indicate that the UE 115-b supports TCI association for TDM based multi-TRP PUSCH operation, such as for unified joint TCI state operation. In some aspects, the capability information 320 may indicate that the UE 115-b supports TCI association for SFN based multi-TRP PUSCH operation, such as for unified joint TCI state operation.

In some aspects, the capability information 320 may indicate that the UE 115-b supports TCI association for SDM based multi-TRP PUSCH operation, such as for separate unified downlink and unified uplink TCI state operation. In some aspects, the capability information 320 may indicate that the UE 115-b supports TCI association for FDM based multi-TRP PUSCH operation, such as for separate unified downlink and unified uplink TCI state operation. In some aspects, the capability information 320 may indicate that the UE 115-b supports TCI association for TDM based multi-TRP PUSCH operation, such as for separate unified downlink and unified uplink TCI state operation. In some aspects, the capability information 320 may indicate that the UE 115-b supports TCI association for SFN based multi-TRP PUSCH operation, such as for separate unified downlink and unified uplink TCI state operation.

In some aspects, the capability information 320 may indicate that the UE 115-b supports switching between performing the multi-TRP operation and performing a single TRP operation. For example, the capability information 320 may indicate that the UE 115-b supports a coexistence switch between multi-TRP and single TRP operation.

In some aspects, the capability information 320 may indicate that the UE 115-b supports BFR operation for unified joint TCI state operation. For example, for unified joint TCI state operation, the capability information 320 may indicate that the UE 115-b supports determining a BFD reference signal set based on one or more unified joint TCI states indicated for single DCI-based multi-TRP operation. For instance, the capability information 320 may indicate that the UE 115-b may support implicit BFD reference signal set determination per each indicated unified joint TCI state for single DCI-based multi-TRP operation.

In some aspects, the capability information 320 may indicate that the UE 115-b supports BFR operation for separate unified downlink and unified uplink TCI state operation. For separate unified TCI state operation, the capability information 320 may indicate that the UE 115-b supports determining a BFD reference signal set based on one or more unified downlink TCI states indicated for single DCI-based multi-TRP operation. For instance, the capability information 320 may indicate that the UE 115-b may support implicit BFD reference signal set determination per each indicated unified downlink TCI state for single DCI-based multi-TRP operation.

In some aspects of BFR operation for unified joint TCI state operation and/or separate unified downlink and unified uplink TCI state operation, the capability information 320 may indicate that the UE 115-b supports per-TRP beam reset in association with BFR. For example, the capability information 320 may indicate that the UE 115-b may only reset the beam and/or TCI state for the TRP 205 for which the beam failed (e.g., rather than for each TRP 205 in response to beam failure associated with one of the TRPs 205).

In some aspects, the capability information 320 may indicate that the UE 115-b supports per-TRP default power control parameters or per-TCI state default power control parameters, such as for unified joint TCI state operation and/or separate unified downlink and unified uplink TCI state operation. For example, the capability information 320 may indicate that UE 115-b supports respective default power control parameters for each TRP 205 or for each indicated TCI state.

In some aspects, the capability information 320 may indicate that the UE 115-b supports default PDSCH and/or aperiodic CSI-RS beam parameters for unified joint TCI state operation and/or separate unified downlink and unified uplink TCI state operation. For example, the capability information 320 may indicate that the UE 115-b supports a new value for an offset threshold (e.g., a scheduling offset threshold), the offset threshold being a duration of time between a control message (e.g., DCI 340) that schedules a PDSCH 350 or an aperiodic CSI-RS 365 and a reception of the PDSCH 350 or the aperiodic CSI-RS 365. That is, the UE 115-b may support an offset threshold that is specific to single DCI-based multi-TRP operation with unified TCI state operation. In some examples, the capability information 320 may indicate that the UE 115-b supports one or two default beams for single DCI-based multi-TRP operation, where the UE 115-b may use default unified joint TCI states or default unified downlink TCI states to buffer the PDSCH 350 or the aperiodic CSI-RS 365 if received before the offset threshold (e.g., the PDSCH 350 or the aperiodic CSI-RS 365 is scheduled to be received within the duration of the offset threshold from the transmission of the control message).

In some aspects, the capability information 320 may indicate that the UE 115-b supports default TCI for non-TCI selection DCI 340 for unified joint TCI state operation and/or separate unified downlink and unified uplink TCI state operation. For example, for unified joint TCI operation, the capability information 320 may indicate that the UE 115-b supports using a first indicated unified joint TCI state as a default in association with a PUSCH or PDSCH transmission scheduled by non-TCI selection DCI 340 (e.g., DCI that lacks a TCI selection field, a SRS resource set selection field, or a TCI indication field, such as fall back DCI0_0, DCI1_0, or DCI0_1/DCI0_2 without SRS resource set selection indicator field or DCI1_1/DCI1_2 without TCI selection field). For separate unified TCI operation, the capability information 320 may indicate that the UE 115-b supports using a first indicated unified uplink TCI state as a default in association with a PUSCH transmission scheduled by non-TCI selection DCI 340, or using a first indicated unified downlink TCI state as a default in association with a PDSCH transmission scheduled by non-TCI selection DCI 340.

In some aspects, the capability information 320 may indicate that the UE 115-b supports an indication or configuration of unified joint or unified downlink TCI states for aperiodic CSI-RS, PDCCH, or PDSCH for individual channels or reference signals. In some aspects, the capability information 320 may indicate that the UE 115-b supports an indication or configuration of unified joint or unified uplink TCI states for SRS for individual reference signals. For example, for unified joint TCI state operation and/or separate unified downlink and unified uplink TCI state operation, the capability information 320 may indicate whether the UE 115-b can support indication and/or configuration of R18 unified TCI states for individual aperiodic CSI-RS, PDCCH, PDSCH as legacy TCI states (e.g., NR release 15 (R15) TCI states or NR release 16 (R16) TCI states) for individual channels or reference signals. For unified joint TCI state operation and/or separate unified downlink and unified uplink TCI state operation, the capability information 320 may indicate whether the UE 115-b can support indication and/or configuration of R18 unified TCI states for SRS, as legacy R15 or R16 TCI states for SRS.

In some aspects, for unified joint TCI state operation and/or separate unified downlink and unified uplink TCI state operation, the capability information 320 may indicate whether the UE 115-b can support configuring R17 single TRP operation in one or more CCs, R18 single TRP operation in one or more CCs, R18 single DCI based multi-TRP operation one or more CCs, R18 multi-DCI based multi-TRP operation in one or more CCs in the same CC list for common beam/TCI activation and/or indication, or any combination thereof.

In some aspects, the capability information 320 may indicate that the UE 115-b supports the configuration of a PDSCH-CJT scheme for unified joint TCI state operation and/or separate unified downlink and unified uplink TCI state operation. For example, for unified joint TCI state operation, the capability information 320 may indicate that up to a quantity (e.g., up to two) unified joint TCI states may be indicated by a control message (e.g., a MAC-CE 335, a DCI 340) and applied to CJT-based PDSCH reception in a BWP and/or CC configured for unified joint TCI state operation. For separate unified TCI state operation, the capability information 320 may indicate that up to a quantity (e.g., up to two) unified downlink TCI states may be indicated by a control message (e.g., a MAC-CE 335, a DCI 340) and applied to CJT-based PDSCH reception in a BWP and/or CC configured for unified downlink TCI state operation.

In some aspects, the capability information 320 may indicate a maximum number of supported unified joint TCI states for the PDSCH-CJT scheme. In some aspects, the capability information may indicate a maximum number of supported unified downlink TCI states for the PDSCH-CJT scheme. In some aspects, the capability information 320 may indicate whether one or two unified joint TCI states or unified downlink TCI states are supported for the PDSCH-CJT scheme.

In some aspects, if multiple (e.g., two) unified joint TCI states or unified downlink TCI states are supported, the capability information 320 may indicate that the UE 115-b supports QCL operation for the PDSCH-CJT scheme. In some examples, the capability information 320 may indicate that, for the QCL operation, PDSCH DMRS port(s) are QCLed with the downlink reference signals of the multiple (e.g., both) indicated unified joint or unified downlink TCI states with respect to a first QCL type (e.g., QCL-TypeA). In some examples, the capability information 320 may indicate that, for the QCL operation, PDSCH DMRS port(s) are QCLed with the downlink reference signals of the multiple (e.g., both) indicated unified joint or unified downlink TCI states with respect to the first QCL type (e.g., QCL-TypeA) except for a subset of QCL parameters (e.g., Doppler shift, Doppler spread) of the second indicated unified joint or unified downlink TCI state. In some examples, the capability information 320 may indicate that, for the QCL operation, PDSCH DMRS port(s) are QCLed with the downlink reference signals of the first indicated unified joint or unified downlink TCI state with respect to the first QCL type (e.g., QCL-TypeA) and QCLed with the downlink reference signal of the second indicated unified joint or unified downlink TCI state with respect to a second QCL type (e.g., QCL-TypeB). In some examples, the capability information 320 may indicate that, for the QCL operation, PDSCH DMRS port(s) are QCLed with the downlink reference signals of the multiple (e.g., both) indicated unified joint or unified downlink TCI states with respect to a first QCL type (e.g., using both delay and doppler properties per TCI state). In some examples, the capability information 320 may indicate that, for the QCL operation, PDSCH DMRS port(s) are QCLed with the downlink reference signals of the multiple (e.g., both) indicated unified joint or unified downlink TCI states with respect to the second QCL type (e.g., ignoring doppler properties from one TCI state). In some examples, the capability information 320 may indicate that, for the QCL operation, PDSCH DMRS port(s) are QCLed with the downlink reference signals of the multiple (e.g., both) indicated unified joint or unified downlink TCI states with respect to the third QCL type (e.g., ignoring delay properties from one TCI state).

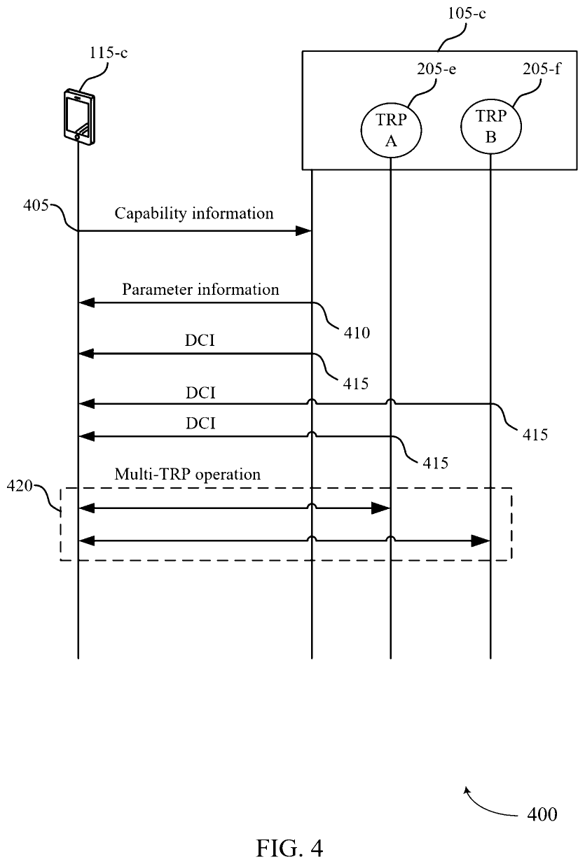

FIG. 4 shows an example of a process flow 400 that supports unified TCI state indication for single or multi-DCI based multi-TRP operation in accordance with one or more aspects of the present disclosure. The process flow 400 may include a network entity 105-c and a UE 115-c. The network entity 105-c may be an example of a network entity 105 described herein. The UE 115-c may be an example of a UE 115 described herein. The network entity may include a first TRP 205-e and a second TRP 205-f, which may be examples of TRPs 205 as described herein. In the following description of the process flow 400, the operations between the network entity 105-c, the UE 115-c, the first TRP 205-e, and the second TRP 205-f may be transmitted in a different order than the example order shown, or the operations performed by the network entity 105-c, the UE 115-c, the first TRP 205-e, and the second TRP 205-f may be performed in different orders or at different times. Some operations may also be omitted from the process flow 400, and other operations may be added to the process flow 400.

At 405, the UE 115-c may transmit, to the network entity 105-c, capability information indicating one or more capabilities of the UE 115-c associated with a unified TCI framework for a multi-TRP operation.

At 410, the UE 115-c may receive, from the network entity 105-c based on the capability information, a control message indicating one or more parameters for the multi-TRP operation.

At 415, the UE 115-c may receive, from the network entity 105-c, a at least one DCI. The at least one DCI schedules a multi-TRP operation accordance with the one or more parameters.

At 420, the UE 115-c may perform the multi-TRP operation with the set of multiple TRPs (e.g., with first TRP 205-e and the second TRP 205-f). For example, the multi-TRP operation may be PDSCHs received from the first TRP 205-e and the second TRP 205-f or PUSCHs transmitted to the first TRP 205-e and the second TRP 205-f.

In some examples, the multi-TRP operation is a multi DCI-based multi-TRP operation, where the one or more parameters are for the multi DCI-based multi-TRP operation, where the at least one DCI is a set of multiple DCIs received from a respective set of multiple TRPs, and where the set of multiple DCIs schedule the multi-TRP operation with the respective set of multiple TRPs.

In some examples, the one or more capabilities include a capability of the UE 115-c to receive control signaling (e.g., a MAC-CE) activating one joint unified TCI state per CC in a band, and at least one TCI codepoint is mapped to a joint unified TCI state per CORESET pool index. In some examples, the one or more capabilities include a capability of the UE 115-c to receive control signaling (e.g., a MAC-CE) activating one downlink unified TCI state and one uplink unified transmission configuration state per CC in a band, and at least one TCI codepoint is mapped to a downlink unified TCI state and an uplink unified TCI state per CORESET pool index.

In some examples, the one or more capabilities include a capability of the UE 115-c to receive control signaling (e.g., a MAC-CE) indicating an activated joint unified TCI state is mapped to a CORESET pool index. In some examples, the one or more capabilities include a capability of the UE 115-c to receive control signaling (e.g., a MAC-CE) indicating an activated downlink unified TCI and an activated downlink unified TCI state is mapped to a CORESET pool index.

In some examples, the one or more capabilities include a capability of the UE 115-c to support common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

In some examples, the one or more capabilities include a capability of the UE 115-c to perform a shared channel communication (e.g., a PDSCH or PUSCH) using a joint unified TCI state associated with a CORESET pool index associated with a DCI that scheduled the shared channel communication.

In some examples, the one or more capabilities include a capability of the UE 115-c to receive a downlink shared channel communication using a downlink unified TCI state associated with a CORESET pool index associated with a DCI that scheduled the downlink shared channel communication.

In some examples, the one or more capabilities include a capability of the UE 115-c to transmit an uplink shared channel communication using an uplink unified TCI state associated with a CORESET pool index associated with a DCI that scheduled the uplink shared channel communication.

In some examples, the one or more capabilities include a capability of the UE 115-c to receive control signaling (e.g., RRC) associating an uplink control channel resource (e.g., a PUCCH resource) with a joint unified TCI state, and the joint unified TCI state is associated with a CORESET pool index associated with one of the respective set of multiple TRPs. In some examples, the one or more capabilities include a capability of the UE 115-c to receive control signaling (e.g., RRC) associating an uplink control channel resource (e.g., a PUCCH resource) with an uplink unified TCI state, and the uplink unified TCI state is associated with a CORESET pool index associated with one of the respective set of multiple TRPs.

In some examples, the one or more capabilities include a capability of the UE 115-c to receive control signaling (e.g., RRC) associating a configured grant resource with a joint unified TCI state, and the joint unified TCI state is associated with a CORESET pool index associated with one of the respective set of multiple TRPs. In some examples, the one or more capabilities include a capability of the UE 115-c to receive control signaling associating a configured grant resource with an uplink unified TCI state, and the uplink unified TCI state is associated with a CORESET pool index associated with one of the respective set of multiple TRPs.

In some examples, the one or more capabilities include a capability of the UE 115-c to update at least one of a QCL assumption, a spatial transmission filter, or a pathloss reference signal for a joint unified TCI state in response to a beam failure recovery procedure for a beam corresponding to the joint unified TCI state. In some examples, the one or more capabilities include a capability of the UE 115-c to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

In some examples, the one or more capabilities include a capability of the UE 115-c to receive control signaling (e.g., RRC) associating a joint unified TCI state or an uplink unified TCI state with an uplink power control configuration.

In some examples, the one or more capabilities include a capability of the UE 115-c to receive control signaling (e.g., RRC) associating an uplink power control configuration per TRP.

In some examples, the one or more capabilities include a capability of the UE 115-c to receive control signaling activating a set of joint unified TCI states per physical cell identifier of a set of multiple physical cell identifiers, and at least one of the set of multiple physical cell identifiers is a serving cell.

In some examples, the one or more capabilities include a capability of the UE 115-c to receive control signaling activating a set of downlink unified TCI states and a set of uplink unified TCI states per physical cell identifier of a set of multiple physical cell identifiers, and at least one of the set of multiple physical cell identifiers is a serving cell.

In some examples, the UE 115-c may transmit, to the network entity 105-c, second capability information indicating one or more second capabilities of the UE 115-c associated with the unified TCI framework for a single DCI based single-TRP operation, where the capability information indicates that one or more of the one or more capabilities of the UE 115-c are the same as corresponding capabilities of the one or more second capabilities indicated by the second capability information.

In some examples, the capability information includes a report that indicates the one or more capabilities of the UE 115-c in addition to one or more second capabilities of the UE 115-c associated with the unified TCI framework for a single DCI-based single TRP operation.

In some examples, the UE 115-c may transmit, to the network entity 105-c, second capability information indicating one or more second capabilities of the UE 115-c associated with the unified TCI framework for a single DCI based single-TRP operation, where the capability information includes an indication that one or more third capabilities of the UE 115-c associated with the unified TCI framework for the multi-DCI based multi-TRP operation that are excluded from the capability information are the same as corresponding capabilities of the one or more second capabilities included in the second capability information.

In some examples, the one or more capabilities are specific to the UE 115-c, a frequency band, a frequency band combination, a feature set associated with the UE 115-c, a feature set per CC, a frequency division duplexing configuration, a time division duplexing configuration, a sub-millimeter wave range of frequencies, a millimeter wave range of frequencies, or a combination thereof.

In some examples, the multi-TRP operation is a single DCI-based multi-TRP operation, where the one or more parameters are for the single DCI-based multi-TRP operation, and where the at least one DCI is a single DCI that schedules the multi-TRP operation.

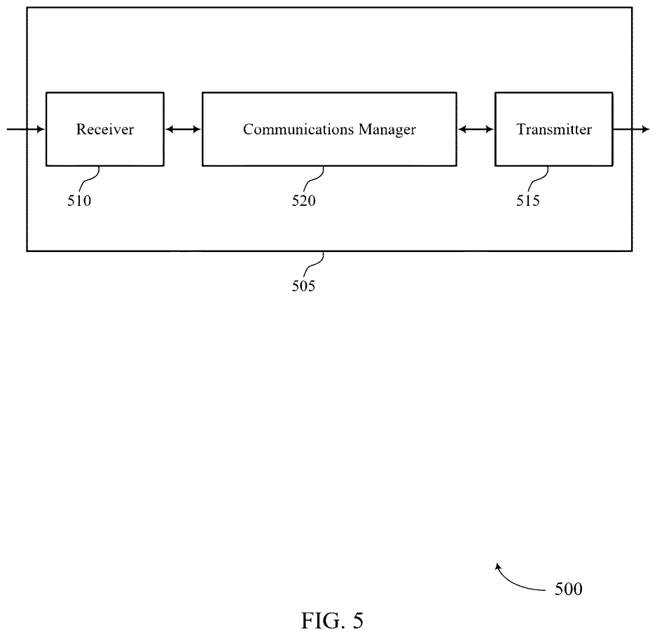

FIG. 5 shows a diagram 500 of a device 505 that supports unified TCI state indication for single or multi-DCI based multi-TRP operation in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to unified TCI state indication for single or multi-DCI based multi-TRP operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to unified TCI state indication for single or multi-DCI based multi-TRP operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of unified TCI state indication for single or multi-DCI based multi-TRP operation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for transmitting capability information indicating one or more capabilities of the UE associated with a unified TCI framework for a multi-DCI based multi-TRP operation. The communications manager 520 is capable of, configured to, or operable to support a means for receiving, based on the capability information, a control message indicating one or more parameters for the multi-DCI based multi-TRP operation. The communications manager 520 is capable of, configured to, or operable to support a means for receiving a set of multiple DCIs from a respective set of multiple TRPs, where the set of multiple DCIs schedule a multi-TRP operation with the respective set of multiple TRPs in accordance with the one or more parameters. The communications manager 520 is capable of, configured to, or operable to support a means for performing the multi-TRP operation.

As another example, the communications manager 520 is capable of, configured to, or operable to support a means for transmitting capability information indicating one or more capabilities of the UE associated with a unified TCI framework for a single DCI-based multi-TRP operation. The communications manager 520 is capable of, configured to, or operable to support a means for receiving, based on the capability information, a control message indicating one or more parameters for the single DCI-based multi-TRP operation. The communications manager 520 is capable of, configured to, or operable to support a means for receiving DCI that schedules a multi-TRP operation in accordance with the one or more parameters. The communications manager 520 is capable of, configured to, or operable to support a means for performing the multi-TRP operation.

As another example, the communications manager 520 is capable of, configured to, or operable to support a means for transmitting capability information indicating one or more capabilities of the UE associated with a unified TCI framework for a multi-TRP operation. The communications manager 520 is capable of, configured to, or operable to support a means for receiving, based on the capability information, a control message indicating one or more parameters for the multi-TRP operation. The communications manager 520 is capable of, configured to, or operable to support a means for receiving at least one DCI that schedules a multi-TRP operation in accordance with the one or more parameters. The communications manager 520 is capable of, configured to, or operable to support a means for performing the multi-TRP operation.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for more efficient utilization of communication resources.

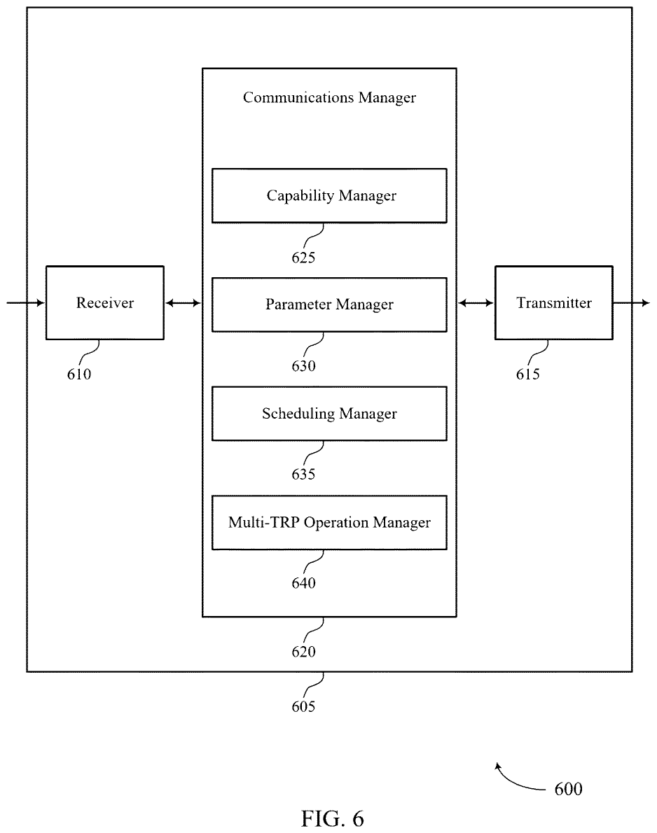

FIG. 6 shows a diagram 600 of a device 605 that supports unified TCI state indication for single or multi-DCI based multi-TRP operation in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to unified TCI state indication for single or multi-DCI based multi-TRP operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to unified TCI state indication for single or multi-DCI based multi-TRP operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of unified TCI state indication for single or multi-DCI based multi-TRP operation as described herein. For example, the communications manager 620 may include a capability manager 625, a parameter manager 630, a scheduling manager 635, a multi-TRP operation manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The capability manager 625 is capable of, configured to, or operable to support a means for transmitting capability information indicating one or more capabilities of the UE associated with a unified TCI framework for a multi-DCI based multi-TRP operation. The parameter manager 630 is capable of, configured to, or operable to support a means for receiving, based on the capability information, a control message indicating one or more parameters for the multi-DCI based multi-TRP operation. The scheduling manager 635 is capable of, configured to, or operable to support a means for receiving a set of multiple DCIs from a respective set of multiple TRPs, where the set of multiple DCIs schedule a multi-TRP operation with the respective set of multiple TRPs in accordance with the one or more parameters. The multi-TRP operation manager 640 is capable of, configured to, or operable to support a means for performing the multi-TRP operation.

In some examples, the capability manager 625 is capable of, configured to, or operable to support a means for transmitting capability information indicating one or more capabilities of the UE associated with a unified TCI framework for a multi-TRP operation. The parameter manager 630 is capable of, configured to, or operable to support a means for receiving, based on the capability information, a control message indicating one or more parameters for the multi-TRP operation. The scheduling manager 635 is capable of, configured to, or operable to support a means for receiving at least one DCI that schedules a multi-TRP operation in accordance with the one or more parameters. The multi-TRP operation manager 640 is capable of, configured to, or operable to support a means for performing the multi-TRP operation.

In some examples, the capability manager 625 is capable of, configured to, or operable to support a means for transmitting capability information indicating one or more capabilities of the UE associated with a unified TCI framework for a single DCI-based multi-TRP operation. The parameter manager 630 is capable of, configured to, or operable to support a means for receiving, based on the capability information, a control message indicating one or more parameters for the single DCI-based multi-TRP operation. The scheduling manager 635 is capable of, configured to, or operable to support a means for receiving DCI that schedules a multi-TRP operation in accordance with the one or more parameters. The multi-TRP operation manager 640 is capable of, configured to, or operable to support a means for performing the multi-TRP operation.

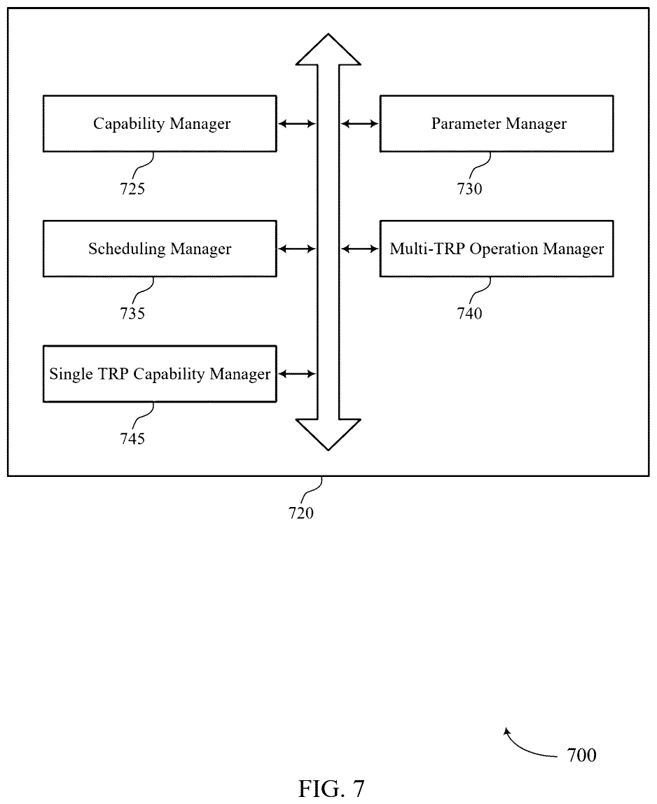

FIG. 7 shows a diagram 700 of a communications manager 720 that supports unified TCI state indication for single or multi-DCI based multi-TRP operation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of unified TCI state indication for single or multi-DCI based multi-TRP operation as described herein. For example, the communications manager 720 may include a capability manager 725, a parameter manager 730, a scheduling manager 735, a multi-TRP operation manager 740, a single TRP capability manager 745, or any combination thereof. Each of these components may communicate, directly or indirectly, with one another (e.g., via one or more buses).

The communications manager 720 may support wireless communications at a UE in accordance with examples as disclosed herein. The capability manager 725 is capable of, configured to, or operable to support a means for transmitting capability information indicating one or more capabilities of the UE associated with a unified TCI framework for a multi-DCI based multi-TRP operation. The parameter manager 730 is capable of, configured to, or operable to support a means for receiving, based on the capability information, a control message indicating one or more parameters for the multi-DCI based multi-TRP operation. The scheduling manager 735 is capable of, configured to, or operable to support a means for receiving a set of multiple DCIs from a respective set of multiple TRPs, where the set of multiple DCIs schedule a multi-TRP operation with the respective set of multiple TRPs in accordance with the one or more parameters. The multi-TRP operation manager 740 is capable of, configured to, or operable to support a means for performing the multi-TRP operation.

In some examples, the one or more capabilities include a capability of the UE to receive control signaling activating one joint unified TCI state per CC in a band. In some examples, at least one TCI codepoint is mapped to a joint unified TCI state per CORESET pool index.

In some examples, the one or more capabilities include a capability of the UE to receive control signaling activating one downlink unified TCI state and one uplink unified transmission configuration state per CC in a band. In some examples, at least one TCI codepoint is mapped to a downlink unified TCI state and an uplink unified TCI state per CORESET pool index.

In some examples, the one or more capabilities include a capability of the UE to receive control signaling indicating an activated joint unified TCI state is mapped to a CORESET pool index.

In some examples, the one or more capabilities include a capability of the UE to receive control signaling indicating an activated downlink unified TCI and an activated downlink unified TCI state is mapped to a CORESET pool index.

In some examples, the one or more capabilities include a capability of the UE to support: common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

In some examples, the one or more capabilities include a capability of the UE to perform a shared channel communication using a joint unified TCI state associated with a CORESET pool index associated with a DCI that scheduled the shared channel communication.

In some examples, the one or more capabilities include a capability of the UE to receive a downlink shared channel communication using a downlink unified TCI state associated with a CORESET pool index associated with a DCI that scheduled the downlink shared channel communication.

In some examples, the one or more capabilities include a capability of the UE to transmit an uplink shared channel communication using an uplink unified TCI state associated with a CORESET pool index associated with a DCI that scheduled the uplink shared channel communication.

In some examples, the one or more capabilities include a capability of the UE to receive control signaling associating an uplink control channel resource with a joint unified TCI state. In some examples, the joint unified TCI state is associated with a CORESET pool index associated with one of the respective set of multiple TRPs.

In some examples, the one or more capabilities include a capability of the UE to receive control signaling associating an uplink control channel resource with an uplink unified TCI state. In some examples, the uplink unified TCI state is associated with a CORESET pool index associated with one of the respective set of multiple TRPs.

In some examples, the one or more capabilities include a capability of the UE to receive control signaling associating a configured grant resource with a joint unified TCI state. In some examples, the joint unified TCI state is associated with a CORESET pool index associated with one of the respective set of multiple TRPs.

In some examples, the one or more capabilities include a capability of the UE to receive control signaling associating a configured grant resource with an uplink unified TCI state. In some examples, the uplink unified TCI state is associated with a CORESET pool index associated with one of the respective set of multiple TRPs.

In some examples, the one or more capabilities include a capability of the UE to update at least one of a QCL assumption, a spatial transmission filter, or a pathloss reference signal for a joint unified TCI state in response to a beam failure recovery procedure for a beam corresponding to the joint unified TCI state.

In some examples, the one or more capabilities include a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

In some examples, the one or more capabilities include a capability of the UE to receive control signaling associating a joint unified TCI state or an uplink unified TCI state with an uplink power control configuration.

In some examples, the one or more capabilities include a capability of the UE to receive control signaling associating an uplink power control configuration per TRP.

In some examples, the one or more capabilities include a capability of the UE to receive control signaling activating a set of joint unified TCI states per physical cell identifier of a set of multiple physical cell identifiers. In some examples, at least one of the set of multiple physical cell identifiers is a serving cell.

In some examples, the one or more capabilities include a capability of the UE to receive control signaling activating a set of downlink unified TCI states and a set of uplink unified TCI states per physical cell identifier of a set of multiple physical cell identifiers. In some examples, at least one of the set of multiple physical cell identifiers is a serving cell.

In some examples, the single TRP capability manager 745 is capable of, configured to, or operable to support a means for transmitting second capability information indicating one or more second capabilities of the UE associated with the unified TCI framework for a single DCI based single-TRP operation, where the capability information indicates that one or more of the one or more capabilities of the UE are the same as corresponding capabilities of the one or more second capabilities indicated by the second capability information.

In some examples, the capability information includes a report that indicates the one or more capabilities of the UE in addition to one or more second capabilities of the UE associated with the unified TCI framework for a single DCI-based single TRP operation.

In some examples, the single TRP capability manager 745 is capable of, configured to, or operable to support a means for transmitting second capability information indicating one or more second capabilities of the UE associated with the unified TCI framework for a single DCI based single-TRP operation, where the capability information includes an indication that one or more third capabilities of the UE associated with the unified TCI framework for the multi-DCI based multi-TRP operation that are excluded from the capability information are the same as corresponding capabilities of the one or more second capabilities included in the second capability information.

In some examples, the one or more capabilities are specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

In some examples, the capability manager 725 is capable of, configured to, or operable to support a means for transmitting capability information indicating one or more capabilities of the UE associated with a unified TCI framework for a single DCI-based multi-TRP operation. The parameter manager 730 is capable of, configured to, or operable to support a means for receiving, based on the capability information, a control message indicating one or more parameters for the single DCI-based multi-TRP operation. The scheduling manager 735 is capable of, configured to, or operable to support a means for receiving DCI that schedules a multi-TRP operation in accordance with the one or more parameters. The multi-TRP operation manager 740 is capable of, configured to, or operable to support a means for performing the multi-TRP operation.

In some examples, the one or more capabilities include a capability of the UE to receive control signaling that activates a TCI codepoint mapped to one or more unified joint TCI states, one or more unified downlink TCI states, or one or more unified uplink TCI states per CC in a band.

In some examples, the one or more capabilities include a second capability of the UE to update a first subset of unified TCI states of a set of activated unified TCI states based on the TCI codepoint being mapped to the first subset and maintain a second subset of unified TCI states of the set of activated unified TCI states based on the TCI codepoint lacking a mapping to the second subset.

In some examples, at least one TCI codepoints of a set of TCI codepoints including the TCI codepoint is mapped to two unified joint TCI states, two unified downlink TCI states, or two unified uplink TCI states.

In some examples, the one or more capabilities include a capability of the UE to receive control signaling that activates a TCI codepoint mapped to up to two unified joint TCI states, two unified downlink TCI states, or two unified uplink TCI states.

In some examples, the one or more capabilities include a capability of the UE to support common TCI state identifier update and activation for a set of CCs associated with the single DCI-based multi-TRP operation.

In some examples, the one or more capabilities include a capability of the UE to receive control signaling that indicates whether the UE is to apply, to an aperiodic CSI-RS resource or an aperiodic CSI-RS resource set: a first unified joint TCI state or a second unified joint TCI state indicated by a second control message; or a first unified downlink TCI state or a second unified downlink TCI state indicated by the second control message.

In some examples, the one or more capabilities include a capability of the UE to receive control signaling that indicates whether the UE is to apply, to a PUCCH resource or group: a first unified joint TCI state, a second unified joint TCI state, or both, indicated by a second control message; or a first unified uplink TCI state, a second unified uplink TCI state, or both, indicated by the second control message.

In some examples, the one or more capabilities include a capability of the UE to receive control signaling that indicates whether the UE is to apply, to a CORESET or group of CORSETs: a first unified joint TCI state, a second unified joint TCI state, both the first and second unified joint TCI states, or none of the first and second unified joint TCI states, indicated by a second control message; or a first unified downlink TCI state, a second unified downlink TCI state, both the first and second unified downlink TCI states, or none of the first and second unified downlink TCI states indicated by the second control message.

In some examples, the CORESET or group of CORESETs are associated with communications via a PDCCH with repetition, communications via a PDCCH without repetition, PDCCH-SFN communications, PDCCH-non SFN communications, or a combination thereof.

In some examples, the one or more capabilities include a capability of the UE to receive DCI associated with PDSCH reception scheduling that includes a field to select, for reception of a PDSCH, one or more unified joint TCI states or one or more unified downlink TCI states indicated by a TCI codepoint.

In some examples, the one or more capabilities include a capability of the UE to receive DCI associated with PUSCH transmission scheduling that includes a field to select, for transmission of a PUSCH, one or more unified joint TCI states or one or more unified uplink TCI states indicated by a TCI codepoint.

In some examples, the one or more capabilities include a capability of the UE to receive control signaling that indicates whether the UE is to apply, to a CG-PUSCH transmission: a first unified joint TCI state, a second unified joint TCI state, or both, indicated by a second control message; or a first unified uplink TCI state, a second unified uplink TCI state, or both, indicated by the second control message.

In some examples, the one or more capabilities include a capability of the UE to switch between performing the multi-TRP operation and performing a single-TRP operation.

In some examples, the one or more capabilities include a capability of the UE to determine a BFD reference signal set based on one or more unified joint TCI states or one or more unified downlink TCI states indicated for the single DCI-based multi-TRP operation.

In some examples, the one or more capabilities include a capability of the UE to perform per-TRP beam reset in association with BFR.

In some examples, the one or more capabilities include a capability of the UE to support per-TRP default power control parameters.

In some examples, the one or more capabilities include a capability of the UE to support an offset threshold that is specific to the single DCI-based multi-TRP operation, the offset threshold being a duration of time between a second control message that schedules a PDSCH or an aperiodic CSI-RS and a reception of the PDSCH or the aperiodic CSI-RS.

In some examples, the one or more capabilities include a capability of the UE to use a first indicated unified joint TCI state or a first indicated unified uplink TCI state as a default in association with a PUSCH transmission scheduled by DCI that lacks a field to select or indicate a unified TCI state.

In some examples, the one or more capabilities include a capability of the UE to receive control signaling that configures a PDSCH-CJT scheme associated with the single DCI-based multi-TRP operation.

In some examples, the one or more capabilities include a second capability of the UE that indicates a first quantity of unified joint TCI states or a second quantity of unified downlink TCI states supported by the UE for the PDSCH-CJT scheme.

In some examples, the one or more capabilities include a third capability of the UE to support QCL operation for the PDSCH-CJT scheme when two unified TCI states are indicated, where for the QCL operation: PDSCH DMRS ports are QCLed with downlink reference signals of the two unified TCI states with respect to a first QCL type; or the PDSCH DMRS ports are QCLed with the downlink reference signals with respect to the first QCL type except for a subset of QCL parameters associated with a second unified TCI state of the two unified TCI states; or the PDSCH DMRS ports are QCLed with downlink reference signals a first unified TCI state of the two unified TCI states with respect to the first QCL type and QCLed with downlink reference signals of the second unified TCI state with respect to a second QCL type.

In some examples, the capability manager 725 is capable of, configured to, or operable to support a means for transmitting second capability information indicating one or more second capabilities of the UE associated with a unified TCI framework for a single DCI-based single-TRP operation, where the capability information indicates that one or more of the one or more capabilities of the UE are the same as corresponding capabilities of the one or more second capabilities indicated by the second capability information.

In some examples, the capability information includes a report that indicates the one or more capabilities of the UE in addition to one or more second capabilities of the UE associated with the unified TCI framework for a single DCI-based single TRP operation.

In some examples, the capability manager 725 is capable of, configured to, or operable to support a means for transmitting second capability information indicating one or more second capabilities of the UE associated with a unified TCI framework for a single DCI-based single-TRP operation, where the capability information includes an indication that one or more third capabilities of the UE associated with the unified TCI framework for the single DCI-based multi-TRP operation that are excluded from the capability information are the same as corresponding capabilities of the one or more second capabilities included in the second capability information.

In some examples, the one or more capabilities are specific to the UE, a frequency band, a frequency band combination, a feature set associated with the UE, a feature set per CC, an FDD configuration, a TDD configuration, a sub-mmW range of frequencies (e.g., an FR1 band), a mmW range of frequencies (e.g., an FR2 band), or a combination thereof.

In some examples, the capability manager 725 is capable of, configured to, or operable to support a means for transmitting capability information indicating one or more capabilities of the UE associated with a unified TCI framework for a multi-TRP operation. The parameter manager 730 is capable of, configured to, or operable to support a means for receiving, based on the capability information, a control message indicating one or more parameters for the multi-TRP operation. The scheduling manager 735 is capable of, configured to, or operable to support a means for receiving at least one DCI that schedules a multi-TRP operation in accordance with the one or more parameters. The multi-TRP operation manager 740 is capable of, configured to, or operable to support a means for performing the multi-TRP operation.

In some examples, the multi-TRP operation is a single DCI-based multi-TRP operation, where the one or more parameters are for the single DCI-based multi-TRP operation, and where the at least one DCI is a single DCI that schedules the multi-TRP operation.

In some examples, the multi-TRP operation is a multi DCI-based multi-TRP operation, where the one or more parameters are for the multi DCI-based multi-TRP operation, where the at least one DCI is a set of multiple DCIs received from a respective set of multiple TRPs, and where the set of multiple DCIs schedule the multi-TRP operation with the respective set of multiple TRPs.

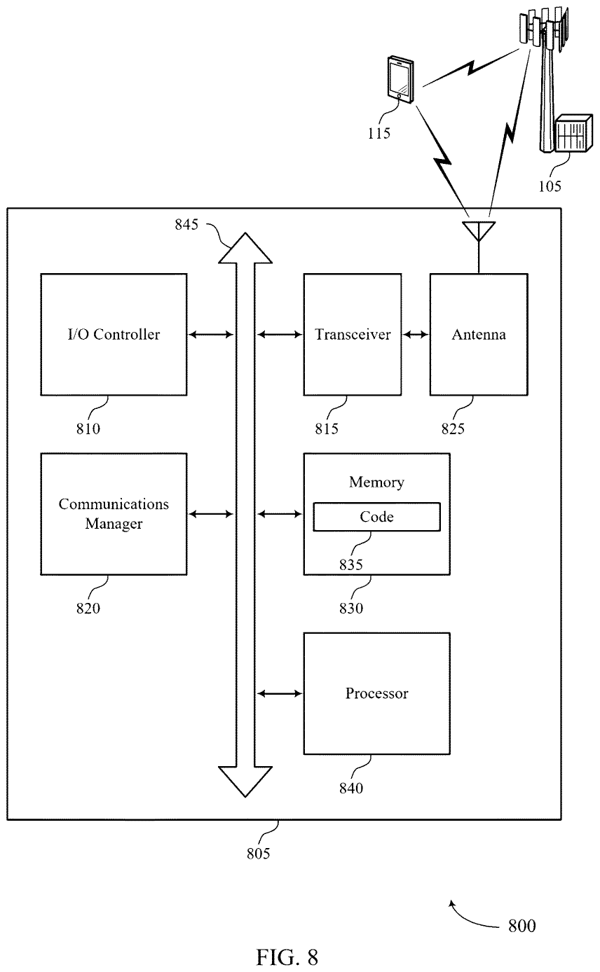

FIG. 8 shows a diagram of a system 800 including a device 805 that supports unified TCI state indication for single or multi-DCI based multi-TRP operation in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting unified TCI state indication for single or multi-DCI based multi-TRP operation). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for transmitting capability information indicating one or more capabilities of the UE associated with a unified TCI framework for a multi-DCI based multi-TRP operation. The communications manager 820 is capable of, configured to, or operable to support a means for receiving, based on the capability information, a control message indicating one or more parameters for the multi-DCI based multi-TRP operation. The communications manager 820 is capable of, configured to, or operable to support a means for receiving a set of multiple DCIs from a respective set of multiple TRPs, where the set of multiple DCIs schedule a multi-TRP operation with the respective set of multiple TRPs in accordance with the one or more parameters. The communications manager 820 is capable of, configured to, or operable to support a means for performing the multi-TRP operation.

As another example, the communications manager 820 is capable of, configured to, or operable to support a means for transmitting capability information indicating one or more capabilities of the UE associated with a unified TCI framework for a single DCI-based multi-TRP operation. The communications manager 820 is capable of, configured to, or operable to support a means for receiving, based on the capability information, a control message indicating one or more parameters for the single DCI-based multi-TRP operation. The communications manager 820 is capable of, configured to, or operable to support a means for receiving DCI that schedules a multi-TRP operation in accordance with the one or more parameters. The communications manager 820 is capable of, configured to, or operable to support a means for performing the multi-TRP operation.

As another example, the communications manager 820 is capable of, configured to, or operable to support a means for transmitting capability information indicating one or more capabilities of the UE associated with a unified TCI framework for a multi-TRP operation. The communications manager 820 is capable of, configured to, or operable to support a means for receiving, based on the capability information, a control message indicating one or more parameters for the multi-TRP operation. The communications manager 820 is capable of, configured to, or operable to support a means for receiving at least one DCI that schedules a multi-TRP operation in accordance with the one or more parameters. The communications manager 820 is capable of, configured to, or operable to support a means for performing the multi-TRP operation.

By including or configuring the communications manager 820 in accordance with examples as described herein, the device 805 may support techniques for more efficient utilization of communication resources and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of unified TCI state indication for single or multi-DCI based multi-TRP operation as described herein, or the processor 840 and the memory 830 may be otherwise configured to perform or support such operations.

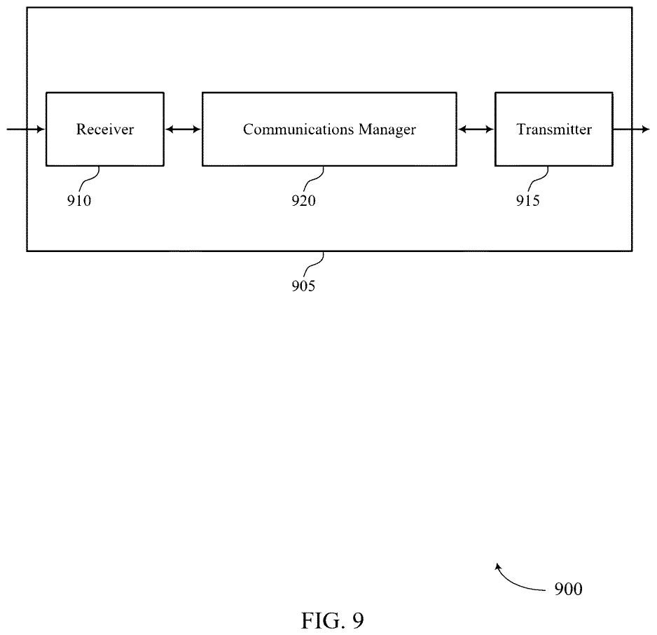

FIG. 9 shows a diagram 900 of a device 905 that supports unified TCI state indication for single or multi-DCI based multi-TRP operation in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of unified TCI state indication for single or multi-DCI based multi-TRP operation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for receiving, from a UE, capability information indicating one or more capabilities of the UE associated with a unified TCI framework for a multi-DCI based multi-TRP operation. The communications manager 920 is capable of, configured to, or operable to support a means for transmitting, to the UE and based on the capability information, a control message indicating one or more parameters for the multi-DCI based multi-TRP operation. The communications manager 920 is capable of, configured to, or operable to support a means for transmitting, to the UE, a set of multiple DCIs via a respective set of multiple TRPs, where the set of multiple DCIs schedule a multi-TRP operation with the respective set of multiple TRPs in accordance with the one or more parameters.

As another example, the communications manager 920 is capable of, configured to, or operable to support a means for receiving capability information indicating one or more capabilities of a UE associated with a unified TCI framework for a single DCI-based multi-TRP operation. The communications manager 920 is capable of, configured to, or operable to support a means for transmitting, based on the capability information, a control message indicating one or more parameters for the single DCI-based multi-TRP operation. The communications manager 920 is capable of, configured to, or operable to support a means for transmitting DCI that schedules a multi-TRP operation in accordance with the one or more parameters.

As another example, the communications manager 920 is capable of, configured to, or operable to support a means for receiving capability information indicating one or more capabilities of a UE associated with a unified TCI framework for a multi-TRP operation. The communications manager 920 is capable of, configured to, or operable to support a means for transmitting, based on the capability information, a control message indicating one or more parameters for the multi-TRP operation. The communications manager 920 is capable of, configured to, or operable to support a means for transmitting at least one DCI that schedules a multi-TRP operation in accordance with the one or more parameters.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for more efficient utilization of communication resources.

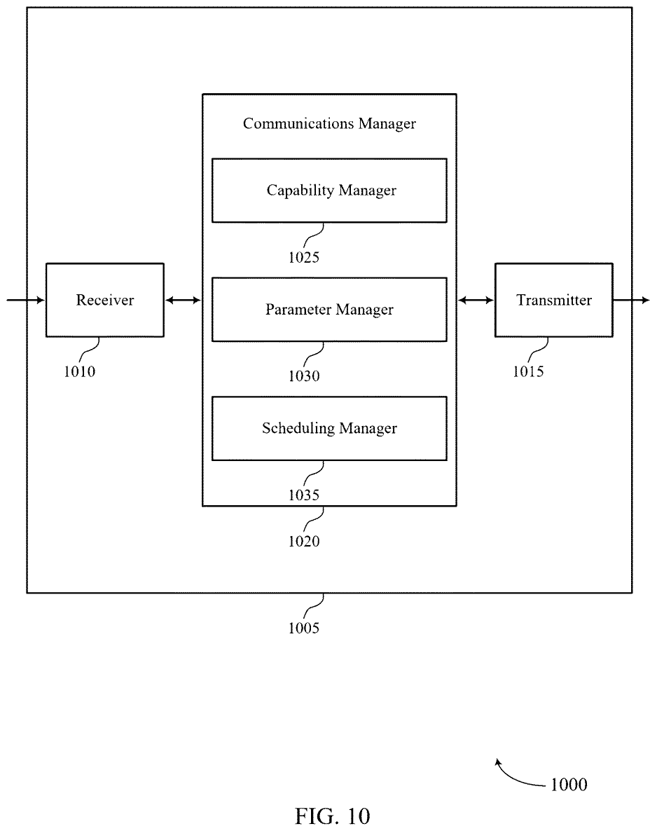

FIG. 10 shows a diagram 1000 of a device 1005 that supports unified TCI state indication for single or multi-DCI based multi-TRP operation in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of unified TCI state indication for single or multi-DCI based multi-TRP operation as described herein. For example, the communications manager 1020 may include a capability manager 1025, a parameter manager 1030, a scheduling manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The capability manager 1025 is capable of, configured to, or operable to support a means for receiving, from a UE, capability information indicating one or more capabilities of the UE associated with a unified TCI framework for a multi-DCI based multi-TRP operation. The parameter manager 1030 is capable of, configured to, or operable to support a means for transmitting, to the UE and based on the capability information, a control message indicating one or more parameters for the multi-DCI based multi-TRP operation. The scheduling manager 1035 is capable of, configured to, or operable to support a means for transmitting, to the UE, a set of multiple DCIs via a respective set of multiple TRPs, where the set of multiple DCIs schedule a multi-TRP operation with the respective set of multiple TRPs in accordance with the one or more parameters.

In some examples, the capability manager 1025 is capable of, configured to, or operable to support a means for receiving capability information indicating one or more capabilities of a UE associated with a unified TCI framework for a single DCI-based multi-TRP operation. The parameter manager 1030 is capable of, configured to, or operable to support a means for transmitting, based on the capability information, a control message indicating one or more parameters for the single DCI-based multi-TRP operation. The scheduling manager 1035 is capable of, configured to, or operable to support a means for transmitting DCI that schedules a multi-TRP operation in accordance with the one or more parameters.

In some examples, the capability manager 1025 is capable of, configured to, or operable to support a means for receiving capability information indicating one or more capabilities of a UE associated with a unified TCI framework for a multi-TRP operation. The parameter manager 1030 is capable of, configured to, or operable to support a means for transmitting, based on the capability information, a control message indicating one or more parameters for the multi-TRP operation. The scheduling manager 1035 is capable of, configured to, or operable to support a means for transmitting at least one DCI that schedules a multi-TRP operation in accordance with the one or more parameters.

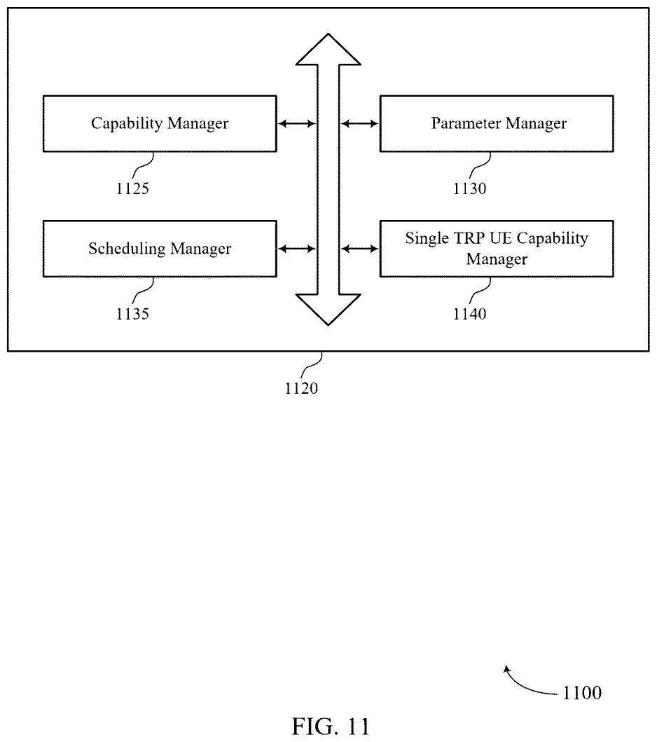

FIG. 11 shows a diagram 1100 of a communications manager 1120 that supports unified TCI state indication for single or multi-DCI based multi-TRP operation in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of unified TCI state indication for single or multi-DCI based multi-TRP operation as described herein. For example, the communications manager 1120 may include a capability manager 1125, a parameter manager 1130, a scheduling manager 1135, a single TRP UE capability manager 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The capability manager 1125 is capable of, configured to, or operable to support a means for receiving, from a UE, capability information indicating one or more capabilities of the UE associated with a unified TCI framework for a multi-DCI based multi-TRP operation. The parameter manager 1130 is capable of, configured to, or operable to support a means for transmitting, to the UE and based on the capability information, a control message indicating one or more parameters for the multi-DCI based multi-TRP operation. The scheduling manager 1135 is capable of, configured to, or operable to support a means for transmitting, to the UE, a set of multiple DCIs via a respective set of multiple TRPs, where the set of multiple DCIs schedule a multi-TRP operation with the respective set of multiple TRPs in accordance with the one or more parameters.

In some examples, the one or more capabilities include a capability of the UE to receive control signaling activating one joint unified TCI state per CC in a band. In some examples, at least one TCI codepoint is mapped to a joint unified TCI state per CORESET pool index.

In some examples, the one or more capabilities include a capability of the UE to receive control signaling activating one downlink unified TCI state and one uplink unified transmission configuration state per CC in a band. In some examples, at least one TCI codepoint is mapped to a downlink unified TCI state and an uplink unified TCI state per CORESET pool index.

In some examples, the one or more capabilities include a capability of the UE to receive control signaling indicating an activated joint unified TCI state is mapped to a CORESET pool index.

In some examples, the one or more capabilities include a capability of the UE to receive control signaling indicating an activated downlink unified TCI and an activated downlink unified TCI state is mapped to a CORESET pool index.

In some examples,, the one or more capabilities include a capability of the UE to support: common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

In some examples, the one or more capabilities include a capability of the UE to perform a shared channel communication using a joint unified TCI state associated with a CORESET pool index associated with a DCI that scheduled the shared channel communication.

In some examples, the one or more capabilities include a capability of the UE to receive a downlink shared channel communication using a downlink unified TCI state associated with a CORESET pool index associated with a DCI that scheduled the downlink shared channel communication.

In some examples, the one or more capabilities include a capability of the UE to transmit an uplink shared channel communication using an uplink unified TCI state associated with a CORESET pool index associated with a DCI that scheduled the uplink shared channel communication.

In some examples, the one or more capabilities include a capability of the UE to receive control signaling associating an uplink control channel resource with a joint unified TCI state. In some examples, the joint unified TCI state is associated with a CORESET pool index associated with one of the respective set of multiple TRPs.

In some examples, the one or more capabilities include a capability of the UE to receive control signaling associating an uplink control channel resource with an uplink unified TCI state. In some examples, the uplink unified TCI state is associated with a CORESET pool index associated with one of the respective set of multiple TRPs.

In some examples, the one or more capabilities include a capability of the UE to receive control signaling associating a configured grant resource with a joint unified TCI state. In some examples, the joint unified TCI state is associated with a CORESET pool index associated with one of the respective set of multiple TRPs.

In some examples, the one or more capabilities include a capability of the UE to receive control signaling associating a configured grant resource with an uplink unified TCI state. In some examples, the uplink unified TCI state is associated with a CORESET pool index associated with one of the respective set of multiple TRPs.

In some examples, the one or more capabilities include a capability of the UE to update at least one of a QCL assumption, a spatial transmission filter, or a pathloss reference signal for a joint unified TCI state in response to a beam failure recovery procedure for a beam corresponding to the joint unified TCI state.

In some examples, the one or more capabilities include a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

In some examples, the one or more capabilities include a capability of the UE to receive control signaling associating a joint unified TCI state or an uplink unified TCI state with an uplink power control configuration.

In some examples, the one or more capabilities include a capability of the UE to receive control signaling associating an uplink power control configuration per TRP.

In some examples, the one or more capabilities include a capability of the UE to receive control signaling activating a set of joint unified TCI states per physical cell identifier of a set of multiple physical cell identifiers. In some examples, at least one of the set of multiple physical cell identifiers is a serving cell.

In some examples, the one or more capabilities include a capability of the UE to receive control signaling activating a set of downlink unified TCI states and a set of uplink unified TCI states per physical cell identifier of a set of multiple physical cell identifiers. In some examples, at least one of the set of multiple physical cell identifiers is a serving cell.

In some examples, the single TRP UE capability manager 1140 is capable of, configured to, or operable to support a means for receiving second capability information indicating one or more second capabilities of the UE associated with the unified TCI framework for a single DCI based single-TRP operation, where the capability information indicates that one or more of the one or more capabilities of the UE are the same as corresponding capabilities of the one or more second capabilities indicated by the second capability information.

In some examples, the capability information includes a report that indicates the one or more capabilities of the UE in addition to one or more second capabilities of the UE associated with the unified TCI framework for a single DCI-based single TRP operation.

In some examples, the single TRP UE capability manager 1140 is capable of, configured to, or operable to support a means for receiving second capability information indicating one or more second capabilities of the UE associated with the unified TCI framework for a single DCI based single-TRP operation, where the capability information includes an indication that one or more third capabilities of the UE associated with the unified TCI framework for the multi-DCI based multi-TRP operation that are excluded from the capability information are the same as corresponding capabilities of the one or more second capabilities included in the second capability information.

In some examples, the one or more capabilities are specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

In some examples, the capability manager 1125 is capable of, configured to, or operable to support a means for receiving capability information indicating one or more capabilities of a UE associated with a unified TCI framework for a single DCI-based multi-TRP operation. The parameter manager 1130 is capable of, configured to, or operable to support a means for transmitting, based on the capability information, a control message indicating one or more parameters for the single DCI-based multi-TRP operation. The scheduling manager 1135 is capable of, configured to, or operable to support a means for transmitting DCI that schedules a multi-TRP operation in accordance with the one or more parameters.

In some examples, the one or more capabilities include a capability of the UE to receive control signaling that activates a TCI codepoint mapped to one or more unified joint TCI states, one or more unified downlink TCI states, or one or more unified uplink TCI states per CC in a band.

In some examples, the one or more capabilities include a second capability of the UE to update a first subset of unified TCI states of a set of activated unified TCI states based on the TCI codepoint being mapped to the first subset and maintain a second subset of unified TCI states of the set of activated unified TCI states based on the TCI codepoint lacking a mapping to the second subset.

In some examples, at least one TCI codepoints of a set of TCI codepoints including the TCI codepoint is mapped to two unified joint TCI states, two unified downlink TCI states, or two unified uplink TCI states.

In some examples, the one or more capabilities include a capability of the UE to receive control signaling that activates a TCI codepoint mapped to up to two unified joint TCI states, two unified downlink TCI states, or two unified uplink TCI states.

In some examples, the one or more capabilities include a capability of the UE to support common TCI state identifier update and activation for a set of CCs associated with the single DCI-based multi-TRP operation.

In some examples, the one or more capabilities include a capability of the UE to receive control signaling that indicates whether the UE is to apply, to an aperiodic CSI-RS resource or an aperiodic CSI-RS resource set: a first unified joint TCI state or a second unified joint TCI state indicated by a second control message; or a first unified downlink TCI state or a second unified downlink TCI state indicated by the second control message.

In some examples, the one or more capabilities include a capability of the UE to receive control signaling that indicates whether the UE is to apply, to a PUCCH resource or group: a first unified joint TCI state, a second unified joint TCI state, or both, indicated by a second control message; or a first unified uplink TCI state, a second unified uplink TCI state, or both, indicated by the second control message.

In some examples, the one or more capabilities include a capability of the UE to receive control signaling that indicates whether the UE is to apply, to a CORESET or group of CORESETs: a first unified joint TCI state, a second unified joint TCI state, both the first and second unified joint TCI states, or none of the first and second unified joint TCI states, indicated by a second control message; or a first unified downlink TCI state, a second unified downlink TCI state, both the first and second unified downlink TCI states, or none of the first and second unified downlink TCI states indicated by the second control message.

In some examples, the CORESET or group of CORESETs are associated with communications via a PDCCH with repetition, communications via a PDCCH without repetition, PDCCH-SFN communications, PDCCH-non SFN communications, or a combination thereof.

In some examples, the one or more capabilities include a capability of the UE to receive DCI associated with PDSCH reception scheduling that includes a field to select, for reception of a PDSCH, one or more unified joint TCI states or one or more unified downlink TCI states indicated by a TCI codepoint.

In some examples, the one or more capabilities include a capability of the UE to receive DCI associated with PUSCH transmission scheduling that includes a field to select, for transmission of a PUSCH, one or more unified joint TCI states or one or more unified uplink TCI states indicated by a TCI codepoint.

In some examples, the one or more capabilities include a capability of the UE to receive control signaling that indicates whether the UE is to apply, to a CG-PUSCH transmission: a first unified joint TCI state, a second unified joint TCI state, or both, indicated by a second control message; or a first unified uplink TCI state, a second unified uplink TCI state, or both, indicated by the second control message.

In some examples, the one or more capabilities include a capability of the UE to switch between performing the multi-TRP operation and performing a single-TRP operation.

In some examples, the one or more capabilities include a capability of the UE to determine a BFD reference signal set based on one or more unified joint TCI states or one or more unified downlink TCI states indicated for the single DCI-based multi-TRP operation.

In some examples, the one or more capabilities include a capability of the UE to perform per-TRP beam reset in association with BFR.

In some examples, the one or more capabilities include a capability of the UE to support per-TRP default power control parameters.

In some examples, the one or more capabilities include a capability of the UE to support an offset threshold that is specific to the single DCI-based multi-TRP operation, the offset threshold being a duration of time between a second control message that schedules a PDSCH or an aperiodic CSI-RS and a reception of the PDSCH or the aperiodic CSI-RS.

In some examples, the one or more capabilities include a capability of the UE to use a first indicated unified joint TCI state or a first indicated unified uplink TCI state as a default in association with a PUSCH transmission scheduled by DCI that lacks a field to select or indicate a unified TCI state.

In some examples, the one or more capabilities include a capability of the UE to receive control signaling that configures a PDSCH-CJT scheme associated with the single DCI-based multi-TRP operation.

In some examples, the one or more capabilities include a second capability of the UE that indicates a first quantity of unified joint TCI states or a second quantity of unified downlink TCI states supported by the UE for the PDSCH-CJT scheme.

In some examples, the one or more capabilities include a third capability of the UE to support QCL operation for the PDSCH-CJT scheme when two unified TCI states are indicated, where for the QCL operation: PDSCH DMRS ports are QCLed with downlink reference signals of the two unified TCI states with respect to a first QCL type; or the PDSCH DMRS ports are QCLed with the downlink reference signals with respect to the first QCL type except for a subset of QCL parameters associated with a second unified TCI state of the two unified TCI states; or the PDSCH DMRS ports are QCLed with downlink reference signals a first unified TCI state of the two unified TCI states with respect to the first QCL type and QCLed with downlink reference signals of the second unified TCI state with respect to a second QCL type.

In some examples, the capability manager 1125 is capable of, configured to, or operable to support a means for receiving second capability information indicating one or more second capabilities of the UE associated with a unified TCI framework for a single DCI-based single-TRP operation, where the capability information indicates that one or more of the one or more capabilities of the UE are the same as corresponding capabilities of the one or more second capabilities indicated by the second capability information.

In some examples, the capability information includes a report that indicates the one or more capabilities of the UE in addition to one or more second capabilities of the UE associated with the unified TCI framework for a single DCI-based single TRP operation.

In some examples, the capability manager 1125 is capable of, configured to, or operable to support a means for receiving second capability information indicating one or more second capabilities of the UE associated with a unified TCI framework for a single DCI-based single-TRP operation, where the capability information includes an indication that one or more third capabilities of the UE associated with the unified TCI framework for the single DCI-based multi-TRP operation that are excluded from the capability information are the same as corresponding capabilities of the one or more second capabilities included in the second capability information.

In some examples, the one or more capabilities are specific to the UE, a frequency band, a frequency band combination, a feature set associated with the UE, a feature set per CC, an FDD configuration, a TDD configuration, a sub-mmW range of frequencies (e.g., an FR1 band), a mmW range of frequencies (e.g., an FR2 band), or a combination thereof.

In some examples, the capability manager 1125 is capable of, configured to, or operable to support a means for receiving capability information indicating one or more capabilities of a UE associated with a unified TCI framework for a multi-TRP operation. The parameter manager 1130 is capable of, configured to, or operable to support a means for transmitting, based on the capability information, a control message indicating one or more parameters for the multi-TRP operation. The scheduling manager 1135 is capable of, configured to, or operable to support a means for transmitting at least one DCI that schedules a multi-TRP operation in accordance with the one or more parameters.

In some examples, the multi-TRP operation is a single DCI-based multi-TRP operation, where the one or more parameters are for the single DCI-based multi-TRP operation, and where the at least one DCI is a single DCI that schedules the multi-TRP operation.

In some examples, the multi-TRP operation is a multi DCI-based multi-TRP operation, where the one or more parameters are for the multi DCI-based multi-TRP operation, where the at least one DCI is a set of multiple DCIs received from a respective set of multiple TRPs, and where the set of multiple DCIs schedule the multi-TRP operation with the respective set of multiple TRPs.

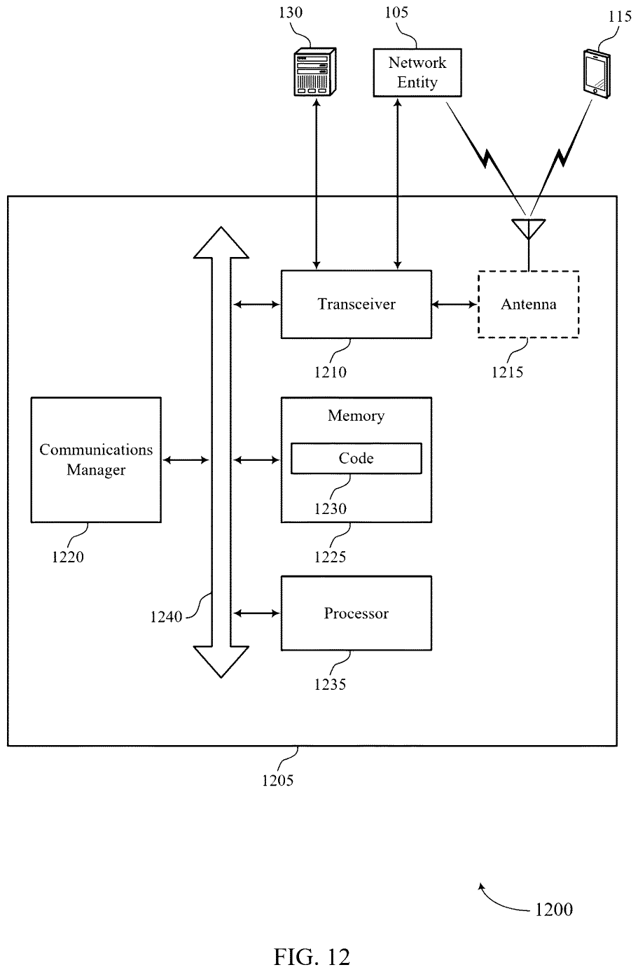

FIG. 12 shows a diagram of a system 1200 including a device 1205 that supports unified TCI state indication for single or multi-DCI based multi-TRP operation in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting unified TCI state indication for single or multi-DCI based multi-TRP operation). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for receiving, from a UE, capability information indicating one or more capabilities of the UE associated with a unified TCI framework for a multi-DCI based multi-TRP operation. The communications manager 1220 is capable of, configured to, or operable to support a means for transmitting, to the UE and based on the capability information, a control message indicating one or more parameters for the multi-DCI based multi-TRP operation. The communications manager 1220 is capable of, configured to, or operable to support a means for transmitting, to the UE, a set of multiple DCIs via a respective set of multiple TRPs, where the set of multiple DCIs schedule a multi-TRP operation with the respective set of multiple TRPs in accordance with the one or more parameters.

As another example, the communications manager 1220 is capable of, configured to, or operable to support a means for receiving capability information indicating one or more capabilities of a UE associated with a unified TCI framework for a single DCI-based multi-TRP operation. The communications manager 1220 is capable of, configured to, or operable to support a means for transmitting, based on the capability information, a control message indicating one or more parameters for the single DCI-based multi-TRP operation. The communications manager 1220 is capable of, configured to, or operable to support a means for transmitting DCI that schedules a multi-TRP operation in accordance with the one or more parameters.

As another example, the communications manager 1220 is capable of, configured to, or operable to support a means for receiving capability information indicating one or more capabilities of a UE associated with a unified TCI framework for a multi-TRP operation. The communications manager 1220 is capable of, configured to, or operable to support a means for transmitting, based on the capability information, a control message indicating one or more parameters for the multi-TRP operation. The communications manager 1220 is capable of, configured to, or operable to support a means for transmitting at least one DCI that schedules a multi-TRP operation in accordance with the one or more parameters.

By including or configuring the communications manager 1220 in accordance with examples as described herein, the device 1205 may support techniques for more efficient utilization of communication resources and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of unified TCI state indication for single or multi-DCI based multi-TRP operation as described herein, or the processor 1235 and the memory 1225 may be otherwise configured to perform or support such operations.

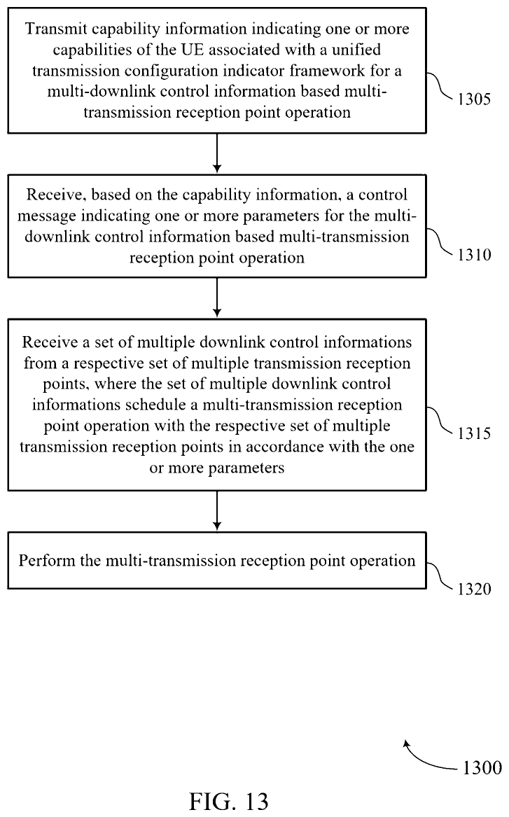

FIG. 13 shows a flowchart illustrating a method 1300 that supports unified TCI state indication for multi-DCI based multi-TRP operation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting capability information indicating one or more capabilities of the UE associated with a unified TCI framework for a multi-DCI based multi-TRP operation. The operations of block 1305 may be performed in accordance with examples as disclosed herein. In some examples, aspects of the operations of 1305 may be performed by a capability manager 725 as described with reference to FIG. 7.

At 1310, the method may include receiving, based on the capability information, a control message indicating one or more parameters for the multi-DCI based multi-TRP operation. The operations of block 1310 may be performed in accordance with examples as disclosed herein. In some examples, aspects of the operations of 1310 may be performed by a parameter manager 730 as described with reference to FIG. 7.

At 1315, the method may include receiving a set of multiple DCIs from a respective set of multiple TRPs, where the set of multiple DCIs schedule a multi-TRP operation with the respective set of multiple TRPs in accordance with the one or more parameters. The operations of block 1315 may be performed in accordance with examples as disclosed herein. In some examples, aspects of the operations of 1315 may be performed by a scheduling manager 735 as described with reference to FIG. 7.

At 1320, the method may include performing the multi-TRP operation. The operations of block 1320 may be performed in accordance with examples as disclosed herein. In some examples, aspects of the operations of 1320 may be performed by a multi-TRP operation manager 740 as described with reference to FIG. 7.

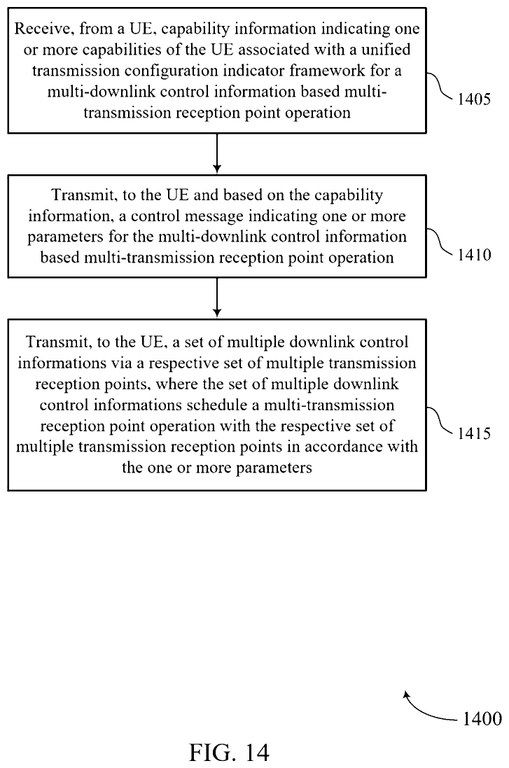

FIG. 14 shows a flowchart illustrating a method 1400 that supports unified TCI state indication for multi-DCI based multi-TRP operation in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving, from a UE, capability information indicating one or more capabilities of the UE associated with a unified TCI framework for a multi-DCI based multi-TRP operation. The operations of block 1405 may be performed in accordance with examples as disclosed herein. In some examples, aspects of the operations of 1405 may be performed by a capability manager 1125 as described with reference to FIG. 11.

At 1410, the method may include transmitting, to the UE and based on the capability information, a control message indicating one or more parameters for the multi-DCI based multi-TRP operation. The operations of block 1410 may be performed in accordance with examples as disclosed herein. In some examples, aspects of the operations of 1410 may be performed by a parameter manager 1130 as described with reference to FIG. 11.

At 1415, the method may include transmitting, to the UE, a set of multiple DCIs via a respective set of multiple TRPs, where the set of multiple DCIs schedule a multi-TRP operation with the respective set of multiple TRPs in accordance with the one or more parameters. The operations of block 1415 may be performed in accordance with examples as disclosed herein. In some examples, aspects of the operations of 1415 may be performed by a scheduling manager 1135 as described with reference to FIG. 11.

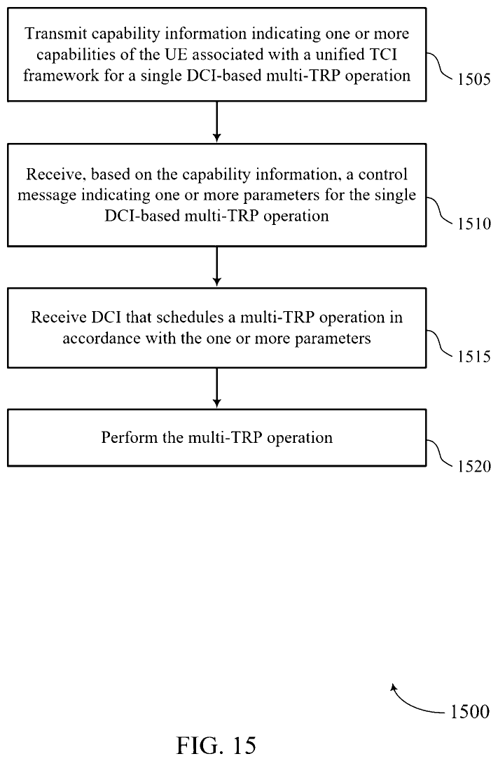

FIG. 15 shows a flowchart illustrating a method 1500 that supports unified TCI framework for single DCI-based multi-TRP operation in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include transmitting capability information indicating one or more capabilities of the UE associated with a unified TCI framework for a single DCI-based multi-TRP operation. The operations of block 1505 may be performed in accordance with examples as disclosed herein. In some examples, aspects of the operations of 1505 may be performed by a capability manager 725 as described with reference to FIG. 7.

At 1510, the method may include receiving, based on the capability information, a control message indicating one or more parameters for the single DCI-based multi-TRP operation. The operations of block 1510 may be performed in accordance with examples as disclosed herein. In some examples, aspects of the operations of 1510 may be performed by a parameter manager 730 as described with reference to FIG. 7.

At 1515, the method may include receiving DCI that schedules a multi-TRP operation in accordance with the one or more parameters. The operations of block 1515 may be performed in accordance with examples as disclosed herein. In some examples, aspects of the operations of 1515 may be performed by a scheduling manager 735 as described with reference to FIG. 7.

At 1520, the method may include performing the multi-TRP operation. The operations of block 1520 may be performed in accordance with examples as disclosed herein. In some examples, aspects of the operations of 1520 may be performed by a multi-TRP operation manager 740 as described with reference to FIG. 7.

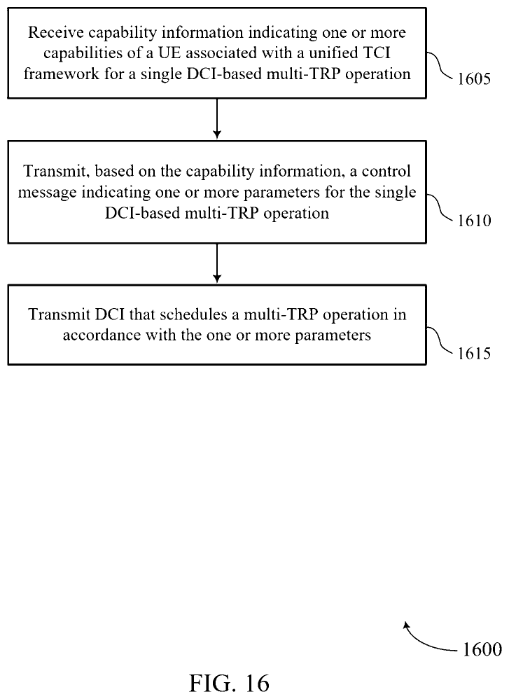

FIG. 16 shows a flowchart illustrating a method 1600 that supports unified TCI framework for single DCI-based multi-TRP operation in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include receiving capability information indicating one or more capabilities of a UE associated with a unified TCI framework for a single DCI-based multi-TRP operation. The operations of block 1605 may be performed in accordance with examples as disclosed herein. In some examples, aspects of the operations of 1605 may be performed by a capability manager 1125 as described with reference to FIG. 11.

At 1610, the method may include transmitting, based on the capability information, a control message indicating one or more parameters for the single DCI-based multi-TRP operation. The operations of block 1610 may be performed in accordance with examples as disclosed herein. In some examples, aspects of the operations of 1610 may be performed by a parameter manager 1130 as described with reference to FIG. 11.

At 1615, the method may include transmitting DCI that schedules a multi-TRP operation in accordance with the one or more parameters. The operations of block 1615 may be performed in accordance with examples as disclosed herein. In some examples, aspects of the operations of 1615 may be performed by a scheduling manager 1135 as described with reference to FIG. 11.

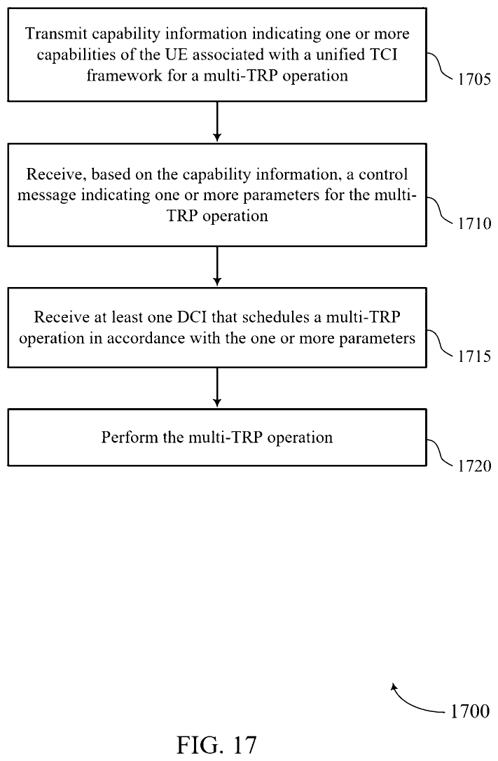

FIG. 17 shows a flowchart illustrating a method 1700 that supports unified TCI framework for single or multi-DCI-based multi-TRP operation in accordance with aspects of the present disclosure. The operations of the method 1700 may be implemented by a UE or its components as described herein. For example, the operations of the method 1700 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1705, the method may include transmitting capability information indicating one or more capabilities of the UE associated with a unified TCI framework for a multi-TRP operation. The operations of block 1705 may be performed in accordance with examples as disclosed herein. In some examples, aspects of the operations of 1705 may be performed by a capability manager 725 as described with reference to FIG. 7.

At 1710, the method may include receiving, based on the capability information, a control message indicating one or more parameters for the multi-TRP operation. The operations of block 1710 may be performed in accordance with examples as disclosed herein. In some examples, aspects of the operations of 1710 may be performed by a parameter manager 730 as described with reference to FIG. 7.

At 1715, the method may include receiving at least one DCI that schedules a multi-TRP operation in accordance with the one or more parameters. The operations of block 1715 may be performed in accordance with examples as disclosed herein. In some examples, aspects of the operations of 1715 may be performed by a scheduling manager 735 as described with reference to FIG. 7.

At 1720, the method may include performing the multi-TRP operation. The operations of block 1720 may be performed in accordance with examples as disclosed herein. In some examples, aspects of the operations of 1720 may be performed by a multi-TRP operation manager 740 as described with reference to FIG. 7.

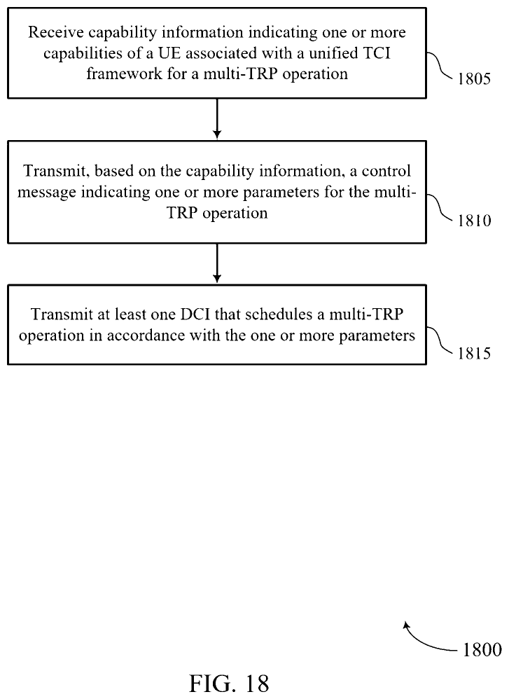

FIG. 18 shows a flowchart illustrating a method 1800 that supports unified TCI framework for single or multi-DCI based multi-TRP operation in accordance with aspects of the present disclosure. The operations of the method 1800 may be implemented by a network entity or its components as described herein. For example, the operations of the method 1800 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1805, the method may include receiving capability information indicating one or more capabilities of a UE associated with a unified TCI framework for a multi-TRP operation. The operations of block 1805 may be performed in accordance with examples as disclosed herein. In some examples, aspects of the operations of 1805 may be performed by a capability manager 1125 as described with reference to FIG. 11.

At 1810, the method may include transmitting, based on the capability information, a control message indicating one or more parameters for the multi-TRP operation. The operations of block 1810 may be performed in accordance with examples as disclosed herein. In some examples, aspects of the operations of 1810 may be performed by a parameter manager 1130 as described with reference to FIG. 11.

At 1815, the method may include transmitting at least one DCI that schedules a multi-TRP operation in accordance with the one or more parameters. The operations of block 1815 may be performed in accordance with examples as disclosed herein. In some examples, aspects of the operations of 1815 may be performed by a scheduling manager 1135 as described with reference to FIG. 11.

The following provides an overview of aspects of the present disclosure:

Aspect 1: A method for wireless communications at a UE, comprising: transmitting capability information indicating one or more capabilities of the UE associated with a unified TCI framework for a multi-TRP operation; receiving, based at least in part on the capability information, a control message indicating one or more parameters for based multi-TRP operation; receiving at least one DCI that schedules a multi-TRP operation in accordance with the one or more parameters; and performing the multi-TRP operation.

Aspect 2: The method of aspect 1, wherein the multi-DCI operation is a multi DCI-based multi-DCI operation, wherein the one or more parameters are for the multi DCI-based multi-DCI operation, wherein the at least one DCI is a plurality of DCIs received from a respective plurality of DCIs, and wherein the plurality of DCIs schedule the multi-DCI operation with the respective plurality of DCIs.

Aspect 3: The method of aspect 2, wherein the one or more capabilities comprise a capability of the UE to receive control signaling activating one joint unified TCI state per CC in a band, at least one TCI codepoint is mapped to a joint unified TCI state per CORESET pool index.

Aspect 4: The method of any of aspects 1 through 3, wherein the one or more capabilities comprise a capability of the UE to receive control signaling activating one downlink unified TCI state and one uplink unified transmission configuration state per CC in a band, at least one TCI codepoint is mapped to a downlink unified TCI state and an uplink unified TCI state per CORESET pool index.

Aspect 5: The method of any of aspects 1 through 4, wherein the one or more capabilities comprise a capability of the UE to receive control signaling indicating an activated joint unified TCI state is mapped to a CORESET pool index.

Aspect 6: The method of any of aspects 1 through 5, wherein the one or more capabilities comprise a capability of the UE to receive control signaling indicating an activated downlink unified TCI and an activated downlink unified TCI state is mapped to a CORESET pool index.

Aspect 7: The method of any of aspects 1 through 6, wherein the one or more capabilities comprise a capability of the UE to support common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

Aspect 8: The method of any of aspects 1 through 7, wherein the one or more capabilities comprise a capability of the UE to perform a shared channel communication using a joint unified TCI state associated with a CORESET pool index associated with a DCI that scheduled the shared channel communication.

Aspect 9: The method of any of aspects 1 through 8, wherein the one or more capabilities comprise a capability of the UE to receive a downlink shared channel communication using a downlink unified TCI state associated with a CORESET pool index associated with a DCI that scheduled the downlink shared channel communication.

Aspect 10: The method of any of aspects 1 through 9, wherein the one or more capabilities comprise a capability of the UE to transmit an uplink shared channel communication using an uplink unified TCI state associated with a CORESET pool index associated with a DCI that scheduled the uplink shared channel communication.

Aspect 11: The method of any of aspects 1 through 10, wherein the one or more capabilities comprise a capability of the UE to receive control signaling associating an uplink control channel resource with a joint unified TCI state, the joint unified TCI state is associated with a CORESET pool index associated with one of the respective plurality of TRPs.

Aspect 12: The method of any of aspects 2 through 11, wherein the one or more capabilities comprise a capability of the UE to receive control signaling associating an uplink control channel resource with an uplink unified TCI state, the uplink unified TCI state is associated with a CORESET pool index associated with one of the respective plurality of TRPs.

Aspect 13: The method of any of aspects 2 through 12, wherein the one or more capabilities comprise a capability of the UE to receive control signaling associating a configured grant resource with a joint unified TCI state, the joint unified TCI state is associated with a CORESET pool index associated with one of the respective plurality of TRPs.

Aspect 14: The method of any of aspects 2 through 13, wherein the one or more capabilities comprise a capability of the UE to receive control signaling associating a configured grant resource with an uplink unified TCI state, the uplink unified TCI state is associated with a CORESET pool index associated with one of the respective plurality of TRPs.

Aspect 15: The method of any of aspects 2 through 14, wherein the one or more capabilities comprise a capability of the UE to update at least one of a QCL assumption, a spatial transmission filter, or a pathloss reference signal for a joint unified TCI state in response to a beam failure recovery procedure for a beam corresponding to the joint unified TCI state.

Aspect 16: The method of any of aspects 2 through 15, wherein the one or more capabilities comprise a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

Aspect 17: The method of any of aspects 2 through 16, wherein the one or more capabilities comprise a capability of the UE to receive control signaling associating a joint unified TCI state or an uplink unified TCI state with an uplink power control configuration.

Aspect 18: The method of any of aspects 2 through 17, wherein the one or more capabilities comprise a capability of the UE to receive control signaling associating an uplink power control configuration per TRP.

Aspect 19: The method of any of aspects 2 through 18, wherein the one or more capabilities comprise a capability of the UE to receive control signaling activating a set of joint unified TCI states per physical cell identifier of a plurality of physical cell identifiers, at least one of the plurality of physical cell identifiers is a serving cell.

Aspect 20: The method of any of aspects 2 through 19, wherein the one or more capabilities comprise a capability of the UE to receive control signaling activating a set of downlink unified TCI states and a set of uplink unified TCI states per physical cell identifier of a plurality of physical cell identifiers, at least one of the plurality of physical cell identifiers is a serving cell.

Aspect 21: The method of any of aspects 2 through 20, further comprising: transmitting second capability information indicating one or more second capabilities of the UE associated with the unified TCI framework for a single DCI based single-TRP operation, wherein the capability information indicates that one or more of the one or more capabilities of the UE are the same as corresponding capabilities of the one or more second capabilities indicated by the second capability information.

Aspect 22: The method of any of aspects 2 through 21, wherein the capability information comprises a report that indicates the one or more capabilities of the UE in addition to one or more second capabilities of the UE associated with the unified TCI framework for a single DCI-based single TRP operation.

Aspect 23: The method of any of aspects 2 through 21, further comprising: transmitting second capability information indicating one or more second capabilities of the UE associated with the unified TCI framework for a single DCI based single-TRP operation, wherein the capability information comprises an indication that one or more third capabilities of the UE associated with the unified TCI framework for the multi-DCI based multi-TRP operation that are excluded from the capability information are the same as corresponding capabilities of the one or more second capabilities included in the second capability information.

Aspect 24: The method of any of aspects 2 through 21, wherein the one or more capabilities are specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

Aspect 25: The method of aspect 1, wherein the multi-TRP operation is a single DCI-based multi-TRP operation, wherein the one or more parameters are for the single DCI-based multi-TRP operation, and wherein the at least one DCI is a single DCI that schedules the multi-TRP operation.

Aspect 26: The method of aspect 25, wherein the one or more capabilities comprise a capability of the UE to receive control signaling that activates a TCI codepoint mapped to one or more unified joint TCI states, one or more unified downlink TCI states, or one or more unified uplink TCI states per CC in a band.

Aspect 27: The method of aspect 26, wherein the one or more capabilities comprise a second capability of the UE to update a first subset of unified TCI states of a set of activated unified TCI states based at least in part on the TCI codepoint being mapped to the first subset; and maintain a second subset of unified TCI states of the set of activated unified TCI states based at least in part on the TCI codepoint lacking a mapping to the second subset.

Aspect 28: The method of any of aspects 25 through 26, wherein at least one TCI codepoints of a set of TCI codepoints comprising the TCI codepoint is mapped to two unified joint TCI states, two unified downlink TCI states, or two unified uplink TCI states.

Aspect 29: The method of any of aspects 25 through 29, wherein the one or more capabilities comprise a capability of the UE to receive control signaling that activates a TCI codepoint mapped to up to two unified joint TCI states, two unified downlink TCI states, or two unified uplink TCI states.

Aspect 30: The method of any of aspects 25 through 29, wherein the one or more capabilities comprise a capability of the UE to support common TCI state identifier update and activation for a set of CCs associated with the single DCI-based multi-TRP operation.

Aspect 31: The method of any of aspects 25 through 30, wherein the one or more capabilities comprise a capability of the UE to receive control signaling that indicates whether the UE is to apply, to an aperiodic CSI-RS resource or an aperiodic CSI-RS resource set: a first unified joint TCI state or a second unified joint TCI state indicated by a second control message; or a first unified downlink TCI state or a second unified downlink TCI state indicated by the second control message.

Aspect 32: The method of any of aspects 25 through 31, wherein the one or more capabilities comprise a capability of the UE to receive control signaling that indicates whether the UE is to apply, to a PUCCH resource or group: a first unified joint TCI state, a second unified joint TCI state, or both, indicated by a second control message; or a first unified uplink TCI state, a second unified uplink TCI state, or both, indicated by the second control message.

Aspect 33: The method of any of aspects 25 through 33, wherein the one or more capabilities comprise a capability of the UE to receive control signaling that indicates whether the UE is to apply, to a CORESET or group of CORESETs: a first unified joint TCI state, a second unified joint TCI state, or both, indicated by a second control message; or a first unified uplink TCI state, a second unified uplink TCI state, or both, indicated by the second control message.

Aspect 34: The method of aspect 33, wherein the CORESET or group of CORESETs are associated with communications via a PDCCH with repetition, communications via a PDCCH without repetition, PDCCH-SFN communications, PDCCH-non SFN communications, or a combination thereof.

Aspect 35: The method of any of aspects 25 through 35, wherein the one or more capabilities comprise a capability of the UE to receive DCI associated with PDSCH reception scheduling that includes a field to select, for reception of a PDSCH, one or more unified joint TCI states or one or more unified downlink TCI states indicated by a TCI codepoint.

Aspect 36: The method of any of aspects 25 through 35, wherein the one or more capabilities comprise a capability of the UE to receive DCI associated with PUSCH reception scheduling that includes a field to select, for transmission of a PUSCH, one or more unified joint TCI states or one or more unified uplink TCI states indicated by a TCI codepoint.

Aspect 37: The method of any of aspects 25 through 36, wherein the one or more capabilities comprise a capability of the UE to receive control signaling that indicates whether the UE is to apply, to a CG-PUSCH transmission: a first unified joint TCI state, a second unified joint TCI state, or both, indicated by a second control message; or a first unified uplink TCI state, a second unified uplink TCI state, or both, indicated by the second control message.

Aspect 38: The method of any of aspects 25 through 37, wherein the one or more capabilities comprise a capability of the UE to switch between performing the multi-TRP operation and performing a single-TRP operation.

Aspect 39: The method of any of aspects 25 through 38, wherein the one or more capabilities comprise a capability of the UE to determine a BFD reference signal set based at least in part on one or more unified joint TCI states or one or more unified downlink TCI states indicated for the single DCI-based multi-TRP operation.

Aspect 40: The method of any of aspects 25 through 39, wherein the one or more capabilities comprise a capability of the UE to perform per-TRP beam reset in association with BFR.

Aspect 41: The method of any of aspects 25 through 40, wherein the one or more capabilities comprise a capability of the UE to support per-TRP default power control parameters.

Aspect 42: The method of any of aspects 25 through 41, wherein the one or more capabilities comprise a capability of the UE to support an offset threshold that is specific to the single DCI-based multi-TRP operation, the offset threshold being a duration of time between a second control message that schedules a PDSCH or an aperiodic CSI-RS and a reception of the PDSCH or the aperiodic CSI-RS.

Aspect 43: The method of any of aspects 25 through 42, wherein the one or more capabilities comprise a capability of the UE to use a first indicated unified joint TCI state or a first indicated unified uplink TCI state as a default in association with a PUSCH transmission scheduled by DCI that lacks a field to select or indicate a unified TCI state.

Aspect 44: The method of any of aspects 25 through 43, wherein the one or more capabilities comprise a capability of the UE to receive control signaling that configures a PDSCH-CJT scheme associated with the single DCI-based multi-TRP operation.

Aspect 45: The method of aspect 44, wherein the one or more capabilities comprise a second capability of the UE that indicates a first quantity of unified joint TCI states or a second quantity of unified downlink TCI states supported by the UE for the PDSCH-CJT scheme.

Aspect 46: The method of aspect 45, wherein the one or more capabilities comprise a third capability of the UE to support QCL operation for the PDSCH-CJT scheme when two unified TCI states are indicated, wherein for the QCL operation: PDSCH DMRS ports are QCLed with downlink reference signals of the two unified TCI states with respect to a first QCL type; or the PDSCH DMRS ports are QCLed with the downlink reference signals with respect to the first QCL type except for a subset of QCL parameters associated with a second unified TCI state of the two unified TCI states; or the PDSCH DMRS ports are QCLed with downlink reference signals a first unified TCI state of the two unified TCI states with respect to the first QCL type and QCLed with downlink reference signals of the second unified TCI state with respect to a second QCL type.

Aspect 47: The method of any of aspects 25 through 46, further comprising: transmitting second capability information indicating one or more second capabilities of the UE associated with a unified TCI framework for a single DCI-based single-TRP operation, wherein the capability information indicates that one or more of the one or more capabilities of the UE are the same as corresponding capabilities of the one or more second capabilities indicated by the second capability information.

Aspect 48: The method of any of aspects 25 through 47, wherein the capability information comprises a report that indicates the one or more capabilities of the UE in addition to one or more second capabilities of the UE associated with the unified TCI framework for a single DCI-based single TRP operation.

Aspect 49: The method of any of aspects 25 through 48, further comprising: transmitting second capability information indicating one or more second capabilities of the UE associated with a unified TCI framework for a single DCI-based single-TRP operation, wherein the capability information comprises an indication that one or more third capabilities of the UE associated with the unified TCI framework for the single DCI-based multi-TRP operation that are excluded from the capability information are the same as corresponding capabilities of the one or more second capabilities included in the second capability information.

Aspect 50: The method of any of aspects 25 through 4953, wherein the one or more capabilities are specific to the UE, a frequency band, a frequency band combination, a feature set associated with the UE, a feature set per CC, an FDD configuration, a TDD configuration, a sub-mmW range of frequencies, a mmW range of frequencies, or a combination thereof.

Aspect 51: A method for wireless communications at a network entity, comprising: receiving, from a UE, capability information indicating one or more capabilities of the UE associated with a unified TCI framework for a multi-TRP operation; transmitting, to the UE and based at least in part on the capability information, a control message indicating one or more parameters for the multi-TRP operation; and transmitting, to the UE, a at least one DCI that schedules a multi-TRP operation in accordance with the one or more parameters.

Aspect 52: The method of aspect 51, wherein the multi-DCI operation is a multi DCI-based multi-DCI operation, wherein the one or more parameters are for the multi DCI-based multi-DCI operation, wherein the at least one DCI is a plurality of DCIs transmitted via a respective plurality of DCIs, and wherein the plurality of DCIs schedule the multi-DCI operation with the respective plurality of DCIs.

Aspect 53: The method of aspect 51, wherein the one or more capabilities comprise a capability of the UE to receive control signaling activating one joint unified TCI state per CC in a band, and at least one TCI codepoint is mapped to a joint unified TCI state per CORESET pool index.

Aspect 54: The method of any of aspects 5152 through 53, wherein the one or more capabilities comprise a capability of the UE to receive control signaling activating one downlink unified TCI state and one uplink unified transmission configuration state per CC in a band, and at least one TCI codepoint is mapped to a downlink unified TCI state and an uplink unified TCI state per CORESET pool index.

Aspect 55: The method of any of aspects 52 through 54, wherein the one or more capabilities comprise a capability of the UE to receive control signaling indicating an activated joint unified TCI state is mapped to a CORESET pool index.

Aspect 56: The method of any of aspects 52 through 55, wherein the one or more capabilities comprise a capability of the UE to receive control signaling indicating an activated downlink unified TCI and an activated downlink unified TCI state is mapped to a CORESET pool index.

Aspect 57: The method of any of aspects 52 through 56, wherein the one or more capabilities comprise a capability of the UE to support common TCI state identifier activation for a set of CCs operating in the multi-DCI based multi-TRP operation; common TCI state identifier activation for a set of CCs that include a first subset of CCs operating in the multi-DCI based multi-TRP operation and a second subset of CCs operating in a single TRP operation; common TCI state identifier activation for a set of CCs that include a first subset of CCs operating in the multi-DCI based multi-TRP operation and a second subset of CCs operating in a single-DCI based multi-TRP operation; common TCI state identifier activation for a set of CCs that include a first subset of CCs operating in the multi-DCI based multi-TRP operation, a second subset of CCs operating in a single-DCI based multi-TRP operation, and a third subset of CCs operating in a single TRP operation; or a combination thereof.

Aspect 58: The method of any of aspects 52 through 57, wherein the one or more capabilities comprise a capability of the UE to perform a shared channel communication using a joint unified TCI state associated with a CORESET pool index associated with a DCI that scheduled the shared channel communication.

Aspect 59: The method of any of aspects 52 through 58, wherein the one or more capabilities comprise a capability of the UE to receive a downlink shared channel communication using a downlink unified TCI state associated with a CORESET pool index associated with a DCI that scheduled the downlink shared channel communication.

Aspect 60: The method of any of aspects 52 through 59, wherein the one or more capabilities comprise a capability of the UE to transmit an uplink shared channel communication using an uplink unified TCI state associated with a CORESET pool index associated with a DCI that scheduled the uplink shared channel communication.

Aspect 61: The method of any of aspects 52 through 60, wherein the one or more capabilities comprise a capability of the UE to receive control signaling associating an uplink control channel resource with a joint unified TCI state, and the joint unified TCI state is associated with a CORESET pool index associated with one of the respective plurality of TRPs.

Aspect 62: The method of any of aspects 52 through 61, wherein the one or more capabilities comprise a capability of the UE to receive control signaling associating an uplink control channel resource with an uplink unified TCI state, and the uplink unified TCI state is associated with a CORESET pool index associated with one of the respective plurality of TRPs.

Aspect 63: The method of any of aspects 52 through 62, wherein the one or more capabilities comprise a capability of the UE to receive control signaling associating a configured grant resource with a joint unified TCI state, and the joint unified TCI state is associated with a CORESET pool index associated with one of the respective plurality of TRPs.

Aspect 64: The method of any of aspects 52 through 63, wherein the one or more capabilities comprise a capability of the UE to receive control signaling associating a configured grant resource with an uplink unified TCI state, and the uplink unified TCI state is associated with a CORESET pool index associated with one of the respective plurality of TRPs.

Aspect 65: The method of any of aspects 52 through 64, wherein the one or more capabilities comprise a capability of the UE to update at least one of a QCL assumption, a spatial transmission filter, or a pathloss reference signal for a joint unified TCI state in response to a beam failure recovery procedure for a beam corresponding to the joint unified TCI state.

Aspect 66: The method of any of aspects 52 through 65, wherein the one or more capabilities comprise a capability of the UE to update at least one of a QCL assumption, a spatial transmission filter, or a pathloss reference signal for an uplink unified TCI state or a downlink unified TCI state in response to a beam failure recovery procedure for a beam corresponding to the uplink unified TCI state or the downlink unified TCI state.

Aspect 67: The method of any of aspects 52 through 66, wherein the one or more capabilities comprise a capability of the UE to receive control signaling associating a joint unified TCI state or an uplink unified TCI state with an uplink power control configuration.

Aspect 68: The method of any of aspects 52 through 67, wherein the one or more capabilities comprise a capability of the UE to receive control signaling associating an uplink power control configuration per TRP.

Aspect 69: The method of any of aspects 52 through 68, wherein the one or more capabilities comprise a capability of the UE to receive control signaling activating a set of joint unified TCI states per physical cell identifier of a plurality of physical cell identifiers, and at least one of the plurality of physical cell identifiers is a serving cell.

Aspect 70: The method of any of aspects 52 through 69, wherein the one or more capabilities comprise a capability of the UE to receive control signaling activating a set of downlink unified TCI states and a set of uplink unified TCI states per physical cell identifier of a plurality of physical cell identifiers, and at least one of the plurality of physical cell identifiers is a serving cell.

Aspect 71: The method of any of aspects 52 through 70, further comprising: receiving second capability information indicating one or more second capabilities of the UE associated with the unified TCI framework for a single DCI based single-TRP operation, wherein the capability information indicates that one or more of the one or more capabilities of the UE are the same as corresponding capabilities of the one or more second capabilities indicated by the second capability information.

Aspect 72: The method of any of aspects 52 through 70, wherein the capability information comprises a report that indicates the one or more capabilities of the UE in addition to one or more second capabilities of the UE associated with the unified TCI framework for a single DCI-based single TRP operation.

Aspect 73: The method of any of aspects 52 through 70, further comprising: receiving second capability information indicating one or more second capabilities of the UE associated with the unified TCI framework for a single DCI based single-TRP operation, wherein the capability information comprises an indication that one or more third capabilities of the UE associated with the unified TCI framework for the multi-DCI based multi-TRP operation that are excluded from the capability information are the same as corresponding capabilities of the one or more second capabilities included in the second capability information.

Aspect 74: The method of any of aspects 52 through 73, wherein the one or more capabilities are specific to the UE, a frequency band, a frequency band combination, a feature set associated with the UE, a feature set per CC, a frequency division duplexing configuration, a time division duplexing configuration, a sub-millimeter wave range of frequencies, a millimeter wave range of frequencies, or a combination thereof.

Aspect 75: The method of aspect 51, wherein the multi-TRP operation is a single DCI-based multi-TRP operation, wherein the one or more parameters are for the single DCI-based multi-TRP operation, and wherein the at least one DCI is a single DCI that schedules the multi-TRP operation.

Aspect 76: The method of aspect 75, wherein the one or more capabilities comprise a capability of the UE to receive control signaling that activates a TCI codepoint mapped to one or more unified joint TCI states, one or more unified downlink TCI states, or one or more unified uplink TCI states per CC in a band.

Aspect 77: The method of aspect 76, wherein the one or more capabilities comprise a second capability of the UE to update a first subset of unified TCI states of a set of activated unified TCI states based at least in part on the TCI codepoint being mapped to the first subset; and maintain a second subset of unified TCI states of the set of activated unified TCI states based at least in part on the TCI codepoint lacking a mapping to the second subset.

Aspect 78: The method of any of aspects 75 through 77, wherein at least one TCI codepoints of a set of TCI codepoints comprising the TCI codepoint is mapped to two unified joint TCI states, two unified downlink TCI states, or two unified uplink TCI states.

Aspect 79: The method of any of aspects 77 through 78, wherein the one or more capabilities comprise a capability of the UE to receive control signaling that activates a TCI codepoint mapped to up to two unified joint TCI states, two unified downlink TCI states, or two unified uplink TCI states.

Aspect 80: The method of any of aspects 75 through 59, wherein the one or more capabilities comprise a capability of the UE to support common TCI state identifier update and activation for a set of CCs associated with the single DCI-based multi-TRP operation.

Aspect 81: The method of any of aspects 75 through 80, wherein the one or more capabilities comprise a capability of the UE to receive control signaling that indicates whether the UE is to apply, to an aperiodic CSI-RS resource or an aperiodic CSI-RS resource set: a first unified joint TCI state or a second unified joint TCI state indicated by a second control message; or a first unified downlink TCI state or a second unified downlink TCI state indicated by the second control message.

Aspect 82: The method of any of aspects 75 through 81, wherein the one or more capabilities comprise a capability of the UE to receive control signaling that indicates whether the UE is to apply, to a PUCCH resource or group: a first unified joint TCI state, a second unified joint TCI state, or both, indicated by a second control message; or a first unified uplink TCI state, a second unified uplink TCI state, or both, indicated by the second control message.

Aspect 83: The method of any of aspects 75 through 82, wherein the one or more capabilities comprise a capability of the UE to receive control signaling that indicates whether the UE is to apply, to a CORESET or group of CORESETs: a first unified joint TCI state, a second unified joint TCI state, or both, indicated by a second control message; or a first unified uplink TCI state, a second unified uplink TCI state, or both, indicated by the second control message.

Aspect 84: The method of aspect 83, wherein the CORESET or group of CORESETs are associated with communications via a PDCCH with repetition, communications via a PDCCH without repetition, PDCCH-SFN communications, PDCCH-non SFN communications, or a combination thereof.

Aspect 85: The method of any of aspects 75 through 84, wherein the one or more capabilities comprise a capability of the UE to receive DCI associated with PDSCH reception scheduling that includes a field to select, for reception of a PDSCH, one or more unified joint TCI states or one or more unified downlink TCI states indicated by a TCI codepoint.

Aspect 86: The method of any of aspects 75 through 85, wherein the one or more capabilities comprise a capability of the UE to receive DCI associated with PUSCH reception scheduling that includes a field to select, for transmission of a PUSCH, one or more unified joint TCI states or one or more unified uplink TCI states indicated by a TCI codepoint.

Aspect 87: The method of any of aspects 75 through 86, wherein the one or more capabilities comprise a capability of the UE to receive control signaling that indicates whether the UE is to apply, to a CG-PUSCH transmission: a first unified joint TCI state, a second unified joint TCI state, or both, indicated by a second control message; or a first unified uplink TCI state, a second unified uplink TCI state, or both, indicated by the second control message.

Aspect 88: The method of any of aspects 75 through 87, wherein the one or more capabilities comprise a capability of the UE to switch between performing the multi-TRP operation and performing a single-TRP operation.

Aspect 89: The method of any of aspects 75 through 88, wherein the one or more capabilities comprise a capability of the UE to determine a BFD reference signal set based at least in part on one or more unified joint TCI states or one or more unified downlink TCI states indicated for the single DCI-based multi-TRP operation.

Aspect 90: The method of any of aspects 75 through 89, wherein the one or more capabilities comprise a capability of the UE to perform per-TRP beam reset in association with BFR.

Aspect 91: The method of any of aspects 75 through 90, wherein the one or more capabilities comprise a capability of the UE to support per-TRP default power control parameters.

Aspect 92: The method of any of aspects 75 through 91, wherein the one or more capabilities comprise a capability of the UE to support an offset threshold that is specific to the single DCI-based multi-TRP operation, the offset threshold being a duration of time between a second control message that schedules a PDSCH or an aperiodic CSI-RS and a reception of the PDSCH or the aperiodic CSI-RS.

Aspect 93: The method of any of aspects 75 through 92, wherein the one or more capabilities comprise a capability of the UE to use a first indicated unified joint TCI state or a first indicated unified uplink TCI state as a default in association with a PUSCH transmission scheduled by DCI that lacks a field to select or indicate a unified TCI state.

Aspect 94: The method of any of aspects 75 through 93, wherein the one or more capabilities comprise a capability of the UE to receive control signaling that configures a PDSCH-CJT scheme associated with the single DCI-based multi-TRP operation.

Aspect 95: The method of aspect 94, wherein the one or more capabilities comprise a second capability of the UE that indicates a first quantity of unified joint TCI states or a second quantity of unified downlink TCI states supported by the UE for the PDSCH-CJT scheme.

Aspect 96: The method of aspect 95, wherein the one or more capabilities comprise a third capability of the UE to support QCL operation for the PDSCH-CJT scheme when two unified TCI states are indicated, wherein for the QCL operation: PDSCH DMRS ports are QCLed with downlink reference signals of the two unified TCI states with respect to a first QCL type; or the PDSCH DMRS ports are QCLed with the downlink reference signals with respect to the first QCL type except for a subset of QCL parameters associated with a second unified TCI state of the two unified TCI states; or the PDSCH DMRS ports are QCLed with downlink reference signals a first unified TCI state of the two unified TCI states with respect to the first QCL type and QCLed with downlink reference signals of the second unified TCI state with respect to a second QCL type.

Aspect 97: The method of any of aspects 75 through 96, further comprising: receiving second capability information indicating one or more second capabilities of the UE associated with a unified TCI framework for a single DCI-based single-TRP operation, wherein the capability information indicates that one or more of the one or more capabilities of the UE are the same as corresponding capabilities of the one or more second capabilities indicated by the second capability information.

Aspect 98: The method of any of aspects 75 through 97, wherein the capability information comprises a report that indicates the one or more capabilities of the UE in addition to one or more second capabilities of the UE associated with the unified TCI framework for a single DCI-based single TRP operation.

Aspect 99: The method of any of aspects 75 through 98, further comprising: receiving second capability information indicating one or more second capabilities of the UE associated with a unified TCI framework for a single DCI-based single-TRP operation, wherein the capability information comprises an indication that one or more third capabilities of the UE associated with the unified TCI framework for the single DCI-based multi-TRP operation that are excluded from the capability information are the same as corresponding capabilities of the one or more second capabilities included in the second capability information.

Aspect 100: The method of any of aspects 75 through 99, wherein the one or more capabilities are specific to the UE, a frequency band, a frequency band combination, a feature set associated with the UE, a feature set per CC, an FDD configuration, a TDD configuration, a sub-mmW range of frequencies, a mmW range of frequencies, or a combination thereof.

Aspect 101: An apparatus for wireless communications at a UE, comprising at least one processor; memory coupled with the at least one processor; and instructions stored in the memory and executable by the at least one processor to cause the apparatus to perform a method of any of aspects 1 through 5024.

Aspect 102: An apparatus for wireless communications at a UE, comprising at least one means for performing a method of any of aspects 1 through 50.

Aspect 103: A non-transitory computer-readable medium storing code for wireless communications at a UE, the code comprising instructions executable by at least one processor to perform a method of any of aspects 1 through 50.

Aspect 104: An apparatus for wireless communications at a network entity, comprising at least one processor; memory coupled with the at least one processor; and instructions stored in the memory and executable by the at least one processor to cause the apparatus to perform a method of any of aspects 51 through 100.

Aspect 105: An apparatus for wireless communications at a network entity, comprising at least one means for performing a method of any of aspects 51 through 100.

Aspect 106: A non-transitory computer-readable medium storing code for wireless communications at a network entity, the code comprising instructions executable by at least one processor to perform a method of any of aspects 51 through 100.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor;
memory coupled with the at least one processor; and
instructions stored in the memory and executable by the at least one processor to cause the apparatus to:
transmit capability information indicating one or more capabilities of the UE associated with a unified transmission configuration indicator framework for a multi-transmission reception point operation;
receive, based at least in part on the capability information, a control message indicating one or more parameters for the multi-transmission reception point operation;
receive at least one downlink control information that schedules the multi-transmission reception point operation in accordance with the one or more parameters; and
perform the multi-transmission reception point operation.

2. The apparatus of claim 1, wherein the multi-transmission reception point operation is a single downlink control information based multi-transmission reception point operation, wherein the one or more parameters are for the single downlink control information based multi-transmission reception point operation, and wherein the at least one downlink control information is a single downlink control information that schedules the multi-transmission reception point operation.

3. The apparatus of claim 1, wherein the multi-transmission reception point operation is a multi-downlink control information based multi-transmission reception point operation, wherein the one or more parameters are for the multi-downlink control information based multi-transmission reception point operation, wherein the at least one downlink control information is a plurality of downlink control informations received from a respective plurality of transmission reception points, and wherein the plurality of downlink control informations schedule the multi-transmission reception point operation with the respective plurality of transmission reception points.

4. The apparatus of claim 3, wherein:
the one or more capabilities comprise a capability of the UE to receive control signaling activating one joint unified transmission configuration indicator state per component carrier in a band, and
at least one transmission configuration indicator codepoint is mapped to a joint unified transmission configuration indicator state per control resource set pool index.

5. The apparatus of claim 3, wherein:
the one or more capabilities comprise a capability of the UE to receive control signaling activating one downlink unified transmission configuration indicator state and one uplink unified transmission configuration state per component carrier in a band, and
at least one transmission configuration indicator codepoint is mapped to a downlink unified transmission configuration indicator state and an uplink unified transmission configuration indicator state per control resource set pool index.

6. The apparatus of claim 3, wherein the one or more capabilities comprise a capability of the UE to receive control signaling indicating an activated joint unified transmission configuration indicator state is mapped to a control resource set pool index.

7. The apparatus of claim 3, wherein the one or more capabilities comprise a capability of the UE to receive control signaling indicating an activated downlink unified transmission configuration indicator and an activated downlink unified transmission configuration indicator state is mapped to a control resource set pool index.

8. The apparatus of claim 3, wherein the one or more capabilities comprise a capability of the UE to support: common transmission configuration indicator state identifier activation for a set of component carriers operating in the multi-downlink control information based multi-transmission reception point operation; common transmission configuration indicator state identifier activation for a set of component carriers that include a first subset of component carriers operating in the multi-downlink control information based multi-transmission reception point operation and a second subset of component carriers operating in a single transmission reception point operation; common transmission configuration indicator state identifier activation for a set of component carriers that include a first subset of component carriers operating in the multi-downlink control information based multi-transmission reception point operation and a second subset of component carriers operating in a single-downlink control information based multi-transmission reception point operation; common transmission configuration indicator state identifier activation for a set of component carriers that include a first subset of component carriers operating in the multi-downlink control information based multi-transmission reception point operation, a second subset of component carriers operating in a single-downlink control information based multi-transmission reception point operation, and a third subset of component carriers operating in a single transmission reception point operation; or a combination thereof.

9. The apparatus of claim 3, wherein the one or more capabilities comprise a capability of the UE to perform a shared channel communication using a joint unified transmission configuration indicator state associated with a control resource set pool index associated with a downlink control information that scheduled the shared channel communication.

10. The apparatus of claim 3, wherein the one or more capabilities comprise a capability of the UE to receive a downlink shared channel communication using a downlink unified transmission configuration indicator state associated with a control resource set pool index associated with a downlink control information that scheduled the downlink shared channel communication.

11. The apparatus of claim 3, wherein the one or more capabilities comprise a capability of the UE to transmit an uplink shared channel communication using an uplink unified transmission configuration indicator state associated with a control resource set pool index associated with a downlink control information that scheduled the uplink shared channel communication.

12. The apparatus of claim 3, wherein:
the one or more capabilities comprise a capability of the UE to receive control signaling associating an uplink control channel resource with a joint unified transmission configuration indicator state, and
the joint unified transmission configuration indicator state is associated with a control resource set pool index associated with one of the respective plurality of transmission reception points.

13. The apparatus of claim 3, wherein:
the one or more capabilities comprise a capability of the UE to receive control signaling associating an uplink control channel resource with an uplink unified transmission configuration indicator state, and
the uplink unified transmission configuration indicator state is associated with a control resource set pool index associated with one of the respective plurality of transmission reception points.

14. The apparatus of claim 3, wherein:
the one or more capabilities comprise a capability of the UE to receive control signaling associating a configured grant resource with a joint unified transmission configuration indicator state, and
the joint unified transmission configuration indicator state is associated with a control resource set pool index associated with one of the respective plurality of transmission reception points.

15. The apparatus of claim 3, wherein:
the one or more capabilities comprise a capability of the UE to receive control signaling associating a configured grant resource with an uplink unified transmission configuration indicator state, and
the uplink unified transmission configuration indicator state is associated with a control resource set pool index associated with one of the respective plurality of transmission reception points.

16. The apparatus of claim 3, wherein the one or more capabilities comprise a capability of the UE to update at least one of a quasi co-location assumption, a spatial transmission filter, or a pathloss reference signal for a joint unified transmission configuration indicator state in response to a beam failure recovery procedure for a beam corresponding to the joint unified transmission configuration indicator state.

17. The apparatus of claim 3, wherein the one or more capabilities comprise a capability of the UE to update at least one of a quasi co-location assumption, a spatial transmission filter, or a pathloss reference signal for an uplink unified transmission configuration indicator state or a downlink unified transmission configuration indicator state in response to a beam failure recovery procedure for a beam corresponding to the uplink unified transmission configuration indicator state or the downlink unified transmission configuration indicator state.

18. The apparatus of claim 3, wherein the one or more capabilities comprise a capability of the UE to receive control signaling associating a joint unified transmission configuration indicator state or an uplink unified transmission configuration indicator state with an uplink power control configuration.

19. A method for wireless communications at a user equipment (UE), comprising:
transmitting capability information indicating one or more capabilities of the UE associated with a unified transmission configuration indicator framework for a multi-transmission reception point operation;
receiving, based at least in part on the capability information, a control message indicating one or more parameters for the multi-transmission reception point operation;
receiving at least one downlink control information that schedules the multi-transmission reception point operation in accordance with the one or more parameters; and
performing the multi-transmission reception point operation.

20. A non-transitory computer-readable medium storing code for wireless communications at a user equipment (UE), the code comprising instructions executable by one or more processors to:
transmit capability information indicating one or more capabilities of the UE associated with a unified transmission configuration indicator framework for a multi-transmission reception point operation;
receive, based at least in part on the capability information, a control message indicating one or more parameters for the multi-transmission reception point operation;
receive at least one downlink control information that schedules the multi-transmission reception point operation in accordance with the one or more parameters; and
perform the multi-transmission reception point operation.
